(19) United States
(12) Patent Application Publication
(10) Pub. No.: US 2025/0272368 A1
(43) Pub. Date: Aug. 28, 2025

(54) METHODS, SYSTEMS, APPARATUSES, AND DEVICES FOR FACILITATING SECURE COMMUNICATION

(71) Applicant: Daniel Thomas Laird, Blackfoot, ID (US)

(72) Inventor: Daniel Thomas Laird, Blackfoot, ID (US)

(21) Appl. No.: 19/057,755

(22) Filed: Feb. 19, 2025

Related U.S. Application Data
(60) Provisional application No. 63/556,893, filed on Feb. 23, 2024.

(51) Int. Cl. G06F 21/31; G06F 21/60

(52) U.S. Cl. CPC G06F 21/31; G06F 21/606

(57) ABSTRACT

A method of facilitating secure communication. The method includes receiving a message from a user device that is configured for receiving a request from a user, receiving a user key from the user, generating a passcode based on the user key, generating a combination based on the passcode, and generating the message based on the generating of the encrypted combination as the request, analysing the message, determining an operation based on the analysing of the message, obtaining the combination based on the analysing of the message, accessing a combination queue, determining a belonging state corresponding to a belonging of the combination in the combination queue based on the combination queue and the combination, determining a performability of the operation based on the operation and the belonging state, and performing the operation associated with a communication channel based on the performability.

### FIELD OF THE INVENTION

Generally, the present disclosure relates to the field of data processing. More specifically, the present disclosure relates to methods, systems, apparatuses, and devices for facilitating secure communication.

### BACKGROUND OF THE INVENTION

Existing techniques for facilitating secure communication to a device are deficient with regard to several aspects. For instance, current technologies use combinations to permit access to a secured device. And these combinations are decipherable. As a result, different technologies are needed that design and use combinations that are not decipherable. Furthermore, current technologies use the combinations that are exposed to the network connecting with the secured device. As a result, different technologies are needed that prevent the combinations from being exposed to the network.

Therefore, there is a need for improved methods, systems, apparatuses, and devices for facilitating secure communication that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating secure communication, in accordance with some embodiments. Accordingly, the method may include a step of receiving, using a communication device, a message from a user device associated with a user. Further, the user device may be configured for receiving a request from the user. Further, the user device may be configured for receiving a user key from the user. Further, the user device may be configured for generating a passcode based on the user key. Further, the user device may be configured for generating a combination based on the passcode. Further, the user device may be configured for generating the message based on the generating of the combination and the request. Further, the method may include a step of analysing, using a processing device, the message. Further, the method may include a step of determining, using the processing device, an operation based on the analysing of the message. Further, the method may include a step of obtaining, using the processing device, the combination based on the analysing of the message. Further, the method may include a step of accessing, using the processing device, a combination queue. Further, the method may include a step of determining, using the processing device, a belonging state corresponding to a belonging of the combination in the combination queue based on the combination queue and the combination. Further, the method may include a step of determining, using the processing device, a performability of the operation based on the operation and the belonging state. Further, the method may include a step of performing, using the processing device, the operation associated with a communication channel based on the performability.

Further disclosed herein is a system of facilitating secure communication, in accordance with some embodiments. Accordingly, the system may include a communication device and a processing device. Further, the communication device may be configured for receiving a message from a user device associated with a user. Further, the user device may be configured for receiving a request from the user. Further, the user device may be configured for receiving a user key from the user. Further, the user device may be configured for generating a passcode based on the user key. Further, the user device may be configured for generating a combination based on the passcode. Further, the user device may be configured for generating the message based on the generating of the combination and the request. Further, the processing device may be communicatively coupled with the communication device. Further, the processing device may be configured for analysing the message. Further, the processing device may be configured for determining an operation based on the analysing of the message. Further, the processing device may be configured for obtaining the combination based on the analysing of the message. Further, the processing device may be configured for accessing a combination queue. Further, the processing device may be configured for determining a belonging state corresponding to a belonging of the combination in the combination queue based on the combination queue and the combination. Further, the processing device may be configured for determining a performability of the operation based on the operation and the belonging state. Further, the processing device may be configured for performing the operation associated with a communication channel based on the performability.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a flowchart of a method 200 for facilitating secure communication to a device, in accordance with some embodiments.

FIG. 3 is a flowchart of a method 300 for facilitating secure communication to the device, in accordance with some embodiments.

FIG. 4 is a flowchart of a method 400 for facilitating secure communication to the device, in accordance with some embodiments.

FIG. 5 is a block diagram of a system 500 facilitating secure communication to a device, in accordance with some embodiments.

FIG. 6 is a schematic diagram of a system 600 for providing a secure channel access scheme to a secured networked channel, in accordance with some embodiments.

FIG. 7 is a schematic diagram of a channel 700 associated with the system, in accordance with some embodiments.

FIG. 8 is a flow diagram of a method 800 for performing SET and ACCESS by a user terminal providing a secure channel access scheme to a secured networked channel, in accordance with some embodiments.

FIG. 9 is a flow diagram of a method 900 for performing RESET by the user terminal providing the secure channel access scheme to the secured networked channel, in accordance with some embodiments FIG. 10 is a flow diagram of a method 1000 for performing SET by an access point of a gateway providing the secure channel access scheme to the secured networked channel, in accordance with some embodiments.

FIG. 11 is a flow diagram of a method 1100 for performing ACCESS by the access point of the gateway providing the secure channel access scheme to the secured networked channel, in accordance with some embodiments.

FIG. 12 illustrates a hash table 1300 for permutation order 20, for HMS-key of first hour, first minute, of all 60 seconds for providing the secure channel access scheme, in accordance with some embodiments.

FIG. 13 illustrates factors of 0-bivectors with respect to reference coordinates 1800, in accordance with some embodiments.

FIG. 14 illustrates factors of 0-bivectors with respect to reference coordinates 1900, in accordance with some embodiments.

FIG. 15 is a flowchart of a method 2000 of facilitating secure communication, in accordance with some embodiments.

FIG. 16 is a flowchart of a method 2100 of facilitating secure communication, in accordance with some embodiments.

FIG. 17 is a block diagram of a system 2200 for facilitating secure communication, in accordance with some embodiments.

FIG. 18 is a block diagram of the system 2200, in accordance with some embodiments.

FIG. 19 is a block diagram of the system 2200, in accordance with some embodiments.

FIG. 20 illustrates a system 2500 comprising a user interface and a gateway for facilitating secure communication, in accordance with some embodiments.

FIG. 21 illustrates matrix frame coordinates 2600, in accordance with some embodiments.

FIG. 22 illustrates matrix frame coordinates 2700, in accordance with some embodiments.

FIG. 23 illustrates a complementary gate 2800 distributed over 40 registers, in accordance with some embodiments.

FIG. 24 illustrates layers 3100 in a matrix, in accordance with some embodiments.

FIG. 25 is a representation 3200 associated with (0, p)-layer over the matrix order, in accordance with some embodiments.

FIG. 26 is a representation 3300 associated with a matrix operator, in accordance with some embodiments.

FIG. 27 is a representation 3400 associated with a spin operator, in accordance with some embodiments.

FIG. 28 is a representation 3500 of 3(0) & 2(±1) alignments in the 2, 3-grades associated with a cublet matrix, in accordance with some embodiments.

FIG. 29 is a representation 3600 of a filtering, in accordance with some embodiments.

FIG. 30 is a representation 3700 of a filtering, in accordance with some embodiments.

FIG. 31 illustrates a cublet matrix state 3800 of a quiescent, in accordance with some embodiments.

FIG. 32 illustrates a cublet matrix state 3900 of a user, in accordance with some embodiments.

FIG. 33 is a representation 4000 associated with disorders, in accordance with some embodiments.

FIG. 34 is a flow diagram of a SET state flow 4100, in accordance with some embodiments.

FIG. 35 is a flow diagram of an ACCESS state flow 4200, in accordance with some embodiments.

FIG. 36 illustrates a representation 4300 of a control state XOR Logic, in accordance with some embodiments.

FIG. 37 illustrates 3-level HMS hash tables 4400 for combination encryption, in accordance with some embodiments.

FIG. 38 is a flow diagram of a process flow 4500 of a GATORMOAT (GM) on a user terminal (UT) communication, in accordance with some embodiments.

FIG. 39 is a flow diagram of a process flow 4600 of an access point (AP) on a gateway, in accordance with some embodiments.

FIG. 40 is a block diagram of a computing device 4700 for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating secure communication, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analysing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes systems, methods, apparatuses, and devices for facilitating secure communication. Further, the present disclosure describes the provisioning of an access scheme to a secured networked channel. Each user is allowed access via a unique combination associated with the user, encrypted onto a user-queue, & stored in combination-queue on an Access Point that mediates access to the channel. The scheme is independent of what requires the provided security, e.g., a database, a secured network, or a monitored system. Further, the present disclosure describes deploying a user-ID (alphanumeric or biometric) & user-key (a sequence of natural numbers: u=u₁, . . . , u_{N}) to encrypt a passcode, s(u(N))=s0; s(u₁); . . . ; s(u_{N}), that generates a unique user-combination, C(s(u(N), R, V)), that resides in the Access Point (AP) that administers access to a device, a system, a database, or whatever requires restricted access. The data may be encrypted via any viable/acceptable encryption scheme. Further, the present disclosure describes components comprising a user-interface, a SET module, and an ACCESS module. Further, the user-interface translates the user-key (u) and encodes it into the passcode that is composed of the user-key (u) & randomly generated data: s ≡s(u(N)/r, v), which is encrypted onto the user-queue (UQ). The UQ is on a user-terminal (UT) linked to the AP via a network.

Further, the SET module establishes the s, encrypts it onto the UQ in the UT, & sets the C(s) in the AP. The SET includes an intelligence that avoids duplicates of s & C(s). This SET intelligence is distributed over the UT & AP (the AP is imagined to be housed in a network gateway/router).

Further, the ACCESS module regenerates the s & C(s) & delivers it to the AP. This module includes a nonrepeatable, encrypted timecode, T′, that is necessary for access to the AP's combination-queue, CQ (which stores all the permitted user's combinations). The ACCESS deploys a permuted version of the C(s)≈C′ appended with the encrypted T′. The decrypted T≈T holds a key that addresses a 3-level hash table, that associates a key extracted from T′ with the C′ permutation-key. This permutation-key is deployed to validate the access request of the user to the secured channel.

Further, the SET establishes user-key (k(N)), user-queue (UQ), user-passcode (s), & user-combination, (C(s)).

Further, the ACCESS deploys u(N) to reestablish s (reconstructed from encrypted store on user-queue (UQ)), & regenerate C(s), concatenate with encrypted timecode, T′, & deliver to AP for processing & access decision. The reconstructed s serves two purposes: 1^{st} it allows access to the combination generator; 2^{nd} it serves as the command sequence that regenerates the user-combination. Both the user-key, (u(N)) & user-ID are required to access the combination generator. The user-key (u(N)), is not stored on the user-terminal (UT). The user-passcode, s, is stored, but not on the user-queue (UQ). It is stored in a memory, at an address, a(s), derived from the user-combination. More than one passcode (s(u(N))) can be stored on an a(s).

Further, the present disclosure describes a plurality of functions. The first function allows the user to SET, which builds the user-queue, UQ, on the user-terminal, UT, sets the user-passcode, s, & establishes their user-combination, C(s), in combination-queue, CQ, on the Access Point, AP:
1) key generated from user's number sequence: u=u₁, . . . , u_{N}→(u₁, . . . , u_{N})mod 24. N is any natural number, as are the u₁, . . . , u_{N}.
2) key-to-passcode: u→s(u(N))/s(r); s(v) ≡s, where s(r) is a random sequence of a finite length, spliced into s(u(N)), & s(v) is another random sequence, chosen from a possibility of a finite number of variations. The s(u(N)) is bound to a random sequence of 24 generator commands. All the random data used to build the passcode, s, are captured to the user-queue, UQ, during SET, as the encrypted code of the passcode, s.
3) passcode-to-combination: s→τ(s)I→ΔI(s)→C(s)
   i) I is a direct matrix of 20(12, 8)(±2, ±3) objects. The 2, 3-objects, are ±2, ±3-coordinate combinations (vectors equivalent to orders), composed using 6 constant, or fixed keys.
   ii) One of the 2, 3-key combination ±-pair varies under the combination generator action, t(s).
   iii) The operator, τ=σ∘ρ is a modulo 4 composite, representative of the SO3 group operator, & key combinations are represented by 2, 3-vector sum conjugate pairs, built from the constant 6-keys.
   iv) passcode-to-combination pair accepted during SET by the AP. If a user-key generates a prior accepted passcode (highly unlikely), the core passcode, s(u(N)) generated from k, is varied by appending a string sequence to s=s(u(N)/r, v). If a passcode generates a prior accepted combination, the passcode is again varied, until a unique passcode-combination pair is accepted by the UT-AP negotiation.

Further, the second function is ACCESS, which allows the user access thru the Access Point, AP, to whatever is secured by the access permission scheme.
1) combination-to-permuted combination, C(s)→C′, which is appended with encrypted timecode, T′(YMD′, HMS′), to inform the payload C′_T′, where “_” designates concatenation.
   i) The T′ parameters are codes of the user-terminal, UT, and clock sample of Years, Months, Days, and Hours, Minutes, and Seconds. The UT clock & AP clocks are synchronized to the second accuracy, via standard network time sources.
   ii) The T′ is applied only during ACCESS. And the user-combination C(s) is exposed only during SET. The passcode, s, & user-key, u are never exposed to the network.
   iii) The T′ is decrypted to T, & HMS part of T is extracted as the key to the—associated key, σ₂₀(H, M, S). This associated permutation, or σ₂₀, key is applied to C′ & compared with each stored Cₙ in the CQ of the AP, until a match of Cₙ=C, where n indexes the stores of CQ.
   iv) On match: C=Cₙ, access is permitted, & otherwise denied. Note, in theory, we can either reverse the permutation on C′, or permute each Cₙ ∈CQ. We deployed both in simulation of the channel access scheme.

Further, the hash-tables that associate the HMS-key with the 6-key are distributed from the AP to all UT on the network. The distribution is periodic and discretion of the administrator of the secured channel. Further, there is one other function that allows for an encrypted text to be included in the ACCESS payload. This is not essential to the use of the key-to-passcode-to-combination scheme. It provides for messages from the UT to the AP. If this option is deployed, there are hash tables for encrypting the message (alphanumeric) data. As with the 6-key, the message encryption keys are associated with the HMS of the ACCESS payload, & are distributed from the AP to each UT in the network, as the administrator of the secure channel decides. The disclosed system is designed in a way that makes a guess of a user-combination-timecode message, impossible as there are trillions of trillions of ways to generate combinations that permit access to whatever the Access Point secures—perhaps encrypted data (by whatever method), or a secured database, or thru a GW, into another network, in a SCIF, say. Further, the implementation of the method of securing access to a network to link a telemetry, TM, channel with an IP channel, to establish a command & control link to a classified data acquisition system, that monitored a classified system under test, or SUT is useful. Of course, the LTE protocol & media provide for such links, as a TM is simply a special case of RF signaling, that carries an encrypted data stream, partitioned in frames of a constant flow of not uninterrupted RF signaling, & the corresponding capture & protocol partition, that eventually leads to a bit synchronized data frame partition of the frame words, delimited by a frame ID, that includes a count. Each frame, & even each parameter can be time-tagged, as desired to parse Time to the level of the acquisition media. All that added description as to the purpose of the channel is irrelevant to the application's function, as a security access mediator, that can reside in the application layer of an applied protocol. The simulator has simulated IP transport, or an equivalent of TCP(UDP)/IP. And the acquisition system need not serve a SUT but might serve any system under observation, SUO, that requires similar or even tighter security.

Further, the implementation includes deploying the combination, to gain access to any SUO, that requires such restricted access. User↔UT↔AP→SUO. The UT-AP exchange is bidirectional. Whether UT-SUO is bidirectional, depends on the application's use—for whatever purpose the SUO serves the user. It can be used for a command & control, with or without an exchanged payload, other than the access request. If so, a system of full exchange of messages is obtained: User↔UT↔AP↔SUO. If the UT houses the AT, the combination can be used for physical access to a vault. That vault might secure a SCIF. In this case, the application serves as a lock on a door. There would be no network to monitor, so the security is assured. In this application, the passcode module could be bypassed. The user-key would convert to the combination generating sequence, directly, not requiring an access check against existing passcodes. But of course, this also removes the intelligence to avoid repetitious keys. The stored passcodes serve as a check during SET of the user-combination, that will be used for access. The encrypting of the combination can be bypassed without an issue, which is used for protecting against sniffing, in an exposed, public network.

Also, if deployed in a secured network, for access to a secured database, of a need-to-know (NTK) security, or as a gateway to another, perhaps unsecured network, the encryption that masks the user-combination, & a bound encrypted timecode—to mediate the access requests—is useful, in assuring that desired level of security it provides.
Further, the present disclosure describes an application for facilitating secure communications. Further, a model of Rubik's Cube is the core of the application, as its states map to the combination that is bound to the user. The user-combination cannot be hacked at the user-terminal, as the combination is generated from an encrypted passcode stored on a user-queue, UQ. Each UQ is bound to a user-ID (alphanumeric name, or a biometric). The UQ holds the passcode of the user-key, k, which is stored in their brain's memory, & in no other place. The user-key initiates the system to either SET their combination, or ACCESS a channel secured by the application.
A sequence of operations initiated by the user's key, u=u₁, . . . , u_{N}, generates a restricted access scheme useful for protecting a data source, which might be a channel, or database in a channel, on a network.
This sequence translates into a passcode, s(umod 24). There are 24=6×4 commands that drive the operator action over matrix translator, which translates a source matrix, I, into a combination, C(s(u)), via a composite modulo 4 operator, τ(s)=(σ∘ρ)(s). The combination is encrypted into a channel access key, or CAK. The sequence is

u→s(u)→τ(s(u))I→ΔI(s(u))→C(s(u))↔C′T′.

C′T′≡CAK.

This encryption is of course invertible: CAK↔C(s(u)).

There is no inversion from combination to passcode, i.e., it is not the case that C(s)→s. The translation sequence, s, is a function, s(p, d), p∈±o3, d∈+o2, where τ(s(0, 0))I=I. There is no inversion of the string to the user-key sequence of natural numbers, 1, 2, . . . .

s(u)=s(u₁), . . . ,s(u_{N})=s₁, . . . ,s_{N}→u=u₁, . . . ,u_{N}.

And the CAK is nearly always unique, with restrictions due to the datetime code encryption deploying a modulo partition & permutation of the level-residual pairings of the modular p division, with the linear inverse of n=p×1+r. I'm certain that is not a novel method. But I'm using it with an encrypted timecode that associates the permutation key of the modular partition, required to validate the user access request. This encryption provides a layer of security, that prevents a useful sniff of the transport, if deployed in a channel exposed to a public network, or a vulnerable private network, that also encrypts the payload of the control messages, but also of whatever data might be exposed in that channel, that is independent of the control channel. A sniffed CAK is useless, as each reconstructed datetime code is unique to one instance of access request. The AP manages access, tracking the reconstructed time, to deny a second use of any prior datetime code.

Every reconstruction of a user's combination is associated with an timecode, which is encrypted. The combination is also encrypted, via an associated permutation key, bound to the Hour Minute Second of the clock's T=[Y, M, D, H, M, S] time data. We deploy a 3-level association table of HMS key & the permutation key, σ₂₀, such that C(s)[σ20]→C′. So C(s) is scrambled. The T is scrambled otherwise, via a 4!(3!)=24×6⁴=4×6×6⁴, which is interesting, given the order of Euclid's cube is 4×6=24, which has 6 degrees of direction freedom, & 4 degrees of rotational freedom, as a rigid object of 3 dimensions, 12 edges, & 8 corners, which we exploit, & map to a matrix of 20 conjugate pairs of rotatable vectors, equivalent to order cycles, which we exploit in our direct order filter:

o24^{0,1}(−o2,−o3)=2×o12(−o2)⊕3×o8(−o3)=o24(−o2)⊕o24(−o3).

This filters the source matrix in varying the +conjugate, cubie

σ20_{0,1}(+o2⁰,+o3¹)=σ12₀(+o2⁰)⊕o8₁(+o3¹).

Our filter of the 480=20×24 products is

o480_{0,1}(−o2⁰,−o3¹)=o20_{0,1}⊕o24_{0,1}(−o2⁰,−o3¹)

In our descriptions we suppress the super indices & simply use the direct product to denote the cublet matrix of conjugate orders:

o20(±o5)=o12(±o2)⊕o8(±o3).

The filter is part of the combination generator, i.e.,

C(s(u))≈Δo20(Δo5)(s(u))

=γ₊₁•o20(0,0)+γ⁻¹•o20′(Δo5)(s(u))

≈γ₊₁•I₂₀^{±5}+γ⁻¹•I₂₀^{±5}′(s)

≡γ₊₁⁻¹•ΔI₂₀^{±5}(s).

The source matrix, I₂₀₀^{±5}, codes the order of 20(12, 8) couplets of (2, 3)-cyclic vectors of the Euclid segments bound to the cube origin, we code in orders of 2, 3-cycles, under a modulo 4 operator action:

Πₛ₍ᵤ₎τ(s(u))I₂₀^{±5}→ΔI₂₀^{±5}(s(u)).

This is sampled & filtered:

κ_{0,1}²(γ₊₁⁻¹(s)•ΔI₂₀^{±5}(s))→(a(s),C(s))≡(a,C)(s).

We track this via a pairing, (1, C)(s). We store s at address a(s), where the queue at a(s) holds all s, such that

s≠s′,a(s)=a(s′)→s,s′∈a[s].

And the address is a scalar of a functional over the aligned elements of the matrix, over the order:

a(s)=Σ₂₀2^{k-1}×γ₊₁₍ₖ₎(s)

Each stored s is encrypted in que of numbers, associated with the user, via the user's ID (alphanumeric or biometric as required). The user enters their key, u, & ID to SET their pair: (1, C)(s). The user enters (u, ID) every time they desire access to the secured channel.

The s(u) is reconstructed from u & the encrypted data, s(r, v), to generate s(u/r, v), which is compared with each s∈a[s]. If there is a match, the s sequences is read by the matrix translator, τ(s), that is sampled at the apex of a reversible sequence, τ(˜s, s)I₂₀^{±5}=I₂₀^{±5}, & τ(s)I₂₀^{±5}, filter to the combination C(s), which is stored in a register.

This register data passes thru a message encryptor, that deploys a datetime coded sample of the device clock:

T=[Y,M,D,H,M,S].

T is encrypted, after the [H, M, S] segment is the key to extract a combination permutation key, 620, from the HMS 3-level association matrix, or hash table. The encrypted T[σ₄₍₃₎]→T′ deploys 4 permutations of 3, permutated as 4!(3!), for which there are 4!(3!)=24×6⁴=31104 time permutations, of a nonrepeating, irreversible code of increasing seconds, tracked to the year, so do repeat all by Y, inevitably.

So the timecode is a once per century code, that isn't predictable. In our simulations, two objects, we denote the GMI & API (GATORMOAT & ACCESS POINT). These manage the encryption-decryption of the C(s)↔CAK, that allows for the access point, AP, to manage the access decision of the secured channel, via a combination queue, CQ, that stores all permitted user combinations. There are two basic states of the channel, & the decision criteria, or conditions for SET & ACCESS are:
SET:
if C(s)∉CQ, then C is added to CQ, else vary C(s).
ACCESS:
if C(s)∉CQ, then access permitted, else rejected.

The SET has sufficient intelligence to assure that the system never replicates either s or C(s). We detail this intelligence to vary s & C(s), as required during SET. We embedded this intelligence as noveltyfilters (discussed in the details) in our simulations. With these filters, our largest simulation generated 5000 (1, C)(s), which entailed fewer than 1500 a(s), or a[s], to store all of 5000 s, in approximately 1400 a[s] ques, of gate numbers, a(s). We did not pursue a higher limit, as we do not foresee a high security scheme allowing so much access. We imagine a high security requirement served by our method of securing limited access.

This control protocol, as simulated, over an emulated internet protocol (using standard IP transport (TCP/UDP) objects) serves an channel access scheme, independent of whatever data source, or data channel, requires restricted access.

These facts of the model matrix & filter structures are the basis of the application's combination generator.

The application (we call ‘GATORMOAT’, so reference below as GM) was simulated as housed on a device (user-terminal, UT), on a network. The communication was simulated using a transport protocol socket & port calls (using the R language) to emulate the exchanges between the UT & a gateway, GW. The GW houses the Access Point, AP. The AP mediates the setting (SET) of the user-combination, C(s), & all access requests (ACCESS) that deploy C(s), to access the secured networked channel.

The security requires a user-key, k, that is associated with an encrypted passcode, s(u). The s(u) is the command sequence that generates the user-combination, C(s), from a variable key-matrix, I, of 20 pairs of fixed-variable key combinations. The 20 pairs are 12 of 2 fixed & 2 variable keys & 8 of 3 fixed & 3 variable keys. The 2 & 3 key combinations are composed using 6 basis keys. The C(s(u)) is also encrypted, C(s(u))→C′, so that C(s(u)) is never exposed on the network.

The combination encryption requires a 3-level hash-table association with an encrypted timecode, T′(HMS). So, the channel requires these HMS-tables to be distributed to each UT, from the GW. The communication between a GM, user terminal, UT, & the access gateway, GW, is required during SET, all access requests, ACCESS, with or w/out an attached message, MSG. Also, for the HMS tables to be identical over all UTs & the GW, the GW generates & distributes these tables. GM is an application, housed on a device, UT. AP is an object on another device, GW, & is the channel's access manager. So the application requires a network protocol for channel management of SET, ACCESS, & for the HMS table updates & distribution. The network administrator has control over when the HMS tables are updated. This is a security decision. In theory, it can be updated as often as desired.

The transport model deployed for network connections is the file protocol. The transport model is extended to include server-client sockets, which are used for URL & TCP/IP protocols. The sockets are deployed for the serve-client channel links required for the UT-GW communication.

HMS Table Distribution: The HMS tables are collated and then sent via another channel. The HMS tables are distributed by the GW to each GM on the network, via a transport protocol that deploys assigned socket-ports on a connection that links a deliver & acknowledge exchange. In simulation, the transport follows the generation of all, in what is called tables_TXPORT & tables_RXPORT. The HMS key is a 3-level call to all hash tables, of which there are 4, each of 86400 entries, as that is the number of seconds in a day. Each table holds permutations of 20, 24 & others of 10, 12, & 8 element permutations. The delivery & acknowledgment is for the SET & HMS table updates. The tables are collated & delivered via an assigned channel, using socket-ports, for the server & client using the transport.

User Combination SET: In simulation, during SET, an object, G20_24, establishes the server-socket via an enveloping module, SET_G20_24. The GW's client-socket receives & parses the encrypted combination, C′, via a subobject, rTABLE_socket. An object, C_CQ_UD_GW, in GW, performs the combination comparison & returns an indicator that informs the SET in GM on UT that the combination is valid, or if it needs to be varied. Each user combination, C, is not stored locally in each UT of GM but is stored globally, on the GW, for use by the AP. All Cs are stored in the combination-queue, CQ, which is managed by the object G20_24 in GW. The combination is not encrypted during SET.

The decision on the combination match in the global CQ is returned to the GM SET, as indicator 21 in the combination register of 20+1 registers, each carrying a complex number. If the 21^{st} number in the register is different than 0, the local CQ update is ignored, & the passcode, s(u) is varied, & checked again.

User Access with Encrypted Message: The ACCESS, like SET links the GM on the UT with the AP on the GW. Each side of the exchanged is discussed below.

GM on UT: This communication channel is established following the masking of the combination, C(s(u))→C′, & appending of the encrypted timecode, T′, by GM on UT. The AP on GW assesses the C′_T′, as a request for access to the channel.

### Passcode, Timecode & Combination Encryption:

Each of three sets of objects serve as functions in our simulations of the secured channel, to translate a user's key sequence into a user's passcode, s(u) & a combination, C(s(u)), that is enciphered via a timecoded mask, C′(T), into a channel access key, CAK:

u→s(u)→τ(s(u))I→γ₊₁⁻¹(s(u))•ΔI(s(u))→κ₁⁻²(ΔI(s(u)))→C(s(u)).

The command string encryption in a user's que, UQ_{ID}. UQ is a registry of data used to reconstruct the passcode, s, assigned to the user via the SET object:

UQ_{ID}(s)≡[cq,r[(sp₁,sp₂),(lsp₁,lsp₂),u(lsp₁,lsp₂)],v[σ6_{1,v}a_{1,v}]][ID].

In the above, cq indexes the σ₂₄o24 command array: o24[s(p, d)][umod 24]. The splice data is

r[(sp₁,sp₂),(lsp₁,lsp₂),u(lsp₁,lsp₂)].

The sp₁, sp₂ are indices of the split passcode sequence. The (lsp₁, lsp₂) are the lengths of the splice sequences. And u(lsp₁, lsp₂) are the splice command sequences concatenated with s(sp₁) & s(sp₂). The spliced sequence length is lsp=lsp₁+lsp₂. We designate the user-passcode, at this point in the SET sequence, as s_{N+1}(u/r).

And if necessary, another random string, s(v), is appended via a variation routine. So, with this final adjustment, the user-passcode plus encryption code, is equivalent to a command string:

s_{N+1}(u)/s(r);s(v)−≡s(u/r,v).

The variation of the passcode is

s(σ6_{1,v}a_{1,v})=sₐ_{₁}(Π₁^{L(a}^{₁}⁾(p,d)[a₁i(σ6₁)]), . . . ,sₐ_{ᵥ}(Π₁^{L(a}^{ₙ}⁾(p,d)[aᵥ(σ6ᵥ)])≡s(v).

The s(r, v) data encoded & stored on the user-que, UQ_{ID}.

UQ_{ID}(s)≡[cq,r[(sp₁,sp₂),(lsp₁,lsp₂),u(lsp₁,lsp₂)],v[σ6_{1,v}a_{1,v}]][ID].

In the above, cq indexes the σ₂₄o24 command matrices: o24[s(p, d)][cq]. Each holds a unique order of commands. This que holds an encryption of the s(r, v) strings, & the address, cq, of σ₂₄o24[cq] in a list data structure.

The C(s(u)) is masked via a permutation, associated with a timecoded key:

σ₂₀(T)(C(s(u)))→o20[C(s)[σ₂₀[HMS(T)]]]=o20[Δo2O+iσ5][σ₂₀[HMS(T)]]

=o20[C′]

≡C′(T).

The T is encrypted:

T=[Y,M,D,H,M,S]→[[YMD],[HMS]]

Tmod p→T[[YMDₗ,YMDᵣ],[HMSₗ],HMSᵣ]]

Tmod p[4×σ₃]→T[YMD[σ₃₍₁₎],YMD[σ₃₍₂₎],HMS[σ₃₍₃₎],HMS[σ₃₍₄₎]]

Tmod p[4×o4[σ₃,1]][σ₄]≡T′_[17[σ₄]].

The p is prime. The encryption scheme adds random, masking imaginaries from 21 to 37 to the real terms of T′:

T′→T′+i×o16[22+σ₁₆o16].

To decipher T′ →T, the imaginary dummy (masking) parameters are removed using a real filter of a complex number.

The control message is the channel access key, CAK:

σ₃₈(C′_[21_S]]T′_[17[64]])=[C′_[21[S]]_T_[17[σ₄]]][σ₃₈]

→[C′T′[21[S]][17[σ₄]][39[σ₃₈]]]

≡AK.

Where, [21[S]] is the 21^{st} register & it carries the channel command: S={1, 2, 3, 4}. The S signify the channel state. Both channel interfaces, GMI & API, interpret S in state changes. The scrambled control message is exposed on the network. Register 39 carries the permutation key of the other 38 registers. Registers 21,17, & 39 imaginary values are 0.

The user's C(s(u)), s(u), & u, are never exposed. And u is never stored, s(u) is stored with no links to u, on a user's device. C(s(u)) is stored as C, with no reference to s(u), in the gateway device of the network's secured channel.

This informs a concatenated composite:

C′(T)_T′ →C′(T)_21[S]_T_[17[σ₄]]≡CAK.

And the control message cipher scrambles the concatenated composite:

[C′_[21[S]]_T′_[17[!₄]]][σ₃₈]↔[C′T[21[S]][17[σ₄]]][σ₃₈⁻¹]

All functions of the cipher scheme are, of course, invertible.

### User-Key to Passcode:

The user-passcode, s, is derived from a user-key, u=u₁, . . . , u_{N} via a modulo 24 mapping that is randomized over a finite number of permutations of order 24:

o24=1,2, . . . ,24.

In general

oN=2=1, . . . ,N,

1, . . . ,N∈ [symbol] =1,2, . . .

As a string the user-key sequence, u, is converted into a user-key passcode sequence, s, via a command string sequencer:

∀u,n∈ [symbol] :uₙ∈Nmod 24.

S(σ₂₄^{eq}o24[u])→s₀;s(u₁); . . . ;s(u_{N})

=s₀;s₁(u); . . . ;s_{N}(u).

The cq indexes a command que that contains a σ₂₄ permutation of the 24 commands.

sₙ(u)=S[uₙ mod 24]→(p,d).

### So

s_{N+1}(u)≡s₀;s₁(p,d); . . . ;s_{N}(p,d),

p∈±o3≈o6,d∈±o2≈o4.

In general, the integer identity may be ignored in reordering the naturals as signed.

±oZ=−Z, . . . ,−1,1, . . . ,Z,

Z∈ [symbol] =0,±1,+2, . . .

The command string elements, s(u), are function of the user-key, u, & each element of the u sequence associates with a pair of commands. This command s-sequence is derived from the user-key is modified via an encryption scheme that stored in the user-que, UQ_{ID}, bound to the user by ID (alphanumeric of biometric). The key-coding sequence is followed by the matrix operator, as a function of the sequence:

S(σ₂₄^{eq}o24[u])→s_{N+1}(u)→τ(s(u))Iₒ₂₀^{±o5}→C(s).

The command matrix permutation, σ₂₄^{eq}o24[u], is modified by two distinct string variations are encrypted onto the user-que: UQ_{ID}.
UQ_{ID}(s)=[cq,r[(sp₁,sp₂),(lsp₁,lsp₂),u(lsp₁,lsp₂)],v[σ₆,(p,d)ᵥ]][ID].

The cq indexes the command matrix. The modified passcode, s, is memorized in a que: s∈a[s]. The passcode is stored at location, derived by a functional on the aligned elements of a complementary (mis)alignment gate (details below):

2^{o20}−1≡Σₖ₋₁²⁰2^{k-1}

a(s)=2^{o20}−1 •γ₊₁(s)≡κ₀(s),

|2^{o20}−1|=2²⁰−1≡a₀.

This location contains a que, bounded by

|γ⁻¹(s)•k′|,k′≈Δo20.

The s of a[s] are encrypted onto user-ques, UQ, linked to the user by an ID:

UQ(u,ID)→UQ_{ID}[e(s)].

The e(s) are the parameters required to regenerate s(u), SET once by the user, & redeployed each time a user requests access to the secured channel. The γ₊₁⁻¹ denotes the sample-alignment gate that maps the mixed source matrix, Iₒ₂₀^{±o5}, into an alignment-filter that drives a combination-register, C(s). Further, the gate, matrix, & combination register are discussed.

### Source Data Matrix (Cublets) & Mixer:

The source Data Matrix Mix holds Iₒ₂₀^{±o5} in a direct order equivalent to an order of o20(o12, o8) ordered-oriented identity conjugate cublets of 2, 3-cyclic variable 2, 3-cubie orders & fixed 2, 3-cubicle orders of coordinates

I[±o5][o2O](s₀)=I[±o2][o12](s₀)|I[±o3][o8](s₀)

=Iₒ₁₂^{±o2}(s₀)⊕Iₒ₈^{±o3}(s₀)

≡Iₒ₂₀^{±o5}(s₀).

The order of 20 is a direct sum of orders:

o20(s₀)=(o12 ⊕o8)(s₀)=o12(s₀)⊕o8(s₀),

These mix, each constrained to their order, as

Πᵤσ₄(s)o20=σ₄(s)o12 ⊕σ₄(s)o8=o12′(s)⊕o8′(s).

The Πₛ σ₄(s) denotes a mixing sequence via a modulo 4 cyclic-shifter of 1 degree of directional freedom that mixes the relative order of the variable & fixed objects. This modulo symmetric, cycle-4 shifter is part of the composite modulo 4 rotation operator, that includes a modulo 4 cyclic-spin operator, ρ⁴(s(u)), which is also of 1 degree of freedom.

ρ⁴(s(u))+o5=+o5′.

The spin-operator spins the o5(o2, o3) orientation orders as a pair that comprise 4 each of o2[o12], o3[o8] of the o5[o20], via 6 layer-calls of the cublet-matrix:

(1_{±p},4u_{±p}^{0,1})(1ₚ,4u_{0,1}^{p}(k))(1,2,3)=1_{±p},4u_{±p},4_{±p}u¹)(1ₚ,4u₀^{p}(m)4u₁^{p}(n))(1,2,3).

### Where

4u_{±p}⁰=2X[0,1,2,3]=[0_{q,r},2_{q,-r},4_{-q,r},6_{-q,-r}],

4u_{±p}¹=u⁰+1=[1_{q,r},3_{q,-r},5_{-q,r},7_{-q,-r}].

4u₀^{p}(m)∈o12mod 4(0,q,r)

4u₁^{p}(n)∈o8mod 4(±p,q,r)

p,q,r∈±o3.

The mixed u inform the cubie-cubicle mixtures:

(1ₚ,4ₚu^{0,1})(1ₚ,4u_{0,1}(k(s)))=(1ₚ,4uₚ⁰,4ₚu¹)(1ₚ,4u₀^{p}(m(s))4u₁^{p}(n(s)))(1,2,3),

k(s)=m(s)⊕n(s)∈Πᵤσ₄(s)o20(s₀)

4u_{0,1}^{p}(k(s))=4u₀^{p}(o12(s))⊕4u₁^{p}(o8(s)).

The mixer mixes reorders by 4s, each the 12 & 8 cubies occupying their identity cubicles in the matrix of 20(12, 8) fixed cubicles that inform a direct matrix under a 6-layered, modulo 4 operator action sequence. The mixed matrix leaves the 20(12, 8) cubicles occupied by any of the variable 20(12, 8) cubies of the identity order. These occupations code the disorder of the matrix, sampled to measure:

Δo20=Δo12⊕Δo8=k+k′

k∈m⊕n⊂o20=o12⊕o8

k′=m′+n′⊂o20′=o12′⊕o8′.

This is a partition of the ordered & disordered cublet (a cublet is a conjugate pair of a bivector/bifactor identity: a variable cubie & fixed cubicle). The aligned matrix informs the forbidden combination, or the empty user's combination, that codes the identity matrix in 20 real numbers of the 480 complex numbers, that mix 460 complexes of both real & imagination components representing the (dis)order & (dis)orientation of the cublets. The disordered are never ‘disoriented’, as a disordered cublet harbors no identity, to be disoriented.

There are 20 ordered-orientations, 28 ordered-disorientations, & 432 disordered-orientations. So, there are 3 classes of mixtures, as described: 480=20+28+460. This distribution is imposed by variation of the 20, sampled via gating (cf. below) to measures.

The u^{0,1} index the fixed 2, 3-cubicles that compose the matrix p-layer. These cubies mix via an operator action. Each call of the matrix includes a call to 1 of 3 composite operators:

$$\begin{matrix}{τ}_{\pm p 4}^{4} ( {u}^{0 , 1} , \pm du ) {v}_{k} ( ap , bq , cr ) = {σ}_{4}^{4} ( {u}^{0 , 1} \pm du ) ◦ {ρ}_{p}^{4} ( {u}^{0 , 1} \pm du ) {v}_{k} ( ap , bq , cr ) \\ = {σ}_{4}^{4} ( {u}^{0 , 1} \pm du ) ◦ {v}_{k} ( {ρ}_{p} ( ab , bq , cr ) ) \\ = {σ}_{4}^{4} ( {u}^{0 , 1} \pm du ) ◦ {v}_{k} ( {( ap , bq , cr )}^{′} ) \\ = {v}_{{k}^{′}} ( {( ap , bq , cr )}^{′} ) \\ ≡ {v}_{{k}^{′}} ( ap , bq , cr )\end{matrix} .$$

### And

νₖ′(ap,bq,cr)≈νₖ′(o3)≈o3(νₖ′).

Where, given our coordinate frame each coordinate sum factors into fixed & variable parts.

νₖ(ap,bq,cr)=νₘ(ap,bq,cr)+νₙ(ap,bq,cr)

=√2m(a₀p,b₀q,c₀r)⊕√3ₙ(a₁p,b₁q,c₁r)

### Normalizing

√(½,⅓)•νₖ(ap,bq,cr)=lₖ(ap,bq,cr).

### So

o3(νₖ)=o3(lₖ(ap,bq,cr)).

a,b,c∈{0,±1},p,q,r∈o3,

k∈o20(o12,o8).

Each vectors codes an order, & vice versa. In our simulator we map the vector pairs to disorder-cycle pairs via a filter that generates a pair of scalars that code a couple of quadruples:

$$\begin{matrix}( 1 , σ5 ) ( Δ ( {k}^{′} , k ) , Δ ( {1}_{k} ( + o 3 ) , {1}_{{k}^{′}} ( - o 3 ) ) ) = {k}^{′} - k + σ5 ( 0 , 1 ; Δ5 ( \pm o 5 ( {v}_{k} ) ) ) ) . \\ = Δ k + σ5 ( ( 0 ; Δ2 ( \pm o 2 ( {v}_{m} ) ) ) ⊕ \\ ( 1 ; Δ 3 ( \pm o 3 ( {v}_{n} ) ) ) ) \\ = Δ m + σ2 ( ( 0 ; + o {2}^{′} ( {v}_{m} ) - \\ o 2 ( {v}_{m} ) ) ⊕ Δ n + σ3 ( 1 ; o {3}^{′} ( {v}_{n} ) - \\ o 3 ( {v}_{n} ) ) ) \\ \approx {m}^{′} - m + σ2 ( 0 ; o 2 ( Δ {v}_{m} ) ) ⊕ {n}^{′} - \\ n + σ3 ( 1 ; o 3 ( Δ {v}_{n} ) ) )\end{matrix} .$$

Where o5=o3 ⊕o2 are filter coordinates, & the σ5=σ2|σ3 are the 5(2, 3)-cycle of variables w.r.t. the fixed vector reference (matrix frame coordinates). These are measures over the 20 cublet pairings that inform the matrix state.

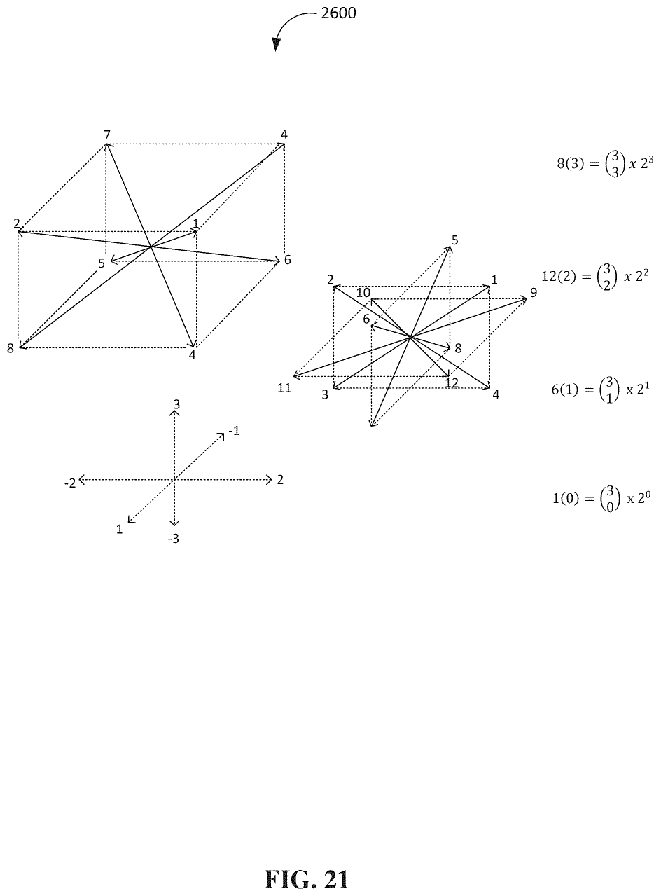

That fixed cubicle factors align with 12 couples & 8 triples of coordinate vector sums, to compose an order of 12, 8 fixed 2, 3-cubicle factor sums, as shown in FIG. 21.

There are o3(0(±p)) bifactor references, 0(±p)=Σ±p, for p∈1, 2, 3. And each 2-cubie has 4(2) orientations per 0(±p). These compose 4 quadrants for each 0(±p). So each 2-cubie occupies 3(0)×4(2)=12(0, 2) in 6(3(0), 2)×4(2)=24 ways, as 2 over the 3 by 4.

For each 0(±p) there is an o2(1_{±p}) reference, that coordinate pairs of polarized octants any 3-cubie might occupy, in 2(1_{±p})×4(3)=8(1, 3) in 6(2(±1), 3)×4(3)=24 ways, as 3 over 2 by 4. Note in translation, 5 of 6 layers are rearranged via our layered-calls of the cublet matrix. So a layer calls 9(1, 4, 4) of 6(±1, ±2, ±3):

(1_{o6(±o3)}o4,o4)(±1_{±o3},±o2,±o3)=(1_{o6(±o3)},o8)(±1_{±o3},±o5)=o9(±o6).

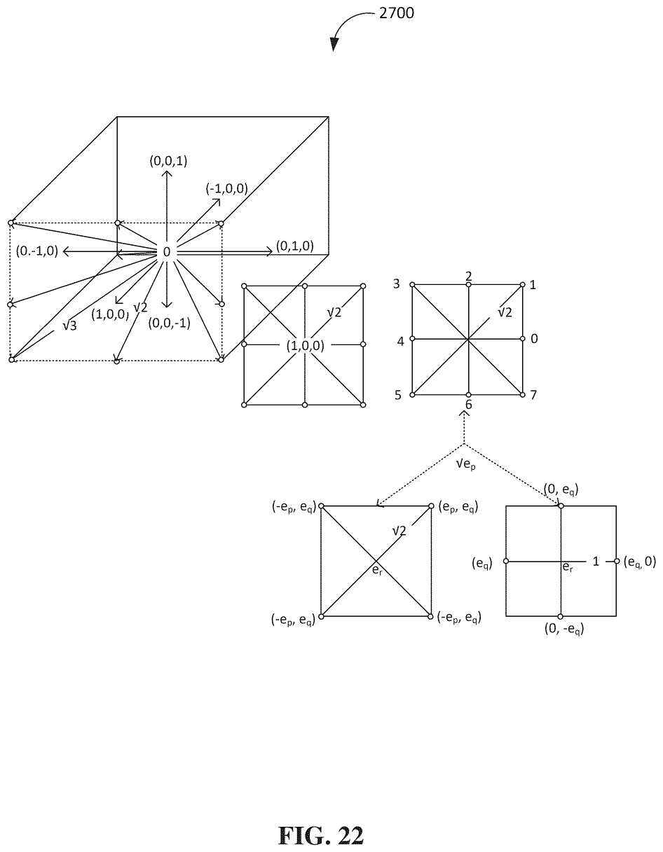

As shown in FIG. 22, each layer calls from 5 of 6 layers. The 1 fixed layer coordinate & 8 orthogonal extensions over the 2, 3-grades. And the matrix layers translate as

τ_{±o3(o6)}(o9(o6))=(1_{o6(±o3)},o4,o4)τ_{±o3(o6)}(1_{o6(±o3)},o2,o3)(1_{o6(±o3)},−o2,−o3)

=(l_{o6(±o3)},o4,o4)(l_{o6(±o3)},+o2′,+o3′)(l_{o6(±o3)},−o2,−o3).

Further, disclosed matrix is an image of a geometric object, composed of 20 vector sums, each mapped to cublets of ν₀=(⅓)³ volume. This mapping in not essential to the channel protocol. Any source able to deliver 20 unique complex numbers permutated & compared to a standard metric, will do.

The matrix may be mixed & each cublet may be measured to generate a measure of the matrix state, as a unique combination pair,

(s,C(s))=(1,C)(s).

The C(s) is unique to a user, & composes the combination of the Channel Access Key, CAK.

Further, a source associated with the disclosed access scheme may be model on a Rubik's cube, so has a known geometric-algebraic, semi-direct group structure. Further, the boundary of the space—the range of permutations is enormous, so serves as a viable information source, of sufficient entropy.

In varying the matrix, the (dis)orders & (dis)orientations of cublet pairs are sampled in to inform disordered 2, 3-cycles. These cycles are as constrained by their vector structure under the action of a quadrant operator:

τ_{±o3(o6)}(±o2)=σ(±o2)∘ρₒ₃(±o2).

The action on the cublet matrix is that of the SU(2) group mechanics, over ¼×2π=½π radian quadrants. Those samples may be metered thru a filter that returns the (dis)order & (dis)orientation cycle. The matrix has 20 ordered-orientations, 28 ordered-disorientations, & 432 disordered-orientations, which are filtered into the combination-register.

There is the 1 order of 20 identities, variable in 1 of a conjugate pair of 2 relatively oriented-orders. These identities are mixed via an operator action sequence that calls from 3 composite spin-operators, ρ_{p(±o3)}(±o)) of 1 common shift-operator, σ(±o2), & 6 (0, 1)(±p)-layer calls of the matrix cubicles. For each of 3(0(±p)) there are 2(1(±p)) conjugate layers, that compose the 6 sides of a coordinated cube volume. Each call extracts the 8, 2, 3-cubies occupying the 8, 2, 3-cubicles of the cublet matrix layer. For every ±p-layer, the 2-cubies align with 0s of the ±q, ±r-layers.

The operator action mixes the variable cubies over the fixed cubicle order, via a spin followed by a shift, indexing over 2 orders of 4 bound to each 1 of 6 layers:

du∈o4(±o2),±p∈o6(p∈o3).

### Sample-Alignment Gate:

The matrix mix is gated to 0, or scalar measure of cublet pairing alignments, & a 2, or a pair of bifactors that inform a cyclic measure of misalignments:

γ₊₁⁻¹(s)•̅τ(s)Iₒ₂₀^{±o5}→γ₊₁⁻¹(s)•̅ΔIₒ₂₀^{±o5}(s)=Iₒ₂₀^{±o5}(s)+Iₒ₂₀^{±o5′}(s).

Where the gating is

γ₊₁⁻¹(s)=γ₊₁(s)+γ⁻¹(s),

γ₊₁(s)=Σo20δ(Δζ)

γ⁻¹(s)=Σₒ₂₀1ₖ−γ₊₁(s)≡Iₒ₂₀−γ⁻¹(s)·γ₊₁(σ)•γ−1(σ)=0,

γ₊₁(σ)⊗γ−1(σ)=Io20.

The ‘⊗’ denotes exclusive-or (XOR) operation. Also, the address functional over the complementary gate is such that

a(γ₊₁⁻¹)=a(γ₊₁(s)+γ⁻¹(s))=a(γ₊₁)+a(γ⁻¹)=2²⁰−1.

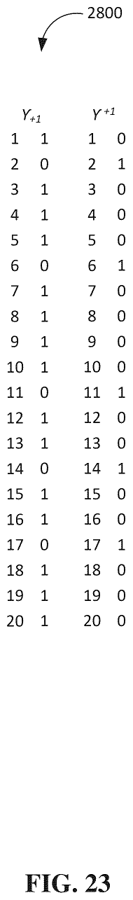

The complementary gate, g+1−1, is such that there are always 20, is & 20, 0s, distributed over 40 registers, as shown in FIG. 23.

### Alignment-Filter & Combination Register:

FIG. 23 shows the linkages between the cublet-matrix & the combination-register. It serves a complementary (0, 2)-measure space—of a scalar, 0-vector, & a bivector, or 2-vector representative.

There may be linkages that bind the cublet matrix, I, with I′(s) to inform ΔI(s), as distributed by the gating. Also,

κ₁(γ₊₁(s)•I)≡I(s)=o20+i0.

So

κ₁⁻²(ΔI(s))≡Γ(s)=(o20+i0+o20′+iσ5)(s)

=(Δo20+iσ5)(s).

We define the alignment filter:

κ₁²(γ₊₁⁻¹)=κ₁(γ₊₁)+κ²(γ⁻¹)≡κ₁+κ⁻². The filtration from the mixed matrix to the user-combination is:

κ₁²(γ₊₁⁻¹•ΔI(s))=κ₁(I(s))+κ⁻²(I′(s))≡C(s).

If we include the scalar grade, the address of a[s] is returned by the alignment functional:

κ_{0,+1}²(ΔI(s))→(a(s),C(s))≡(a,C)(s).

Each pair, s, C(s), is associated with the above.

(s,C(s))=(1,C)(s),s∈a[s].

### Cipher Scheme:

### Encipher Combination Message:

T=[[Y, M, D],[H,M,S]]

C(s)[σ₂₀[HMS(T)]][σ₃₈]→C′

Tmod 7→T[[YMDₗ,YMDᵣ],[HMS₁],HMSᵣ]]

Tmod 7[4×σ₃]→T[YMD[σ₃₍₁₎],YMD[σ₃₍₂₎],HMS[σ₃₍₃₎],HMS[σ₃₍₄₎]]

→Tmod 7[4×o4[σ_{3,1}]][σ₄]≡T′_[17[σ₄]].

The encrypted timecode is masked with imaginary dummy parameters, starting at register 22 in a message of 39 registers:

### T′ →T′+i×o16[22+σ₁₆o16].Generate the Channel Access Key, CAK:

C′_T′→C′ T′[21[S]][39[σ₃₈]].

### Decipher Message Combination:

C′T[21[S]][39[σ₃₈]]→C′T′

T′[σ₄⁻¹]→Tmod 7[YMD[σ₃₍₁₎],YMD[σ₃₍₂₎],HMS[σ₃₍₃₎],HMS[σ₃₍₄₎]]

The real part of the complex T is filtered from the imaginary, then the modulo 7/permutation partition is decrypted, to extract HMS, which extracts the associated mask of the user's combination:

T[[YMDₗ,YMDᵣ],[HMSₗ],HMSᵣ]] mod⁻¹7→T

T[[Y,M,D],[H,M,S]]

C′[σ₃₈⁻¹σ₂₀⁻¹[HMS(T)]]→C(s).

Where register 21, 21[S], contains the channel state command, S, which is 1 of 4 commands: SET, ACCESS, EXIT, CLEAR. We have built all this functionality into the simulator that SET combinations & requests ACCESS.

### GMI Guard & API Time Filter:

In Simulation, within the GMI, the GUARD object checks the regenerated passcode, s(k/r, v) against all those passcodes, s∈a[s], at address a(s)≈a(s). If s is sanctioned (via the rules of the channel state: SET or ACCESS), the s is read by the translator, τ(s), to generate

Πₛτ(s)I→ΔI(s).

The check of s, at a(s) is whether s∈a[s]. And the decision of the check influenced by the state. In the SET state, the decision logic is

if s∉a[s] then s→a[s],

else s→s(v).

In the ACCESS state, the logic is

if s∈a[s] then Πₛτ(s)I→ΔI(s).

else I→I(s₀).

The above check of s∈a[s] entails a command sequence comparison be applied, if & only if the length of the s-sequence, |s| equals any s′∈a[s]. Where ∀N∈Nmod 24, s(u_{N})|=1.

|s(u)|=|s(u₁), . . . ,s(u_{N})|=N.

The API Time Filter, TF, guards access to the combination-que, CQ. Following the message decipher & reconstruction of the datetime code,

T=[Y,M,D,H,M,S].

The HMS-key is the register, [H, M, S]. The entire f(T)=T_{N} is compared to a prior T≠Tₚ, & the difference of comparison must be w/in a window of a number of seconds.

ΔT=T_{N}−T_{P}≥T_{W}.

Time differences are assured, given the irreversibility of time. T=T_now is always greater than T=T_then, where T_then is the T of the previous access request acknowledged by the API. T_then is stored & accessible, as managed by the API, in our simulations of the channel access scheme, or what is our control protocol.

The decision is state dependent. For ACCESS, EXIT, & CLEAR:

if C=Cₙ∈CQ(AP): access permitted, else denied.

For SET:

if C=Cₙ∉CQ(AP):C→CQ.

The EXIT & CLEAR serve the channel security, in exiting the channel by closing the connection, & removal of access permission, such that

s∉a[s],C(s)∈CQ.

### Novelty Filters:

### Vary Passcode:

To each user's passcode is applied a random sequence, sᵣ, of length selected from sample range (default 1:3).

sᵣ(n)=(sir(n,1₁),s₂ᵣ(n+1_{1,12}))≡s_{1r,2r}(n,1_{1,2}).

The modified string is the concatenated string of the splices:

s_{N+1}(u,δ_{1,2}(n,1_{1,2}))(p,d)=s₀;sₙ(p,d);δₛ₁(n,1₁);sₙ₊₁; . . . ;s_{N}(p,d);δs₂(n+1_{2,12}).

The matrix operator commands are composed of these strings. We denote these as part of the of all such strings:

s_{N+1}(u,sᵣ(n))(p,d)∈S(o24(o4,o6)(±o2,±o3)).

And by implying the arguments, we have a command set we index by orders of 24.

s_{N+1}(u,sᵣ(n))≡s(u/r)∈S(o24(o4,o6)).

We deploy array S[o24]=S[1, . . . , 24]& matrix of commands:

S[s(p∈o6(±o3)×d∈o4(±o2))][o24].

We deployed 25 command arrays, where one is bound to each user, as the source of the passcode commands. We can deploy to extend the space of unique (1, C)(s) pairs. To extend this, we deploy an object, s_V, that generate novelty pairs:

s(σ6_{1,v},a_{1,v})=sₐ_{₁}(Π₁^{L(a}^{₁}⁾(p,d)[a₁(σ6₁)]), . . . ,sₐ_{ᵥ}(Π₁^{L(a}^{ᵥ}⁾(p,d)[aᵥ(σ6ᵥ)])≡s(v).

The algorithms a_{1,v}=Σ aᵢ are randomly selected algorithms, as are

σ6=σ[+1,−1,+2,−2,+3,−3].

These index layer calls to the matrix, of an assigned algorithm. The applied command que is that established during the SET state of the user passcode, s(u), which is derived from the user-key, u=uᵢ, . . . , u_{N}. The generated variation is concatenated with s(u/r), delimited by ‘;’. The completed passcode generates the user's combination:

s(u/r)→s(u/r;v)

C(s(u/r))→C(s(u/r,v)).

The command variations are encrypted onto the UQ_{ID}:

UQ_{ID}(s)≡[cq,r[(sp₁,sp₂),(lsp₁,lsp₂),u(lsp₁,lsp₂)],v[α6_{1,v}a_{1,v}]][ID].

In the above, cq indexes the σ₂₄o24 command matrices: o24[s(p, d)][cq]. Each holds a unique order of commands. This que holds an encryption of the s(r, v) strings, & the address, cq, of σ₂₄o24[cq] in a list data structure (of language R).

### Vary Combination:

If C(s(u/r, v))∈CQ, the combination is varied. We deployed two methods in simulation: the one varies s & C(s), until both are novel. The other, faster method, varies C(s/r, v) w/out applying another variation s(v):

s(u/r)→s(u/r,v): C(s₀)→C(s(u/r))→C(s(u/r,v))

C(s(u/r,v))→σ^{2,3}×S_{12,8}(C(s(u/r,v))→C′(s(u/r,v)).

Where σ^{2,3}×S_{12,8}(C(s)) represents 2, 3-cycles the combination data in orientation, over a sample, S_{12,8}=S(A_{12,8}), of the even alternating 12, 8-(dis)order.

### Encryption Scheme:

### Timecode Encryption:

Time is sampled from the UT's clock, partitioned modulo p as the levels & residues.

T=[[Y,M,D],[H,M,S]]

Tmod p=[[Y,M,D]l,[Y,M,D]r,[H,M,S]l,[H,M,S]r].

The 1, r indices are for the level & residue of a modulo-p (prime) division of the elements that represent Year, Month, Day, Hour, Minute, Seconds of the device clock sample. Time, T, may be encrypted as

σ_{4×(3,1)}Tmod p=[σ_{(3,1)}[Y,M,D]ₗ,σ_{(3,1)}[Y,M,D]ᵣ,σ_{(3,1)}[H,M,S]ₗ,σ_{(3,1)}[H,M,S]ᵣ].

The (3, 1) indexes an order of 3 addressed by the 1 array index. There are 3!=6 permutations of an order of 3. These 4 are also permuted, in 1 of 4!=24 ways, to mix the final encrypted timecode:

σ_{4!}σ_{4×(3,1)}Tmod p=σ_{4!}[σ_{((3,1),1)},σ_{((3,1),2)},σ_{((3,1),3)},σ_{((3,1),4)}]T≡T′.

And the payload is C′_T′, which denotes T′ appended, or concatenated to C′. The is the channel ACCESS request message. The SET payload is C′, with no timecode tag.

The Access Point Decryption:

σ_{4!}⁻¹σ_{4×(3,1)}⁻¹T′→Tmod p→T=T₁×p+Tᵣ

T→HMS(T)

σ_{o20!}⁻¹(HMS(T))(C′)→C.

Where T₁ denotes the modulo level, & Tᵣ denotes the residue of the division. All this functionality may be built into the AP, that manages the set of a user's combinations, & also handles the access requests, via SET & ACCESS objects. The access decision is:

if C=Cₙ∈CQ(AP): access permitted, else denied.

Our default p is 7, to partition H∈24, M∈60, & S∈60. Permutations of 20+17=37 all require inverse keys to descramble the permutation. So for the 20+17 registers of permutation requires a memory addressable by the HMS(T). This is a hash table of 3 levels of 24×60×60=86400 samples of 20! The 86400 of 20! is associated with the HMS(T) key. The 17 inform are shuffles of 16(4×4), & together with the 20 & a state register of 1 complex number inform shuffles of 38! possible permutations.

So, deploying these tables, available on every user-terminal, UT, & the Access Point, AP, as distributed by the AP on command by the network administrator. This last layer of ACCESS request mixes all 38 registers in 1 of 38! possible ways to encode the masked combination & encrypted timecode C′_T′:

σₒ₃₈(σₒ₂₀(C(s(u))_σ₄σ_{4×(3,1)}Tmod p)→σₒ₃₈(C′_[21[s]]_T_[17[σ₄]])

→C′T′[21[S]][17[σ₄]]_[39].

This is unmasked at the AP,

C(s(u))_Tmod p←σₒ₂₀⁻¹C′_[21]_σ₄⁻¹σ_{4×(3,1)}⁻¹T′←σₒ₃₈⁻¹(C′T′[21[S]][17[σ₄]]_[39]).

Tₙ=lₙ×p+rₙ→T=[[Y, M,D],[H,M,S]],n=1,2.

These objects (in R) may be built as part of a channel simulator, & each of these reversible operations may be verified.

### User-Key Sequence to Passcode Sequence:

The user-passcode, s, is derived from a user-key, u=u₁, . . . , u_{N} via a modulo 24 mapping that is randomized over a finite number of permutations of order 24.

As a string the user-key sequence, u, is converted into a user-key passcode sequence, s, via a command string sequencer:

∀u,n∈ [symbol] :uₙ∈ [symbol] mod 24.

S(σ₂₄^{cq}o24[u])→s₀;s(u₁); . . . ;s(u_{N})

=s₀;s₁(u); . . . ;s_{N}(u).

The cq indexes a command matrix—(of some multiple: we simulated with 25 permutations of commands to serve the passcode encryption of the user's key sequence. Each command matrix contains a 624 permutation of the 24 commands.

S[uₙ]→(p,d)≡sₙ(u),

p∈±o3≈o6,d∈±o2≈o4.

And

s_{N+1}(u)≡s₀;s₁(p,d); . . . ;s_{N}(p,d).

The above denotes the user's passcode. We map each natural number into the 6 layer indices, p∈±o3 & one of 4 matrix operator action parameters: d∈±o2. So we cover the cube order of 24, as 24 coded command pairs, (p, d):

|p⊗d|=|p|×|d|=6×4=24.

Where

|p|=|±o3|=6,

|d|=|±o2|=4.

In general, the integer identity may be ignored, 0, in reordering the naturals as signed.

±oZ=−Z, . . . ,−1,1, . . . ,Z,

Z∈ [symbol] //{0}>=±1,±2, . . . .

The command string elements, s(u), are function of the user-key sequence, u, & each element of the u sequence associates with a pair of operator commands. This command s-sequence is derived from the user-key is modified via an encryption scheme that stored in the user-que, UQ_{ID}, bound to the user by ID (alphanumeric of biometric). The key-coding sequence is followed by the matrix operator, as a function of the sequence:

S(σ₂₄^{eq}o24[u])→s_{N+1}(u)→τ(s(U))Iₒ₂₀^{±o5}.

The command matrix permutation, σ₂₄^{eq}o24[u], is modified by two distinct string variations are encrypted onto the user-que: UQ_{ID}.

Each user passcode is encrypted onto an assigned que, which is identified (associated & indexed) by an ID (alphanumeric or biometric). Each que is assigned to only one user. And via variations of the passcode, each user passcode & combination are unique to the one user. This is required for the security assured by our access scheme.

As an infinite number of command strings are able to generate any one user-combination, C(s), so the combination is also checked to avoid duplicates. And the check requires zero search time. As we shall see, the passcode serves two purposes: to gain access to the combination generator, & as the generating command sequence of the user-combination, C(s). The access is decided via a comparison of the user's reconstructed s, with the s SET & assigned to the user by the system. The user's passcode, s, is stored in a que, a[s], at gate number, a(s) of a class of passcodes:

∀s,s′∈a[s]:s≠s′ & a(s)=a(s′).

Where

κ₀(γ₊₁⁻¹(s)•ΔI(s))→a(s).

This derivation is a function of the gating, & is discussed elsewhere. Replication is highly unlikely, tho possible—given the unbounded length of a user-key sequence, u, the pseudorandomly variable command array, σ₂₄^{eq}o24. So a pseudorandom sequence, s(r), is spliced into the s_{N}+1(u) command-string, at a random break of the passcode:

s_{N+1}(u)→s_{N+1}(u/r).

Another appending variation, s(v) is added, if the s(u/r) is replicated:

s_{N+1}(u/r)→s_{N+1}(u/r,v).

These passcode modifications assure the novelty of each user's passcode.

The first modification of s_{N}+1(u) is an essential part of a user-passcode construction, via a spliced command string, of a set length, at a random location of the string sequence. The set length of the splice is variable. The second modification is probable, of a low probability, based on the string constructed to the first modification being unique to the user, & to no other user of the application.

This variation algorithm appends a random sequence, generated by a randomly selected algorithm, based on what we refer to as a matrix perspective, that applies 1 of 44 algorithms, up to 6×4=24 times. These combine to code 1056 variation algorithms of command sequencing. The command string encryption in the UQ_{ID} is a registry:

s[UQ]≡[cq,r[(sp₁,sp₂),(lsp₁,lsp₂),u(lsp₁,lsp₂)],v[σ6,(p,d)ᵥ]].

In the above, cq indexes the σ₂₄o24 command array: o24[s(p, d)][umod 24]. The splice data is

r[(sp₁,sp₂),(lsp₁,lsp₂),u(lsp₁,lsp₂)].

The sp₁, sp₂ are indices of the split passcode sequence. The (lsp₁, lsp₂) are the lengths of the splice sequences. And u(lsp₁, lsp₂) are the splice command sequences concatenated with s(sp₁) & s(sp₂). The spliced sequence length is lsp=lsp₁+lsp₂. This string codes the splice of s(r) into the s_{N+1}(u) sequence, of the user-key passcode. We designate the user-passcode, at this point in the SET sequence, as s_{N+1}(u/r).

Each attempt to SET a passcode, is checked for duplicates in the already SET codes, post the passcode splice, which is applied to every s(u). If s(u/r) passcode exists, that s-sequence is varied once more.

Variation Algorithm: The variation algorithm uses a sequence order register to permute the execution order w.r.t. a fixed order of aligning the matrix. This variation of order is equivalent to a matrix perspective register

σ6=σ[[1,4],[2,5],[3,6]].

As cubists might imagine the coordinates of a space the cube occupies. The cube coordinates are ep, where

σ6(±σ3)×4(±o2)=σ6[[+1,−1],[+2,−2],[+3,−3]]×4

=σ3[σ2[±1],σ2[±2],σ2[±3]]×4.

This perspective permutes in 6=3×2×1×4=24 ways. And we deployed 44 algorithms, that apply in combinations of 1, 2, 3, 4 algorithms serially sequenced. There are 24×44=1056 algorithms to select in combinations up to 4.

There are, in fact, an infinite number of algorithms that might apply given the cyclic nature of the source matrix operator action, which provides for sufficient variation of any state, as the space is bounded by | [symbol] |=½×2¹¹×12!×3⁷×8! possible passcodes, in theory.

The change to the passcode, s_{N+1}, is due to a spliced pseudorandom sequence of command strings, selected from the same command matrix. The boundaries of the splice in the string, s(r), are stored on the UQ. And if necessary, another random string, s(v), is appended via a variation routine. So, with this final adjustment, the user-passcode plus encryption code, is equivalent to a command string:

s_{N+1}(u)/s(r);s(v)≡s(u/r,v).

The s(v) is usually the null string of no label. These data compose the operator command sequence: s(u/r, v). Not that so is a null string label. As s(v) is a probable appendix concatenated to s(k/r), it is also likely to be null. As designed, the s(r) is never null. So the minimal passcode is

s_{N+1}(u,δs_{1,2}(n,1_{1,2}))(p,d)=s₀;sₙ(p,d);δₛ₁(n,1₁);sₙ₊₁; . . . ;s_{N}(p,d);δs₂(n+1_{2,12}).

The variation of the passcode is

s(σ6_{1,v}a_{1,v})=sₐ_{₁}(Π₁^{L(a}^{₁}⁾(p,d)[a₁(σ6₁)]), . . . ,sₐ_{ᵥ}(Π₁^{L(a}^{₁}⁾(p,d)[aᵥ(σ6ᵥ)])≡s(v).

The s(r, v) data encoded & stored on the user-que, UQ_{ID}.

UQ_{ID}(s)=[cq,r[(sp₁,sp₂),(lsp₁,lsp₂),u(lsp₁,lsp₂)],v[σ6_{1,v}a_{1,v}]][ID].

In the above, cq indexes the σ₂₄o24 command matrices: o24[s(p, d)][cq]. Each holds a unique order of commands. This que holds an encryption of the s(r, v) strings, & the address, cq, of σ₂₄o24[cq] in a list data structure.

This list contains numbers—the command matrix permutation, the s(r) boundaries & length, the variation sequence matrix of command sequences of 6×4=24 commands in 11 distinct algorithms operating over the indexed elements of o24=o6⊕o4. This list of natural numbers, arrays & matrices, are SET by the system for each user during the SET of their user-key passcode.

A user interfaces with the system via a device, a User-Terminal, UT, that is network linked to a remote Access Point, AP.

The AP resides on a network terminal/device, such as a gateway, which includes an application layer, accessible via the channel protocol. The AP terminal must be able to execute the SET & ACCESS decisions of the security scheme. Our access scheme assures the security of each UQ & the sole AP that compose the entire channel.

The SET & ACCESS routines may be discussed, after describing the objects deployed in each of those algorithms of the application—one that sets & another that deploys a user-combination,

C(s)≡m₁+iσ2ₘ₁,m₂+iσ2_{m2, . . . ,12}+n₁+iσ3_{ni, . . . ,12}+n₈+iσ3ₙₛ.

For an ACCESS request to be delivered from the UT to the AP, the decryption of the UQ in response to the user-key entry rebuilds the user-passcode string:

s=s₀;s(k/r,v)=s(0,k/r,v).

The ‘;’ is a delimiter of coded command strings parsed to drive the matrix operator, which permutes the data matrix, we process as the user-combination. In simplified terms (ignoring prefix & suffix on I):

ZZ*=Z(s₀)Z*≡I.

And

τ(s)ZZ*=Z′(s)Z*=ΔI(s)≠I.

So, from the user-key input, k, & the encrypted passcode in the UQ, the command string, s, is rebuilt. The entire string serves two purposes: first as the user-passcode—for access to the key-combination generator; second as the command sequence of translator calls required to regenerate the user-combination.

The passcode & combination for each user is unique. This is assured by the system. This assurance relies on the random strings deployed in setting a user-passcode & combination. I is a direct matrix is sampled at command s_{N}. The matrix is then returned to the initial, solution state:

κ_{0,1}²(γ₁⁻¹•τ(s)I)≡κ₁⁽⁻²⁾(ΔI(s))→C(s).

The identity combination is

κ₀⁽⁻²⁾(I(s₀))=1+i0(σ2),2+i0(σ2), . . . ,12+1+i0(σ3), . . . 12+8+i0(σ3)

≡C(s₀).

The C(s₀) is the forbidden combination that represents the source identity matrix, I(s₀)=I. So s carries the arguments of the operator action on the data matrix. Via our alignment filter, κ₀⁽⁻²⁾, the C(s) is a unique measure the cublet-matrix state. The matrix mechanics & alignment filtering is discussed (below).

### Matrix Operator Layer Structure:

In the disclosed model, the normal subgroup is 2, 3-cyclic symmetric subgroup, which is bound to the even alternating subgroup of the symmetric group, S₄₈. This binding is via the semi-direct product of these subgroups of the Rubik's group:

[symbol]

≡ [symbol] _{2,3}^{11,7}×A_{12,8}.

This is a cartesian product of the two types of groups, of a direct variable orders of 5(2, 3) & 20(12, 8), that inform the Rubik's Group.

### Combination Source Matrix Structure:

We represent a constant cubic volume of variable alignment phase via a direct matrix able to generate a semi-direct group product of two subgroups, one normal to the symmetric group of 48 objects, confined to the cubic geometry of 6 faces, 12 edges, & 8 corners of 6 coordinates, 12 bivector quadrants, & 8 trivector octants, represented in their basis vector sum, under an SU(2) operator action, that preserves the volume while varying the alignment phase of coordinate sum factors:

$${e}_{p} ( \pm {x}^{p} ) ≡ {e}_{p} ( {x}^{p} {x}^{* p} ) = {e}_{p} ( {x}^{p} \cdot {x}^{p *} + {x}^{p} ⋀ {x}^{p *} ) . \\ And \\ \begin{matrix}{β}_{k} ( 0 , \pm \frac{1}{2} ) \underline{\cdot } {e}_{k} ( \pm {x}^{p , q , r} ) = a \times {e}_{p} ( {x}_{k}^{p} \cdot {x}_{k}^{p *} + {x}_{k}^{p} ⋀ {x}_{k}^{p *} ) + \\ b \times {e}_{q} ( {x}_{k}^{q} \cdot {x}_{k}^{q *} + {x}_{k}^{q} ⋀ {x}_{k}^{q *} ) + \\ c \times {e}_{r} ( {x}_{k}^{r} \cdot {x}_{k}^{r *} + {x}_{k}^{r} ⋀ {x}_{k}^{r *} ) . \\ = a \times {e}_{p} ( {1}_{\pm k}^{Δ p} + {0}_{\pm k}^{Δ p} ) + \\ b \times {e}_{q} ( {1}_{\pm k}^{Δ q} + {0}_{\pm k}^{Δ q} ) + \\ c \times {e}_{r} ( {1}_{\pm k}^{Δ r} + {0}_{\pm k}^{Δ r} ) . \\ = a \times {e}_{p} ( {1}_{0}^{Δ p} + {0}_{0}^{Δ p} ) + \\ b \times {e}_{q , \pm k} ( {1}_{0}^{Δ q} + {0}_{0}^{Δ q} ) + \\ c \times {e}_{r , \pm k} ( {1}_{0}^{Δ r} + {0}_{0}^{Δ r} ) .\end{matrix}$$

Where

a,b,c,∈{0,±½},

βₖ(0,±½)=(a,b,c).

These βₖ(0, ±½) are 20=12+8 in number: 12(0, ±½) & 8(±½, ±½²) (a, b, c) vectors that map 1-to-1 onto the quadrants & octants of a uniformly ⅓-segmentation over the 3 1-unit dimensions of a Euclidian cube, of 6 coordinates of an assigned order, we store in a register:

p,q,r∈±o3(o6)=[−3,−2,−1,+1,+2,+3].

These generate 3³=27=6 ⊕20 uniform volumes: 6(0, 1) coordinates & 20(12, 8)(2, 3) cublets, as defined above. Each vector ep(+x^{p}) carries (encodes) ν₀=(⅓)³ volume.

$$12 ( 0 ; \pm \frac{1}{2} ) = 3 ( 0 ( \pm \frac{1}{2} ) ) \times 4 ( \pm \frac{1}{2} , \pm \frac{1}{2} ) \\ 8 ( \pm \frac{1}{2} ; \pm \frac{1}{2} ) = 2 ( \pm \frac{1}{2} ) \times 4 ( \pm \frac{1}{2} , \pm \frac{1}{2} ) .$$

Under the SU(2) operator action, there is a fixed-variable change:

$$\begin{matrix}τ ( s ) {e}_{k} ( \pm {x}^{p , q , r} ) = {v}_{Δ k} ( Δ {x}^{p , q , r} ) \\ = {v}_{{p}^{′} p} ( {x}_{{k}^{′}}^{{p}^{′}} \cdot {x}_{k}^{p *} + {x}_{{k}^{′}}^{{p}^{′}} ⋀ {x}_{k}^{p *} ) + \\ {v}_{q , {q}^{′}} ( {x}_{{k}^{′}}^{{q}^{′}} \cdot {x}_{k}^{q *} + {x}_{{k}^{′}}^{{q}^{′}} ⋀ {x}_{k}^{q *} ) + \\ {v}_{r , {r}^{′}} ( {x}_{{k}^{′}}^{{r}^{′}} \cdot {x}_{k}^{r *} + {x}_{{k}^{′}}^{{r}^{′}} ⋀ {x}_{k}^{r *} ) \\ = {v}_{{p}^{′} p} ( {α}_{Δ k}^{Δ p} + {x}_{Δ k}^{Δ p} ) + \\ {v}_{{q}^{′} , q} ( {α}_{Δ k}^{Δ q} + {x}_{Δ k}^{Δ q} ) + \\ {v}_{{r}^{′} , r} ( {α}_{Δ k}^{Δ r} + {x}_{Δ k}^{Δ r} )\end{matrix} .$$

So every cublet translates as

$$\begin{matrix}τ ( s ) ( {v}_{0} \times {β}_{k} ( 0 , \pm \frac{1}{2} ) \times {e}_{k} ( \pm {x}^{p , q , r} ) ) = {v}_{0} \times τ ( s ) ( {β}_{k} ( 0 , \pm \frac{1}{2} ) \times {e}_{k} ( \pm {x}^{p , q , r} ) ) \\ = {v}_{0} \times {v}_{Δ k} ( Δ {x}^{p , q , r} ) \\ = {v}_{0} \times ( {v}_{{p}^{′} p} ( {α}_{Δ k}^{Δ p} + {x}_{Δ k}^{Δ p} ) + \\ {v}_{{q}^{′} , q} ( {α}_{Δ k}^{Δ q} + {x}_{Δ k}^{Δ q} ) + \\ {v}_{{r}^{′} , r} ( {α}_{Δ k}^{Δ r} + {x}_{Δ k}^{Δ r} ) )\end{matrix} . \\ Where \\ {x}_{k}^{p *} = - 1 \times {x}_{k}^{p} .$$

We have mixed (0, 2) multivector representatives for each cublet pairing. We measure over the matrix order & orientation, to sample products of the Rubik's Group:

[symbol]

≡ [symbol] _{2,3}^{11,7}×A_{12,8}.

We measure these to the order & relative cycle number of the product/pairing alignments. There are 20 alignments of order & orientation, & 460 misalignments of the total of 20×24=480 alignment products, or pairings. Of those 460, 28=12+16 are ordered & disoriented, so 432 are disordered & oriented, accordingly.

We measure the 12, 8 order in capturing the occupying cubie's identity order number & the occupied fixed cubicle order number. We measure 2, 3-cubie orientations relative to the 2, 3-cubicle orientation, of a total of 2, 3-cyclic orientations per each mixed cublet pairing. These cublets are the source data of the direct product matrix of order 20 of orders of 12 & 8. Each order is the matrix index to a cublet (multivector) representative, as the basis vector sums of the multivector factors.

o20(±o5)=o12(±o2)⊕o8(±o3).

Each ν₀×ν_{Δk}(Δx^{p,q,r}) maps into an (dis)order-(dis)oriented pairing of fixed cubicle & variable cubie. The disorder is a measure of the order permutations:

Δo20=o20[σo20]

=o12[σo12]⊕o8[σo8].

Where

o20[σo20]≈σo20−o20=σo12−o12 ⊕σo8−o8.

Where σ is a modulo 4 operator. The disorientation is coded in relative cycle numbers:

σ5(Δo5)=σ2(Δo2)⊕σ3(Δo3),

Δo5≡Δo2 ⊕Δo3=o2′−o2 ⊕o3′−o3≡o5′−o5.

The (1, C)(s(u)) pairings, bound to the user via u=u₁, . . . , u_{N}, are also associated pairs representative of cube solutions. Each combination is generated as a solution of a mixed disorder returned to order on an operator sequence 0-cycle. The operator action drives 0, 2, 3, & 4-cycles. We have mixed semi-direct products, generated by 3 modulo 4 spin & 1 shift operators:

σ⁴◯ρₚ⁴(u^{0,1})×o5(o2,o3),

σ₄(u_{0,1})×o20(o12,o8),

For a modulo 4 partition of the source matrix direct over orders of 0, 1, 2, 3≡o4:

u_{0,1}∈o20mod 4=o12mod 4 ⊕o8mod 4.

For the source matrix orientations:

u^{0,1}=u⁰⊕u¹,

u⁰=2×o4=[0,2,4,6],

u¹=u⁰+1=[1,3,5,7].

The upper index is the layer or index, the lower is the matrix order index. The σ₄ & σ₄ are the same operator, we denote σ₄⁴. This operator operates over the order o20 & o5 orientation objects:

u_{0,1}×σ₄(±d)=u_{0,1}±d,

u^{0,1}×σ⁴(±d)=u^{0,1}±d,

d∈−1,−2,+1,+2≡±o2.

And for

u_{0,1}^{0,1}=u_{0,1}⊕u^{0,1}

u_{0,1}^{0,1}×σ₄⁴(+2)=u_{0,1}^{0,1}+2=u_{0,1}^{0,1}×σ₄⁴(+2).

Together the two operators inform the matrix operator:

u_{0,1}^{0,1}•(σ₄ [symbol] σ⁴∘ρₚ⁴)≡τ_{±p4}⁴.

In composite, σ⁴ ∘ρₚ⁴ informs a rotation over 2π×¼=% ½π-radians, modulo 4. The matrix is called by layer. There are 6 layers in the matrix, each called by an index of a fixed order.

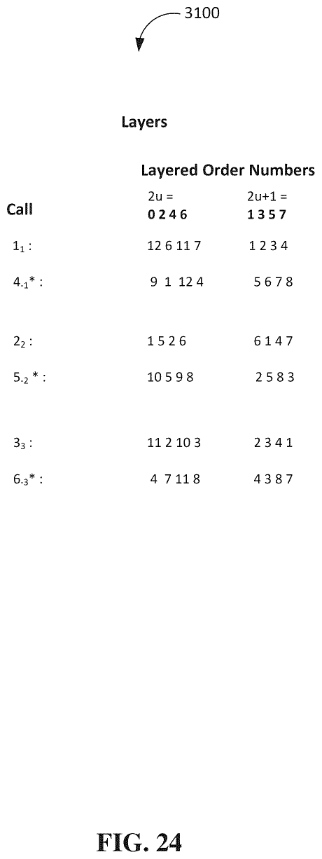

As shown in FIG. 24, we see p, q, r index an order 1, . . . , 6≡o6 as 3 polarities. Each call informs a layer of 9=1+8 variable matrix objects called from fixed locations in the layer order. That called variable data translates relative to the fixed conjugates. Each aligned conjugate pair in forms an identity:

lₖ(0,0(±ap),0(±bq),0(±cr)),

k=m⊕n∈o12⊕o8≡o20,

a,b,c∈{0,1},

p,q,r∈±o3.

The operator action on layers is

τ_{±p}(s)×o9(1_{±p},o8(u_{±p}⁰,u_{±p}¹))(±o2,±o3)→1_{±p}⊕σ₄₈(u⁰,u¹)(+o2′,+o3′)•(−o2,−o3).

In the layering of the matrix the variables have a fixed inverse image over the same layer order:

1_{±p}∘o8(u⁰,u¹)(+o2,+o3)+1_{±p}∘o8(u⁰,u¹)(−o2,−o3)=1_{±p}∘o8(u⁰,u¹)(0,0).

The operator action is

τ_{±p}(s)×o9(1_{±p},o8(u_{±p}⁰,u_{±p}¹))(±o2,±o3)→1_{±p}∘o8(u⁰,u¹)(+o2′,+o3′).

In measure, the variable may be projected over the fixed layer orders:

1_{±p}∘o8(u⁰,u¹)(+o2′,+o3′)•1_{±p}∘o8(u⁰,u¹)(−o2,−o3)=1_{±p}∘o8(u⁰,u¹)(Δo2,Δo3).

The order differences Δo2, Δo3, may be measured to relative 2, 3-cycle numbers:

σ5(Δo5)=σ2(Δo3)⊕σ3(Δo3).

The layers calls of the matrix, & the matrix orders, are partitioned modulo 4. As context is clear, the above may be denoted simply as a semi-direct operator product of the composition:

τ_{±p,4}⁴(u_{0,1}^{0,1})≡u_{±p,0,1}× [symbol] u_{±p}^{0,1}×σ⁴∘ρₚ⁴,

p∈1,2,3=o3,

d∈1,2=o2.

Note that the order may be indexed over a different modulo 4 partition, then the orientations may be done. It may be tracked both in measure. An in layering, 4_{0,1}=4^{0,1}. But in filtering, we track each w/in the scalar & vector orders.

Also, since τ_{±p}(1_{±p})=1_{±p}, we denote the (0, ±p)-layer operators as mixture of a direct product of a unit & a semi-direct product:

τ_{±p}(u_{0,1}^{0,1}(±d))≡1_{±p}⊕u_{±p,0,1}×σ₄(±d) [symbol] u_{±p}^{0,1}×σ⁴(±d)∘ρₚ⁴(±d).

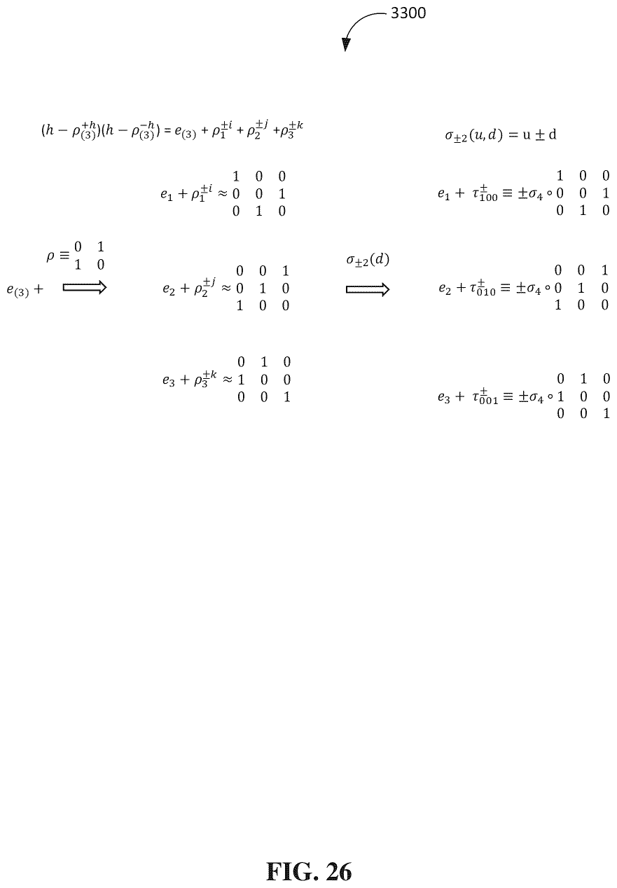

The matrix operator is shown in FIG. 26

The variables cycle, modulo 4, under the composite operator action:

τ_{±p,4}^{p}(u_{0,1}^{0,1},±d)=u_{±p,0,1}×σ₄(±d)o20(o12,o8)

[symbol]

u_{±p}^{0,1}×σ⁴(±d)∘ρₚ⁴(±d)o5(+o2,+o3)(−o2,−o3).

and

u_{±p,0,1}×σ₄(±d)o12 ∘o8=u_{±p,0,1}×σ₄(±d)o20(o12,o8)=o20′(o12′,o8′)

u_{±p}^{0,1}×σ5(σ2,σ3)≈u_{±p}^{0,1}×σ⁴(±d)∘ρₚ⁴(±d)o5(o2,o3)=o5′(o2′,o3′).

### Gating the Translated Matrix to Alignment Filter to the Combination Register:

Further, a channel data source associated with the disclosed access scheme is based on a 3D model of 6 directions, 12 bidirections, & 8 tridirections, under a single operator action, that doesn't mix directions of products, so informs a direct product of 20 permutable objects of a data matrix, that cover the 48 directions of the Rubik's group. This provides an enormous space of permutations provides the data for the SCAS access-keys, each bound to a user, via an encrypted passcode that generates the key, we have referred to as the user-combination.

In SCAS application, the gates have a form of an interesting complex. The passcode-combination memory is mediated by gates that allow access to the user-passcode, s, stored in a que of all equivalent passcodes. The gate mediates access to this equivalence class, of partitioned cublet alignments. The equivalence is founded on the equality of aligned cublet conjugates—those that inform the cublet identities:

zₖzₖ*=l_{κ}(0_{±p}0_{±q},0_{±r})(a,b,c)

p,q,r∈{1,2,3},

a,b,c∈{0,±1}.

k=(m,n)∈(o12,o8)=o20.

None of the misaligned cublets occupy the cubicle of their matrix order, in the cycle of the identity. Alignment requires both order & cycle of cubicle-cubie pair inform the 0 of disorder & their vector sum & product inform the 0 vector sum & product.

0=x^{p}+x*^{p},

0=x^{p}Λx*^{p}.

### Gating Sampled Matrix:

The sample gate is a complementary pair of inner & outer gates:

$${γ}_{+ 1}^{- 1} ( s ) = {γ}_{+ 1} ( s ) + {γ}^{- 1} ( s ) . \\ \begin{matrix}\vert {γ}_{+ 1}^{- 1} ( s ) \vert ≡ \vert {\sum }_{o 20} {γ}_{+ 1} ( s ) + {\sum }_{o 20} {γ}^{- 1} ( s ) \vert = \\ = \vert {\sum }_{o 20} {γ}_{+ 1} ( s ) \vert + \vert {\sum }_{o 20} {γ}^{- 1} ( s ) \vert \\ = 20\end{matrix} .$$

Each complement of the gate comprises 20 registers. Each register carries either a 0 or 1. There are always 20 0s & 20 is distributed over the gate. For a user-key, u≡u₁, . . . , u_{N}, there is a passcode. The a is constant, the γ₊₁⁻¹ vanish after use.

For simplicity we repress the u of s(u). The matrix operator sequence,

τ(s)I(s₀)=Πᵤτ(s)I

γ₁⁻¹(s)•τ(s)I(s₀)=γ₁⁻¹(s)•ΔI(s)=γ₊₁(s)•ΔI(s)+γ⁻¹(s)•ΔI(s).

### Where,

I(s)=γ₊₁(s)•ΔI(s)=γ₊₁(s)•I(s₀),

Γ(s)=ΔI(s)−I(s)=(τ(s)−γ₊₁(•s))!I(s₀)

=(τ−γ₊₁)(s)•I(s₀)=γ⁻¹(s)•ΔI(s).

The matrix operator is a modulo 4 composite:

τ(s(p,d))mod 4=τ_{±p}(±d)mod 4=σ₄⁴(±d)∘ρₚ⁴(±d),

p∈o3=1,2,3,

d∈o2=1,2.

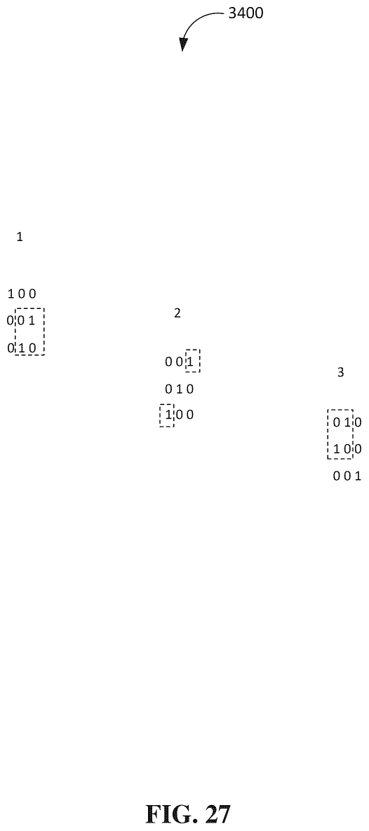

The ρₚ⁴ are unsigned spin-operators, or rotors, each bound to 1 dimension, orthonormal to 2 others, as shown in FIG. 27. The passcode, s_{N+1}, codes the operator command sequence:

Πᵤτ(s_{N+1}(u))I(s₀)≡τ(s)I=ΔI(s)So, our operator-complementary gating action is

γ₁⁻¹•τ(s)I=γ₁⁻¹ΔI(s)=I(s)+I′(s).

The filter generates the gate-number, a(s), & combination, C(s), from the gated distribution.

### Matrix State Meter:

We measure via a geometric algebraic product over a semi-direct group of quadruples of one scalar & a conjugate pair of vectors, that compose an order of coordinates of a fixed reference frame:

±zₖ=±1(k,(a,b,c)),

a,b,c∈{0,±½}

k∈o20=o12 ⊕12+o8.

We map into the constant of a variable-fixed conjugate complex identities, distributed over a 4-grade, Hestenes' frame, that provides the basis of observation & change. The changes map to meter composed of tangent stalks at each cubicle. Each stalks is composed of all cubies in all possible orientations. So the tangent stalk is composed of 2×12(2)=24(12, 2) 2-cubies over the 12 2-cubicles, & 3×8(3)=24(8, 3) 3-cubies over the 8 3-cubicles. The reference frame of the matrix covers the graded cube of

o6(p(±½)) of (0,1)(±½)-coordinates,

o3(0(±p))×u4(±q,±r)≈o12(u,0(±p),±o2(±q,±r)) of (0(p),2)(±½²)-quadrants,

o2(±½(p))×u4(±p,±q,±r)∘o8(u,½(p),±o3(±p,±q,±r)) of (±1(p),3)(±½³)-octants.

Where

p,q,r∈[1,2,3]o3,

u∈[1,2,3,4]o4.

These quadruples vary in 1 of the 2(±½) conjugates of a unit:

|±½|=|−½||+½|=1.

So the magnitude of the quadrant radials is √2 & those of the octants are √3. In layer, we translate √5(±Ψ(o5))=√2(±(I(o2)) ⊕√3(±4(o3)). Each radial phase varies homomorphically:

τ(s)√5(±Ψ(o5))=τ(s)(√2(±((o2))⊕√3(±4(o3)))

=τ(s)√2(±Φ(o2))⊕τ(s)√3(±∂(o3)).

As Ψ(Φ, ∂) vary, the orders circulate under an axial rotation in the framed space, we map to our data source matrix, via a 6-layer partition & call structure. The operator action is SU(2), Unitary in preserving the volume of the matrix frame. Our filter maps the matrix sample into the stalk space of 480=20 24=4×6×20 possible cublet pairings.

o4^{0,1}×o120(6^{0,1,20}_{0,1}^{0,1})=o4⁰×o72(o3(0)/o2,o12(0,σ2))

⊕o4¹×o48(o2(±1)×o3,8(±1,σ3)).

This represents the stalk filter, we deploy to align the matrix in a permutation of the identity matrix,

I₂₀^{±o5}≈o20 [symbol] √5(±Ψ)=o12 [symbol] √2(±Φ)⊕o8 [symbol] √3(±∂)≈Iₒ₁₂^{±o2}⊕Iₒ₈^{±o3}.

For convenience, we suppress the vector magnitudes & represent order in the index of units of order:

Iₒ₂₀^{±o5}≈Iₒ₂₀ [symbol] 1(±Ψ)=o12 [symbol] 1(±Φ)⊕1ₒ₈ [symbol] 1(+∂)≡Iₒ₁₂^{±o2}⊕Iₒ₈^{±o3}.

This is our direct source (cublet) matrix; we call each layer by coordinate index, ±p∈±o3(o6). Layers correspond to coordinates of Cartesian system. This is the coordinate system of our Hestenes frame. Our data are conjugates of coordinate vector sums, factored, such that

eₚ=x^{p}•x*^{p}.

We do not factor coordinates, we factor coordinate vector sums of 2 & 3 coordinates. The coordinates are fixed, as the call of the variable layer of the matrix call. So we have a geometric space of conjugate identities we mix into the nonidentities of the Rubik's Group, & sample to measures bound to a user, via user-key to passcode encryption, s→e(s), of a combination, C(s), generator, κ₁²(γ₊₁⁻¹ •(s)Iₒ₂₀^{±o5}) encrypted in a control message, or Channel Access Key (CAK(C(s))).

The matrix operator is such that we have a sequence

u=u₁, . . . ,u_{N}→s(u),

Πᵤτ(s(u))Iₒ₂₀^{±o5}→ΔIₒ₂₀^{±o5}(s)

γ₊₁⁻¹(s)•ΔIₒ₂₀^{±o5}(s)=γ₊₁(s)•ΔIₒ₂₀^{±o5}(s)+γ⁻¹•ΔIₒ₂₀^{±5}(s)

κ₁²(Iₒ₂₀^{±o5}+Iₒ₂₀^{±o5′})→C(s).

This last stage is the filtering, which is two sided, as the inputs & outputs of a data hold. Each of the complements of the (mis)alignment gate, γ₊₁⁻¹=γ₊₁⊕γ⁻¹ distributes the aligned & misaligned. The aligned are the data of the address functional:

a(s)=Σ2^{k}Xγ₊₁₍ₖ₎(s).

γ₊₁(s)=Σγ₊₁₍ₖ₎(s)=Σγ₊₁₍ₘ₎(s)⊕γ₊₁₍ₙ₎(s),

γ⁻¹(s)=1ₒ₂₀−γ₊₁(s).

k(m,n)⊂o20(o12,o8),

1ₒ₂₀=1ₒ₁₂⊕1ₒ₈.

|1ₒ₂₀|=|1ₒ₁₂|−|1ₒ₈|=12+8=20.

These k are those of the aligned cublets. the address a(s) is where a passcode is stored. This passcode does not relate to its user, or any of the encrypted versions of each one of those passcodes, that binds a user-key to a user-combination. The stored s∈a[s], at a(s), is used to compare a regenerated s to its image in the address space: a∈{1, 2, . . . , 2¹⁹}. The a(s₀)=0 is that of the null passcode (command), s₀ ∈ø. This is the address of the aligned cublet (source) matrix. A check of s via a matched filter, decides if a request for control of the combination generator is accepted.

The filter generates the gate-number, a(s), & combination, C(s), from the gated distribution. This gate-number & combination the user's access-key to the secured channel:

κ_{0,1}²(γ₁⁻¹•τ(s)I)↔(a(s),C(s))

So

κ_{0,1}²(γ₁⁻¹•ΔI(s))↔a(s)

κ₁²(γ⁻¹•ΔI(s)↔C(s)=C(s₀)+C′(s).

These are representative of s(u) & C(s(u)), referenced to the alignment gate-number, a(s). So, for s∈a[s], a user's pair, (s, C(s)) are represented by our filtering:

(a,C)(s)≈(1,C)(s).

If accepted, a combination is generated from the command sequence, s, bound to the user-key sequence of natural numbers, u∈N, of however many permutations. For u=u₁, . . . u_{N} there are N! permutations. And the sample set is denumerably infinite. We place no theoretical, but do impose practical limits on the number of natural numbers in a user's key sequence. we varied from 1 to 13 in our simulations, & generated thousands of unique combinations & passcodes, a pair that binds to a user. We denote this pairing a (1, C)(s(u)). These, together, inform a permission pair of an access request to a desired channel, or data source.

These are facts of matrix-operator, τ(s), the sample-alignment gating, γ₊₁⁻¹, & alignment filtering, κ_{0,1}², structures.

This is not a direct product, as the a(s) do not inform a group. The gates do inform an identity of inverse products, so inform a group. The negative sign is due to our defining the forbidden state of full alignment as a₀=a(s₀). But since a(s) is not unique to the user, & s is, it is this pair that is unique to the user. The binding of s & a(s) is explicit. The binding pair, as coded on the UQ & in CQ, is

(1,C)(s)≈(a,C)(s).

These C(s) are representative measures of (0, 2)-multivector residuals of the projective product measure:

μZ′(s)•Z*≡κ₁²(γ₊₁⁻¹•ΔI(s))→C(s).

This map is reversible, in theory. We do not reverse it in practice, so the directional arrow. The forbidden Combination is:

C(s₀)=1+i0(σ2),2+i0(σ2), . . . ,12+1+i0(σ3), . . . 12+8+i0(σ3).

The acceptable combinations have form:

C(s)=m₁+iσ2m₁,m₂+iσ2m₂, . . . ,12+n₁+iσ3ₙᵢ, . . . 12+n₈+iσ3ₙ₈.

So the masked combination is

σₒ₂₀(C(s))=[k₁+iσ5ₖ_{₁},k₂+iσ5ₖ_{₂}, . . . ,k₂₀+iσ5ₖ_{₂₀}][σₒ₂₀]≡C′.

Where,

k₁+iσₖ_{₁}∈o12+iσ2ₒ₁₂∩o8+iσ3ₒ₈

≡o12+iσ2ₒ₁₂⊕o8+iσ3ₒ₈

≈o20+iσ5ₒ₂₀.

### Matrix Sample Alignment Filtering:

The alignment-filter is a couple of a 6-cycle filter, over 5(2, 3) dimensions, over a space of 5(3, 2) multivector grades. The coded simulation objects are denoted

A6(3,2)_6(2,3)×A20(12,8)_5(2,3)=A120(6,20)(5(3,2),5(2,3))

≈A120(72,48)(3,2)(2,3).

Where, as orders we have

σ6⁰(o3,σ2(o2))×o12(o2)≈o3(0,σ2(o2))×o24(o12,−o2)

=o72(o3,o24)(o12,σ2(Δo2))

σ6¹(o2,σ3(o3))×o8(o3)≈o2(±1,σ3(o3))×o24(o8,−o3)

=o48(o2,o24)(o8,σ3(Δo3)).

Where, 3(0, 2) cover the 3(0) 2-grade quadrants & 2(±1, 3) cover the conjugate 2(±1) of conjugates ±1ₚ of 3(0ₚ), for each dimension of order 1, 2, 3≈o3. And we define the alignment-filter stalks of 24 over the cyclic orders as

o24^{0,1}(o20,σ5(−o5))=o24⁰(o12,σ2(−o2))⊕o24¹(o8,σ3(−o3)).

And

o5(0,±1)×o24^{0,1}(o20,σ5(−o5))=o3(0)×o24⁰(o12,σ2(−o2))⊕o2(±1)×o24¹(o8,σ3(−o3))

=o72(0,σ2(−o2))⊕o48(±1,σ3(−o3)).

Also

o20′(o5′)(s)•o24^{0,1}(σ5(−o5))→o20[20′(o12′,o8′)+i×σ5(Δo5)]

This filter feeds the alignment-hold. The hold feeds the combination register, via a matrix stalk-filter, A20×24 (the name of the object deployed in the simulator). The alignment-filter is 2, 3-cyclic, & the combination filter captures those cycles in the occupied cubicle, of a fixed order of 20 registers, each holding a complex number, representative of the cubie's order & relative orientation—w/in the occupied cubicle, w.r.t. the imposed 2, 3-cyclic orders:

σ2∈o2(0,1)∩o2(1,0),

σ3∈o3(0,1,2)∩o3(2,0,1)∩o3(1,2,0).

The orientation of the 2, 3-cubie is derived from a comparison of the 2, 3-cubie w.r.t. each of the each orientation of its 2, 3-cycles. Each 2, 3-cubie has 2, 3-images to compare, & each is assigned a cycle number, as shown above for the 2, 3-cycles:

σ2(±Δo2)∈{0,1},

σ3(±Δo3)∈{0,1,2}.

Further, it may be mapped to a relative cycle number: σN(ΔoN)→{0, 1, . . . , N−1}. We can do this, as each 2, 3-cubie 2, 3-cycles in every 2, 3-cubicle, & every 2, 3-cubicle is occupied by each 2, 3-cubie in 2, 3-cyclic ways.

By offsetting the even o8 register of the direct matrix, we inform a register of

o20=o12 ⊕12+o8.

In masking (cf. paper 2) the combination we impose this offset to both the register order, o20 & the disordered data,

Δo20(s)=Πₛσ₄o20(s)−o20=o20′(s)−o20=o12′(s)−o12 ⊕12+o8′(s)−o8

=(Δo12 ⊕12+Δo8)(s).

So the variation of the Δo20 order data is

Πₛσ₄o20(s)=o20′(s)=o12′(s)⊕12+o8′(s).

This may be exploited to inform a register of 20 registers, each register holding a complex number, that includes the direct disorder of o20=o12 ⊕o8 & the order of the signed differences that inform the cycle matches:

σ5(±Δo5)=σ2(±Δo3)⊕σ3(±Δo3).

This may be captured & the cyclic variations via the disclosed gating, as:

$$\begin{matrix}C ( s ) \approx {γ}_{+ 1} ( s ) \underline{\cdot } o 20 + i \times σ5 ( 0 , 0 ) + {γ}^{- 1} ( s ) \underline{\cdot } o {20}^{′} + i \times σ5 ( Δ o 5 ) \\ = o 20 ( s ) + i \times ( 0 , 0 ) + o {20}^{′} ( s ) + i \times σ5 ( Δ o 5 ) ( s ) \\ = o 20 ( s ) + o {20}^{′} ( s ) + i \times σ5 ( Δ o 5 ) ( s ) \\ \approx o 20 [ Δ20 ( Δ o 12 , Δ o 8 ) + i \times σ5 ( Δ o 5 ) ] ( s )\end{matrix} .$$

These data inform the user's combination. This combination is encrypted as the CAK, of the secured channel.

The combination filtering is an important, required description—as part of the overall description of the SCAS.

### CAK Generator:

C(s) may be generated from s. The generation of s, & C(s), via the gating is described below. The generation of the passcode, s from the user key, & also a paper on the encryption of s onto the user-que is discussed. Further, the encryption, or masking of the combination, is associated with an encryption key of the mask. This key is a timecode, constructed from the UT's clock sample.

T=[[Y,M,D],[H,M,S]]∈[[100,12,31],[24,60,60]].

The timecode, T, associates with a permutation of 20! possible permutations of C(s). The encryption of T comprises 17 number registers. Part of T is the associates with this permutation key:

σ_{20!}(HMS(T))∈o20!

The whole T of which is provides a security check for access to the Combination Que, CQ, of the Access Point, AP, that holds all combinations that warrants access:

if s(u)∈aₙ[s] then C(s(u))∈CQ→access.

aₙ(s)∈2²⁰−1.

There are 2¹² even, & 2⁸ odd, alignment decisions. So there are 2²⁰=2¹²×2⁸ alignment decisions, 1 of which is never assigned to any user. This forbidden alignment is that of all 20 aligned, which is the alignment identity of the matrix. This is the initial state for ever combination generated by a user's passcode, s. We denote the aligned register as the forbidden alignment of no misalignments:

C(s₀)=o20+i0(σ5ₒ₂₀).

A mask of C(s)↔C′ may be encrypted with a timecoded key, T=[[Y, M, D], [H, M, S]]. The HMS is a key associated with the mask key, which is 1 of 20! possible permutations of the 20 registers of complex numbers. The complexes are unchanged, only their place in the register order.

### Combination Mask:

C(s₀)=1+i0(σ2),2+i0(σ2), . . . ,12+1+i0(σ3), . . . 12+8+i0(σ3),

C(s)=m₁+iσ2ₘ₁,m₂+iσ2ₘ₂, . . . ,12+n₁+iσ3ₘᵢ, . . . 12+n₈+iσ3ₙ₈.

So the permutation mask is

σ_{o20!}(C(s))=σ_{o20!}(k₁+iσ5ₖ₁,k₂+iσ5ₖ₂, . . . ,k₂₀+iσ5ₖ₂₀)=C′.

Where,

k₁+iσ5ₖᵢ∈o12+iσ2ₒ₁₂∩o8+iσ3ₒ₈≈o20+iσ5ₒ₂₀

≡o12+iσ2ₒ₁₂⊕o8+iσ3ₒ₈.

Time plays a part as an encryption key associated with the permutation key of the combination mask. Time is sampled from the UT's clock, & the [H, M, S] register addresses the associated permutation key. The combination is masked via the associated keys:

σ_{20!}(HMS)C(s)→C′.

Time is also encrypted & concatenated to inform the payload message: C′_T′. Both T′ & C′ are decrypted, in both the SET & ACCESS objects, that are the primary objects that mediate this security access scheme.

Timecode Encryption: Time is sampled from the UT's clock, partitioned modulo p as the levels & residues.

T=[[Y,M,D],[H,M,S]]

Tmod p=[[Y,M,D]i,[Y,M,D]r,[H,M,S]i,[H,M,S]r].

The l, r indices are for the level & residue of a modulo-p (prime) division of the elements that represent Year, Month, Day, Hour, Minute, Seconds of the device clock sample. We encrypt time, T, as

σ_{4×(3,1)}Tmod p=[σ_{(3,1)}[Y,M,D]ₗ,σ_{(3,1)}[Y,M,D]ᵣ,σ_{(3,1)}[H,M,S]ₗ,σ_{(3,1)}[H,M,S]ᵣ].

The (3, 1) indexes an order of 3 addressed by the 1 array index. There are 3!=6 permutations of an order of 3. These 4 are also permuted, in 1 of 4!=24 ways, to mix the final encrypted timecode:

σ_{4!}σ_{4×(3,1)}Tmod p=σ_{4!}[σ_{((3,1),1)},σ_{((3,1),2)},σ_{((3,1),3)},σ_{((3,1),4)}]T≡T′.

And the payload is C′_T′, which denotes T′ appended, or concatenated to C′. The is the channel ACCESS request message. The SET payload is C′, with no timecode tag.

### The Access Point Decryption:

σ_{4!}⁻¹σ_{4×(3,1)}⁻¹T′ →Tmod p→T=T₁×p+Tᵣ

T→HMS(T)

σ_{o20!}⁻¹(HMS(T))(C′)→C.

Where T₁ denotes the modulo level, & Tᵣ denotes the residue of the division. All this functionality may be built into the AP, that manages the set of a user's combinations, & also handles the access requests, via SET & ACCESS objects. The access decision is:

if C=Cₙ∈CQ(AP): access permitted, else denied.

The default p is 7, to partition H∈24, M∈60, & S∈60.

Permutations of 20+17=37 all require inverse keys to descramble the permutation. So for the 20+17 registers of permutation requires a memory addressable by the HMS(T). This is a hash table of 3 levels of 24×60×60=86400 samples of 37! The 86400 of 20! is associated with the HMS(T) key. So, deploying these tables, available on every user-terminal, UT, & the Access Point, AP, as distributed by the AP on command by the network administrator. This last layer of ACCESS request mixes all 37 registers in 1 of 37! possible ways to encode the masked combination & encrypted timecode C′_T′:

σₒ₃₈(σₒ₂₀(C(s(u))_σ₄σ_{4×(3,1)}Tmod p)→σₒ₃₈(C′_[21[S]]_T′_[17[σ₄]])→C′T′[21[S]][17[σ₄]]_[39].

This is unmasked at the AP,

C(s(u))_Tmod p+←σₒ₂₀⁻¹C′_[21]_σ₄⁻¹σ_{4×(3,1)}⁻¹T′ ←σₒ₃₈⁻¹(C′T′[21[S]][17[α₄]]_[39]).

Tₙ=1ₙ×p+rₙ→T=[[Y,M,D],[H,M,S]],n=1,2.

These objects (in R) may be built as part of a channel simulator associated with the disclosed access channel scheme, & each of these reversible operations may be verified.

The passcodes is derived from a user-key, that is never exposed, as it resides only in the user's brain. The passcode derived from the key is varied randomly, via a splice, & checked against existing passcodes—of a search of a single equivalence class of passcodes:

s(a)∈a[s].

If s=s′,s is varied again, until

s≠s′,s(a),s′(a)∈a[s].

The combination, C(s), is generated on a unique s, then checked against the combination-que, CQ(AP). During SET, if C(s)=Cₙ ∈CQ(AP), s is varied & C(s) regenerated, until unique. So, the logic is

if C(s)≠Cₙ∈CQ(AP): set C(s), else vary C(s).

Note that the decision criteria for SET & ACCESS are oppositional. These are the only objects of mediation. There are objects to regenerate & deliver the association tables. Each table, of 24×60×60=864000 entries, is regeneratable by the administrator of the channel. The AP may be imagined as residing in a gateway, that links the user device with another network, or a database, or a device, as desired by the users who require such security.

Both channel interface objects, GMI & API, encipher, decipher, & interpret payload message. This is so for all channel states. The combination is never exposed on the network.

The weak points in the application are the storage of the passcodes, s, in que a[s], addressed by gate numbers, a(s). A hacker of some skill somehow gets access to a user-terminal, they can get beneath/behind the gate numbers, to reveal a que of passcode strings. Each string codes a user combination, which is required to decide access, to whatever is secured by our secure channel access scheme.

To generate a viable combination from the passcode, the hacker has to also get access to a user-terminal (unlikely in a sufficiently secured network); but, having gained that, the hacker has to bypass the GUARD object, which verifies all stored passcodes against a reconstructed matched passcode, encrypted onto a user's que, UQ. An hacker would have to breach the GUARD, or avoid it. To avoid it, the hacker has to exploit the combination generator, the source matrix, & the matrix operators.

If the passcode & operator are deployed by a hacker to generate its combination, this is level of breach is still deficient to gain access to the channel. The hacker would also have to figure out how to construct a timecoded encryption key (HMS-key), & decipher how the associated keys mask the combination mask. As the hash table of the associates is a 3-level call to the mask via a composite address of Hours, Minutes, Seconds.

The call of the mask mixes the user-combination. And this same call is used to unmask the combination. And the unmasker decrypts a datetime code to retrieve the HMS-key, that unmasked the user-combination. And that reconstruction of T from T′, to unmask C(s) from C′, requires a decipher of T′ & C′ from the scramble of 39 registers of complex numbers that code each CAK. And no CAK is repeatable.

As the HMS key is required at both source & sink of the channel protocol, the timecoded key would have to be encrypted & concatenated to the mixed combination, to inform the acceptable CAK as the only transport payload accepted by the Access Point, that mediates channel access.

And so, these security checks have to be deciphered & deployed, for any intruder to gain access. Uncovering passcodes on gate numbers is insufficient to gain access, lacking understanding of the encryption-decryption scheme that deploys a timecode. So, if the s stored at a(s) is an issue.

In a firewalled gateway, there is no way to hack the gateway from a user-terminal device, so a hacker would be unable to bypass the security checks required to expose the combination que, as required for access permission.

As the timecode masks every combination exposed in the network transport (with viable payload encoder), the disclosed system also secures against a network sniff by an intruder (hacker), to capture & redeploy a captured payload. And the masking & scramble with the associated timecode assures a user's combination is never exposed on the network—not even during a user's combination SET routine, as simulated in our testing of the protocol.

And each access request is constrained by a Time Filter, TF, of a set time window, that denies capture & reuse for all deciphered timecodes outside the window boundary—a deciphered timecode must follow (by some set multiples of seconds) the last time of access request, by any authorized user. Every access request & set of a new user's combination is datetime stamped on the gateway & the user-que. And the deciphered timecode must be a later time than the one stored & deployed by the Access Point, AP, that mediates access in guarding accesses to the combination que, CQ that resides on the gateway. This que access check uses the entire timecode, so each datetime code is used only once per 100 years.

So, an attempt to hack the AP routine, would require a hacker access to the gateway. And that is impossible, if the gateway is firewalled. To avoid a hack via the transport, the interface of the transport & application layers of the communication protocol restricts access to the payload message format & ports. No messages are accepted, but those parsed by this interface for delivery to the AP's interpreter.

Although there are weaknesses in the protocol's structure, as a whole, the scheme provides sufficient security for those who require clearance for restricted access, of whatever might be secured by our security scheme. The disclosed scheme imposes no restrictions on the network protocol, including how the transport payload might be encrypted. Further, any channel that requires such security, would also require encrypted payload. But that is not essential for our scheme, as the CAK is encrypted.

The hash tables of course reside on every device on the network that is part of the secured channel. These table are updated via the administrator, as they decide the schedule. All updated tables are delivered from the gateway to each terminal. The objects that handle this are separate from the AP. A typical file transfer protocol may be deployed in channel simulations. TCP/IP payload methods may be used in the simulations.

The tables, if exposed, do provide useful information, so the payload of the network transport, requires encryption—of payload or transport—for the security of the channel. In the simulations, the table data may be encrypted using 1 permutation key to modify each for transport from the gateway to a user-terminal. And standards such as HTTPS/TLS, VPNs, public & symmetric key encryption algorithms, etc., are sufficient, as the security requirements determine.

The security protocol would be useful for high security clearance access—for access to SCIF, Top Secret, & Secret information. It would be useful to both military & industry.

### Security Via GMI Guard & API TF

In the GMI, the GUARD object checks the regenerated passcode, s(u). Ignoring the u: s→s(k/r, v) against all those passcodes, s∈a[s], at address a(s)=a(s). If s is sanctioned (via the rules of the channel state: SET or ACCESS), the s is read by the translator, τ(s), to generate

Πₛτ(s)I→ΔI(s).

The check of s, at a(s) is whether s∈a[s]. And the decision of the check influenced by the state. If SET, the decision logic is

if s∉a[s] then s→a[s],

else s→s(v).

If the state is ACCESS, the logic is

if s∈a[s] then Πₛτ(s)I→ΔI(s).

else I≈I(s₀).

The above check of s∈a[s] entails a command sequence comparison be applied, if & only if the length of the s-sequence, |s| equals any s′∈a[s]. Where, recalling the u=u₁, . . . ,u_{N},

∀N→Nmod 24,|s(u_{N})|=1.

So

|s(u)|=|s(u₁), . . . ,s(u_{N})|=N.

It is possible to remove, while still allowing the GUARD to assure that a(s) exists, given s. This removes all s∈a[s]. The check of a(s)'s existence assures that the passcode is one of an existing class of passcodes, w/out validating the particulars of the passcode via a command sequence comparison.

Absent the s-sequence check, security is still assured via the s(cq, u/r, v) reconstructed from the encrypted passcode stored in the UQ_{ID}. So the removal of a[s] avoids the security check of s comparison, but nevertheless assures a hack will never discover either s(u), or u—as neither is stored on the user-terminal (device) of the GMI. Trying to decipher a UQ is difficult. Each, as simulated, is a simply a list of natural numbers, of scalars, arrays, & matrices of natural numbers, that together encrypt each user's passcode s(cq, u/r, v), where cq designates the index of the command matrix of the passcode source:

s(p, d)∈o24_{eq}[s(o6(±o3), o4(±o2))]. The passcode encryption is stored in the UQ & secures access to the combination generator:

UQ(s(u))→s(cq,u/r,v)(p,d)→UQ_{ID}[cq,r[cq[s₁,s₂],1₁,1₂],v[2×l(v)]](p,d).

Each sub-que, r[ ], v[ ] stores pointers to commands in the assigned command permutation of o24. These data are stored in the UQ, which is on the UT. So, the advantage to the removing the a[s] from a(s) may be seen. The UQs are the only data available to a hack, that might be exploitable, but given the encryption, that is clearly less likely. Lacking the s, the combination generator is useless.

The user-combination, C(s), is not stored locally on the user-terminal device, UT. Recall that the measure functional resolves (0, 2)-graded pairings, as an array of complex scalars:

κ_{0,1}²(γ₊₁⁻¹•Πₛτ(s)I)→o20[(Δo2O+i xσ5(Δ5))(s)]≡C(s).

All C(s) are stored in the combination-que, CQ, which is guarded by the channel API, that resides on the network gateway, GW. And each C(s) is stored w/out any reference to s, simply as

C=o20[Δo2O+i xσ5(Δ5)].

This combination is a permutation of 20 complex numbers, derived via an sample of the source matrix under the operator action, τ(s)=6(s)∘p(s), we discuss elsewhere in our description of the application. Each C each distinct, or unique, & each is bound to a user, via the UQ_{ID} encryption of the user-key.

A sample of the UT clock generates the datetime available to the GMI. The time encryption (ignoring the imaginary mask on T′) is such that

Tmod 7→T[YMD[σ₃₍₁₎],YMD[σ₃₍₂₎],HMS[σ₃₍₃₎],HMS[σ₃₍₄₎]]

Tmod 7→Tmod 7[σ₄]≡T′.

And this is part of the control message:

C′_T′→C′T′[21[S]][39[σ₃₈]]

The decipher objects parse the masked combination & encrypted timecode:

C′T′[21[S]][39[σ₃₈]]→C′T′

T′[σ₄⁻¹]→T[YMD[σ₃₍ᵢ₎],YMD[σ₃₍₂₎],HMS[σ₃₍₃₎],HMS[σ₃₍₄₎]]

T′[σ₄⁻¹] mod⁻¹7→T

T=T[Y,M,D,H,M,S].

Where, for residuals, r(T), & levels, l(T):

Tmod⁻¹7=1(T)×7+r(T).

The API Time Filter, TF, guards access to the combination-que, CQ. Following the message decipher & reconstruction of the datetime code,

T_{N}=[Y,M,D,H,M,S].

The HMS-key is the register, [H, M, S]. The T_{N} is compared to a prior T≠T_{P}, & the difference of comparison must be w/in a window of a number of seconds.

$$Δ T = {T}_{N} - {T}_{P} \geq {T}_{W} .$$

Time differences are assured, given the irreversibility of time. T=T_now is always greater than T=T_then, where T_then is the T of the previous access request acknowledged by the API. T_then is stored & accessible, as managed by the API, in our simulations of the channel access scheme, or what is our control protocol.

The seconds must provide a sufficiently wide envelop of time to cover timeout of the transport layer's attempts to access the gateway, GW. If the transport times out (in handling more than one access request, which is highly unlikely), the user-combination must regenerate. This is the case with any transport that times out on failure to access the application GW. The user-interface must handle timeouts, whether the TF is deployed or not. The GW must include a router & an OS able to run the application layer of the network protocol, which is required to deploy the API.

Passing the API TF, the HMS-key then retrieves σ₂₀⁻¹ from the table of combination masks. This mask is deployed to unmask C from C′, for comparison with the C that resides in the CQ. The comparator decides, as required via the state control stored in register 21 of the deciphered message. This API security supplements the security assured via the encrypted security of the enciphered message, C′_T′, & the security assured by the GMI, via the user-passcode encryption.

This is the user-combination, & it serves as the user's channel access key, or CAK. The control message may be referred to as the CAK. So, the API guards the C register, via a mediation of each deciphered C with each C∈CQ.

### Set & Access:

Further, a simplified flow chart of the SET & ACCESS sequencing avoids the network that links the UT & GW, which can be imposed. The networking case may be simulated, using a transport protocol to link an emulator of the User Terminal, UT, with an emulator of the Access Point, AP, during both SET & ACCESS. The networked distribution association may be accounted for, which are required for the encryption scheme—what is designated as HMS-tables. These tables associate the Hour, Minute, & Seconds (from a network standard clock) timecode with a permutation table entry.

The HMS call is composed of 3 layers: H=24, M=60, S=60, for a total of 86400 association permutations, per table. These may be deployed to encrypt the 20(5) complex numbers of the user-key-combination deployed for access, to whatever the network secures. How often the tables are updated, is the network administrator's to decide. It may provide the objects required to build the tables in the AP, & deliver them to each UT in the secure channel.

To set/establish a user's combination, we establish a unique array of o20(σ5), unique complex numbers of o20(o12, o8) (dis)orders, of σ5(σ2, σ3)-cycle numbers, that code the user's combination, & is bound to the user-key. The user-key, k, that is not stored in the system. The passcode is stored on the alignment-gate number, but in no way links to a user-que, UQ, which encrypts the splice-variation of the key's passcode sequence.

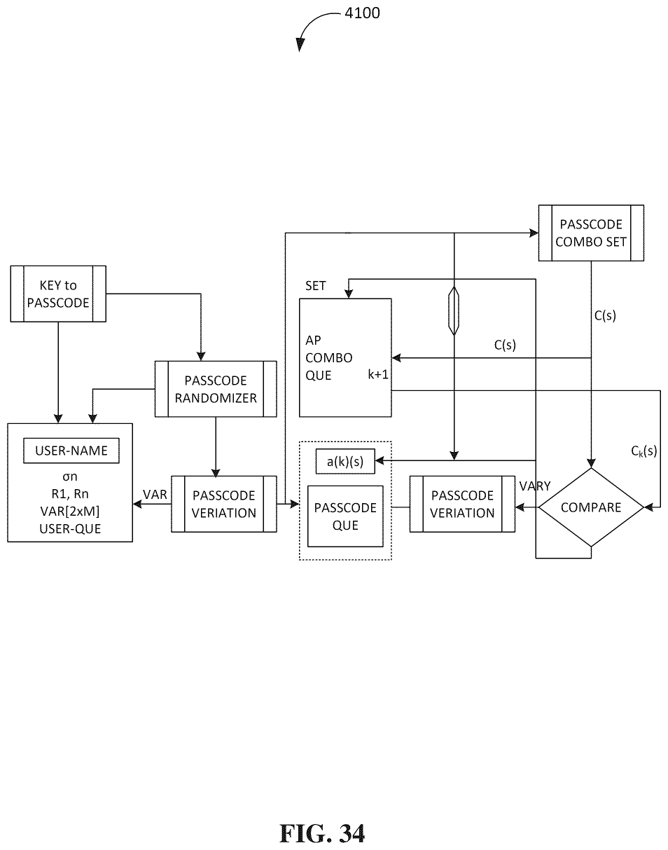

The SET state flow from key to passcode to combination is shown here, in FIG. 34. The 3 numbers H, M, S, are divided modulo a base number, to generate 6 numbers. Each of the 2×3 numbers of residues & levels, are permuted in 1 of 6=3!ways. The permutation is identified as 1 of the 3!=6 possible permutations. So each of the 2×3 modulo registers, has another number, to make for 2×[3, 1]=2×4=8 numbers for both the H, M, S. We impose the mixture on the Y, M, D, triplet, & deploy 2×8=16 numbers, to encrypted a supplement to the masked version of user-combination of 20! possible permutations, with an access restriction register of 16=4×4[3, 1] numbers, it also permute, & attach the permutation index number, of the array of 4!=24 possible permutations. So we encrypt 6 numbers in 17 numbers, as permutable orders

o4x[o3,1]+1=[o4[o3,1],1]=[o16[o4,o4],1]=o17[o16,1].

So the encrypted timecode, TC(YMD, HMS) occupies a register of 17 numbers, that carry an encryption of the 2×3=6 numbers of (Y, M, D), (H, M, S), that attaches to permuted C(s). The permutation sequence of C(s) is stored in the HMS table, & is recalled by HMS. YMD serves another security check, that is independent of the HMS call to the associated permutation of the combination, required to decipher the encrypted TC. The timecode is encrypted, by a permutation of 4!(3!)=3!⁴=1296 permutations of the modulo residues & levels, where the divisor is defaulted to 7, which is prime, & does not divide either 24 or 60, evenly. There are 3 levels in 24 modulo 7, & 8 levels in 60, of the 7 residuals, 0, . . . , 6.

The 4 arrays of [3, 1] may be permuted, based on the index number of the 4! possible permutations of the 17[4×4[3, 1], 1], to reorder the 4×4 timecode

4[3,1]=[[σYMD]ᵣ,[σ_{YMD}]ₗ[σHMS]ᵣ,[σHMS]ₗ].

This reconstruction then permutes each 3, of [3, 1], via the 1 index of each permutation, to reconstruct the numbers Y, M, D & H, M, S:

2×4[3,1]=N×YMD₁+YMDᵣ=YMD,

2×4[3,1]=N×HMS₁+HMSᵣ=HMS.

Where N is the modulo divisor of the encryption scheme of the timecode. We use the residue & level to reconstructed the 3 numbers of YMD, & the 3 of HMS, from the 17 numbers of the 6 encrypted TC numbers, [[Y, M, D], [H, M, S]].

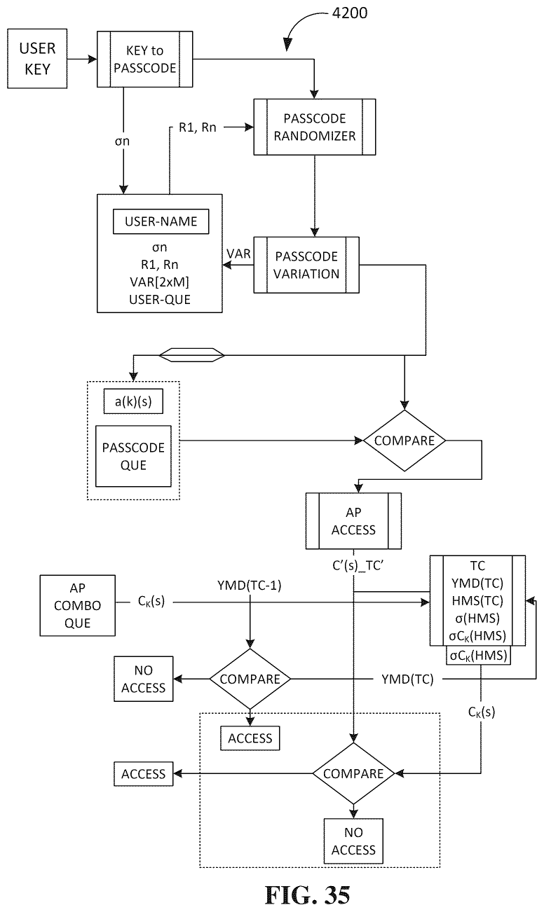

The ACCESS flow is shown in FIG. 35. This shows a simplified flow diagram, or chart, of the application's access flow. After the user-key-combination, C(s(u)), is SET, it is used in an encrypted form, C′(s(u)), appended with the TC, to again access to whatever is secured. The HMS associates with the σ(20!) permutation of the C′(s(u)), needed to compare the combinations in the CQ on the AP. The YMD & HMS, together as a pair are used to gain access to the CQ on the AP, to compare the user's C′(s(u)) with each combination, under the same permutation, σ₂₀(20!)C, for each C∈CQ, until a match is found. If no match is found, the access request is denied.

In the disclosed scheme, the user-key-combination, C(s(u)), is never exposed to the network, except during SET. This secure channel, of an unpickable, nonreusable combination may be simulated, that can't be sampled & redeployed, as it never repeats the YMDHMS code, for 100 years.

A timecode may be encrypted, to encrypt the user-combination for delivery from UT to the AP, the user-key-combination, C(s(u)), is never exposed on the network. And the user-key, k, is not stored on the UT; instead, an encryption of a user-passcode (of the key) is stored on the user-que, UQ, on the UT, & the passcode, s(u), is stored on a gate-number, a(s(u)), unique to the passcode, s, & every member of its equivalence class. Multiple passcodes—in theory, an infinite number—can be stored on a single gate number. And there is no link between a(s) & the UQ that encrypts s(u), given the user-key.

This details the channel control message, carried in the transport protocol (as payload, that might or not be further encrypted), via the transport layer.

The masker-encryptor-scrambler, MES( ), & its inverse descrambler-decryptor-unmasker, SEM( ), serve both the GM & AP. The iMES( ) attaches the GCM_SAG( ) object that generates the passcode & mixes the cublet matrix, GCM, into the sample-alignment gate, SAG, & into data HOLD of the alignment-filter, A6_6 of (3, 2) 6-cycles over the (2, 3) composites.

To simulate the GM-AP communication a GMI( ) & API( ) object mediate the message exchanges. Each of the objects, SET( ), ACCESS( ), EXIT(, & CLEAR( ) contains the pair, (MES( ), iMES( )). SET( ) contains the combination filter, that include the C CQ comparator, C_CQ_COMP), & C_CQ_UD( ), where this UD, or updater, is contained a variation call on a match of C with an element of CQ.

If the C(s) is varied, this occurs in the GM, after a rejected SET attempt to place C in CQ, on the GW, by AP( ). So, that variation object will have a front end SEM( ), & it will return to the delivery to AP( ), for check & SET, if novel, & otherwise the loop continues. Our loop has been verified to 5040 (1, C)(s)—but we will pursue further limits before delivery of the final package—so we do expect a quick validation of C, by the now distributed decision loop, that includes GM & AP, exchanging encrypted messages over the channel, via a simulation of our Secure Channel Access Scheme.

The communication wrappers mask the combination, encrypt the timecode & scramble (a larger mask) the message:

C[o20[[o12,o8][σ2,σ3]]][σ₂₀[H,M,S]]→C′[o20[[o12,o8][σ2,σ3]]],

T[[Y,M,D],[H,M,S]][σ₄₍₃₎]→T′[4[4[3,1],1]]

C′[o20[[o12,o8]][σ2,σ3]],1]_T′[4[4[3,1],1]][σ₃₈[365[1]]]→C′T′[38,1].

The scrambler mixes the concatenated masked combination with the encrypted timecode. There may be an inverse pair:

C′T′ [σ₃₈][σₒ₃₈⁻¹[39]]→C′[σ₂₀]_[21]_T′[σ_{4(3)],}

T′[σ₄₍₃₎][σ₄₍₃₎⁻¹]→T[[Y,M,D],[H,M,S]]

C′[σ₂₀][σ₂₀⁻¹]→C[o20[o12,o8][σ2,σ3]]],

The objects that perform these operations are wrapped around the communication calls between the GM object VARY_C_MES( ) & the reduced C_CQ_UD( ) in API( ). The API( ) may be rebuilt, to suit simulation, & description.

MES & iMES work both sides of the channel, as the exchanges are between the GMI & API—so each must cipher & decipher the payload. Testing of following is performed: A socket, a file write-read, & an Open file method, of an immediate transfer that is never stored, so does not have to be removed, as less dynamic file transfer requires. We do not save any of the message traffic. The user-combination is never exposed. The user-key is never stored. An encrypted que binds the user to their user-passcode—which is regenerated after SET, to regenerate the user-combination for ACCESS to the secured channel. The never exposed combination & never stored key, are reassurances of security.

The system has sufficient intelligence to generate novel pairs (1, C)(s). There is a pair of cipher-decipher objects (composed of multiple sub-objects) that mask, encrypt, & scramble the message to avoid any possibility of guessing the combination. All combinations are stored in the combination-que, CQ, accessible to the API object. GMI & API mediate an exchange of the cipher-decipher of the user-combination:

σ_{o12,o8}C(s)→C′(T),

σ_{4!(3!)}T→[T′,1]

σₒ₃₈[C′(T),1]_T′]→[C′(T),1]_T′,1].

So

σ_{o12,o8}[o20[o12,o8](s)→o20[o12,o8′],

σ₄₍₃₎[o4[o4[o3,1]]→[o4′[o4[o3,1],1]

σₒ₃₈[[o21][[o20′]1]_[016[o4′[o4]],1]]→o39[[o21,o17],1].

This designates the payload cipher—the security key of every user, each unique to that user, & perhaps repeatable, over TIME—as the HMS values are bound to the seconds that compose a day, which is 86400 seconds, per day, of 3600 per Hour, & 60 per Minute, which the encryptor addresses as a 3-level hash, the GMI & API share.

These association tables of permutation keys are essential to the system security, & are stored locally on the devices of the GMI & API—what we've referred to in the descriptions as the user-terminal, UT, & the channel gateway, GW. The network administrator distributes these tables via file transfers, from the GW to all participating UT. We've simulated these file transfers using socket connection transfers & file transfers. These tables can remain outside the application, in UT memory. There are two types, each called by during cipher-decipher exchanges:
GMI generates C
SET/ACCESS/EXIT/CLEAR cipher-payload-transport
receive-payload-decipher
decide state: SET/ACCESS/EXIT/CLEAR
cipher-payload-transport-reply (AP decision)
regenerate C to SET (conditioned on AP decision).

After ACCESS, the user EXITS the control channel. The channel will close after a set timeout imposed upon the transport connection. We have imposed such restrictions in our simulations.

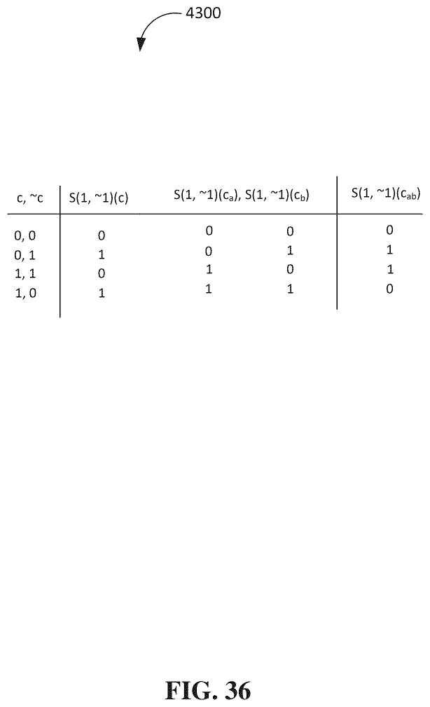

FIG. 36 shows tables that hold for all controls, c_{χ}∈↔≡{SET, ACCESS, . . . }, where, in the above, a, b designate elements of ↔. A control logic error routine may be built, that does not proceed if more than one control is set, as conditioned by the XOR exclusions.

The EXIT control sets i[5]—of the state decision condition indicators that permits access to each of the other states, via a passcode check & update, via the s_CHECK_UD & GUARD objects. But, as EXIT implies an active ACCESS, so there is no need to regenerate the passcode & its check, & i5 is decided by the results of those checks. So, the i5 default is loaded with the EXIT control (default 0).

All EXIT need do is close the data port, as we emulate in the API, we will eventually simulate via the two active R global environments—one harboring GMI, the other, API.

And these will link as we've already linked, via the TCP or UDP sockets of a transport protocol. The source model is valid. The Rubik's Cube simulator validated that the channel model is valid. Our GATORMOTE simulator validates it. The layers may be emulated below the transport protocol of the network protocol stack and the application interfaces at the transport layer, as designed & described.

The following are the original aspects of the systems, methods, apparatuses, and devices for facilitating secure communication: Timecoding an association key; using a model of a Rubik's Cube as the source for the combination generator; encrypting the user key sequence, u, into a list of numbers as scalars & arrays in the user device. This user-que, UQ, is read & deciphered to reconstruct the user passcode, s(u), from the user's-key, i.e., a natural number sequence, u=u₁, . . . , u_{N}. The reconstructed passcode regenerates the user's combination, C(s(u)), via the operator sequence:

κ₁²(γ₊₁⁻¹•Πᵤτ^{±p}(s(u))I)→κ₁²(ΔI(s))=κ₁(I(s))+κ²(Γ(s))≈C(s(u)).

Where τ_{±p}(s)=σ(s) ∘ρₚ(s), is a sequence of a composite modulo 4 SU(2) operator representative, & s(u) maps into s(±p, ±d), which carries two control parameters:

±p∈±o3(o6),d∈±o2(o4).

There are 24=|o4|×|o6| commands. In this discourse, a order of N natural numbers is 1, 2, . . . , N ≡oN. The alignment filtering of the mixed matrix, ΔI(s(u)), to the combination C(s(u)) is also unique, in being an invention of my own.

In the above, I denotes the combination data (cublet) matrix—which is an image of a 33 Rubik's Cube of 27 objects, addressable by coordinates & coordinate factors:

eₚ(x^{p},x*^{p})=x^{p}•x*^{p}.

The necessity of s is evident, but our storing it is unnecessary, if the check it provides is decided less secure than removing s from the system. As s is a function of the user key sequence, u=u₁, . . . , u_{N}, which is also not stored, there is only the user's que, UQ[ID], bound by ID to the user, that links u with s(u), & s(u) with C(s(u)).

The operator, τ(s) operates

τ(s)eₚ(x^{p},x*^{p})=τ(s)x^{p}\sqrt{•}x*^{p}=½×(x^{p′}•x*^{p}+x^{p}•x*^{p}).

If x^{p′}=x^{p},then

τ(s)eₚ(x^{p},x*^{p})=½×(x^{p}•x*^{p}+x^{p}•x*^{p})=eₚ(x^{p},x*^{p}).

Cublets are vector products, we represent as vector sums. Both the vectors & multivectors translate identically under the SU(2) action:

τ_{±p}(s(p,d))=σ(d(s))∘ρₚ₍ₛ₎(d(s))

Where, for

uₙ,n∈

[symbol]

s(p,d)≈s(uₙ mod 24).

And the vector sums & multiplications translate equivalently under the operator action:

$$\begin{matrix}{z}_{k ( m , n )} ( ap , bq , cr ) = {z}_{k ( m , n )} ( a \times {x}_{k}^{p} + b \times {x}^{q} + c \times {x}_{k}^{r} ) \\ \approx {z}_{k ( m , n )} ( a \times {x}_{k}^{p} ⋀ b \times {x}^{q} ⋀ c \times {x}_{k}^{r} ) = {x}_{k}^{pqr} ( a , b , c )\end{matrix} . \\ \vert {z}_{k ( m , n )} \vert = \vert {z}_{m} \vert + \vert {z}_{n} \vert = 1 + 1 = 2 .$$

The amplitudes are normalized. And

τ_{±p}(s(u))zₖ(ap,bq,Cr)≡zₖ(ap,bq,cr)′(s(u))≈xₖ^{pqr}(a,b,c)′≡τ_{±p}(s(u))xₖ^{pqr}(a,b,c).

For p∈±o3(o6), d∈±o2(o4) there are 24=6 4 s-commands in a command register. We shuffle multiple registers as part of the encryption scheme. Which register is bound to the UQ[ID], accordingly.

Also our alignment measure product is a projection of a geometric product over each dimension:

```
k′(m′, n′)−k(m, n) ⊕ zₖ(ap, bq, cr)′z*ₖ(−ap, −bq, −cr) ≈ Δk ⊕ xₖ^{pqr}′(a, b, c)′x*ₖ^{pqr}(−a, −b, −c)
  ≈ Δk(Δm, Δn) ⊕ z_{Δk(Δm, Δn)}(x^{p}′x*^{p} + x^{q}′x*^{q} + x^{r}′x*^{r})(a′−a, b′−b, c′−c)
  = Δk(Δm, Δn)
⊕ z_{Δk(Δm,Δn)}(x^{p} • x*^{p} + x^{p} \hat{ } x*^{p} + x^{q} • x*^{q} + x^{q} \hat{ } x*^{q} + x^{r} • x*^{r} + x^{r} \hat{ } x*^{r})(a′−a, b′−b, c′−c)
  ≡ Δk(Δm, Δn) ⊕ z_{Δk(Δm, Δn)}(Σₒ₃ αₚ′−αₚ × x^{p}x*^{p}.
  αₚ′, −αₚ ∈ {±a, ±b, ±c}.
  Where
  z_{k(m,n)}(a × p, b × q, c × r)′ ∈ Z′ (s(u)),
  z*_{k(m, n)}(−ap, −bq, −cr) ∈ Z*,
  z_{Δk(Δm,Δn)}(c × p, b × q, a × r)′z*ₖ(a × p, b × q, c × r) ≡ zΔₖ(ΔΨ_{Δk}) ∈ Z′ (s(u))Z*.
  And
  ∀s ≠ s₀, if
  k(m, n)(s) ≡ m ⊕ n ∈ Πᵤ σ₄(s(u))o20(o12, o8) = o12 ⊕ o8,
  &
  zₖ(p, q, r)′(s) = zₖ(p, q, r)(s₀),
  then
  Z(s₀)Z* = I(s₀) ≡ I.
  else if
  ∀k(m, n)(s) ∈ Πᵤ σ4(s(u))(o12 ⊕ o8) = o20′(o12′, o8′) ≠ o20(o12, o8),
  zₖ(p, q, r)′(s) ≠ zₖ(p, q, r)(s₀),
  Z′ (s)Z* = ΔI(s) ≠ I(s₀).
```

We filter products of a pairs relative orientation to relative 2, 3-cycle numbers. We basically have an order of o48(o12, o8)(σ2, σ3) 2 stalks of o24(o12, σ2) & o24(o8, σ3), matched filter banks, where the 2, 3-cycles cover orders o2=(0, 1) & o3=(0, 1, 2), such that

σ2(Δo2)∈(0,1)∩(1,0),

σ3(Δo3)∈(0,1,2)∩(2,0,1)∩∪(1,2,0).

Where

Δo2=o2′−o2,Δo3=o3′−o3.

And oN′=σ(oN), where σ is the modulo 4 symmetric permutator operating of 2, 3-cyclic space representative of [symbol] _{2,3}^{11,7}. The stalks inform a direct order

o24(o12,σ2)⊕o24(o8,σ3).

The order of 24 contains each cubie of each cublet identity, where cubies vary & are bound in the matrix to a fixed cubicle. The filter of stalks attaches to each misaligned cublet. Each cycle of the stalk of cubie elements is replicated in the 2, 3-cycles, that represent its orientation, in the cubicle to which the filter attaches. So each cycle contains an image of each cubie:

σ2(o2)=o2(0,1)∩o2(1,0).

Both the order & its inverse of each cubie covers the 2-cycle. And by extension,

σ3(o3)=o3(0,1,2)∩o3(2,0,1)∩o3(1,2,0).

These cycles have an order in the union of potential orientations. So each permutation, σ, filter is uniquely identifiable. We filter this data into a hold. The hold serves a display & a combination generating filter, κ_{0,1}². The hold input filter links to the matrix, via our complementary gating over an (0, 2)-measure space. And independent of s(u), the gate, composed of 40=2×20 registers as a pair of complementary vectors of 20 objects each, is such that each register output is either one or the other, exclusive:

γ₊₁⁻¹=(γ₊₁+γ⁻¹),

γ₊₁•γ⁻¹=0

γ₊₁⊕γ⁻¹=1.

This sampling-gating imposes a exclusive-or logic of the relative orthonormals that vanish in the innerproduct, which is a functional over the aligned cublets of the source matrix. The XOR product imposes a 0 on the aligned cublets' outer-gate, γ⁻¹. So this gate's is provide a pass for the data of the misaligned cublets into the alignment filter, κ_{0,1}². Each gate indicator is a function of alignment measure:

γ₊₁(s)=Σ₂₀δ(z_{Δk}(Δψ_{Δk})(s)),

δ(z_{Δk}(Δψ_{Δk})(s)=0₀²⁽³⁾)=1,δ(z_{Δk}(Δψ_{Δk})(s)≠0₀²⁽³⁾)=0,

0₀²⁽³⁾=(0,(0(±ap),0(±bq),0(±cr)),

a,b,c∈{0,±1},p,q,r∈±o3(o6)≡−3,−2,−1,+1,+2,+3.

And both the gate & filter distribute as functions of s(u): So γ₊₁⁻¹(s(u)) & κ_{0,1}²(s(u)) are joined via the mixed matrix data hold, with the gate, γ₊₁⁻¹(s(u)), joining the matrix sample, ΔI(s) to the hold input, & the filter, κ₁²(γ₊₁⁻¹(s(u))) delivering the sampled matrix to the combination register, as C(s(u)). The κ₀(γ₊₁(s(u)) generates the gate number, a(s(u)) of the equivalence class of passcodes, s(u)∈a[s]. To bind the user to a passcode, we place a copy of s in an equivalence class que:

if s(u)≠s′(u′)& s(u),s′(u′)∈a[s],

then

a(s(u))=a(s′(u′)).

The s stored at a(s(u)) serves a check of a reconstructed s(u), which must be an element of a class, for this s to be passed to the matrix translator: τ(s(u))I→ΔI(s(u)). Filtering handles the rest, to deliver C(s(u)). The passcode, s(u), binds the user to the combination, C(s(u)). The s(u) are converted modulo 24 into a command sequence:

u=u₁, . . . ,u_{N}

s(u)=s(u₁, . . . ,u_{N})s(u)=s₁(u); . . . ;s_{N}(u).

s(p,d)[u]≡s₀;s₁(p₁,d₁)[u₁mod 24]; . . . ;s_{Nmod24}(p_{N},d_{N})[u_{N}mod 24].

The “;” is a command delimiter, read by the matrix operator interface. There are also two noveltyfilters that assure the uniqueness of s & C(s(u)) during the user's setting their combination. The secured channel has 4 states: SET, ACCESS, CLEAR, & EXIT. SET is run once, to establish a user. ACCESS is the state of every user's request for access. And time plays a roll, in serving as an associated key of a combination mask, & as a guard on the access requests, which are tracked over time via a register that contains the reconstructed time of the last successful use of the channel (in SET, ACCESS, CLEAR, or EXIT).

Our (date)timecoded encryption scheme, σ₄₍₃₎T→T′ is independent of the source matrix structure & action. This encryption scheme associates a generated combination, C(s(u)), with a permutation key, for mixing it, for transport. The translated C′=C(s(u))[σ₂₀(HMS)], where a is a permutation σ₂₀∈o20[o20]. There 20!symmetric permutations. We deploy tables of 24×60×60=86400 permutations, as the HMS addresses (keys) the permutation key used to mix C(s(u)) into C′.

We also encrypt [H, M, S] with [Y, M, D], to inform the Channel Access Key, as a function of CAK(C(s(u)), T)—it is a permutated, concatenated composite of C′(HMS) & T′, where σ₄₍₃₎T→T. The time permutator, σ₄₍₃₎, is embedded in both the user interface, GMI, & the Access Point interface, API, which are the interfaces of our simulated channel nodes (each acting as source & sink). There are 4!×6⁴=31104 permutations possible for every unique datetime coded factor of the CAK.

The CAK is decrypted via the AP. The AP mediates channel accesses, via comparisons of the decrypted C with those in the que of admissible combination keys, C(s(u))∈CQ. This is part of our SCAS, which is the name of our invention, as we reference it in the descriptions that will guide the assessors.

We also deploy a noveltyfilters to vary s & C(s(u)), to assure for all s there is neither s′=s nor C(s(u))=C(s′). We've deployed these filters to generate more than 5k pairs, (1, C)(s(u)), even if there are some u=u′. And the novelty filters assure a unique (1, C)(s), for however many (a, C)(s), in the class, a[s]. Via the equivalence, we now that (1, C)(s(u)) (a, C)(s(u)).

So a chain of sequenced events generates the user's passcode from the user's key sequence, u, s(u) determines their combination, C(s(u)):

u→s(u)→τ(s(u))I→ΔI(s(u))→κ_{0,1}²(γ₊₁⁻¹(s(u))•ΔI(s(u)))→C(s(u))→C′.

The user's encrypted Channel Access Key is a function of a datetime code, T=[[Y, M, D], [H, M, S]], that associates with the permutation key, of the masked combination, C′,

σ₄₍₃₎T→T′

C[σ₂₀(HMS(T))]→C′

C′,T′ →CAK.

Where H, M, S addresses a 3-level association table of permutations of the natural order of 20. The combination is encrypted & delivered from the user device to the Access Point, where it is decrypted & compared with C∈CQ, & a decision is returned in reply to the user interface. If C is in CQ, access is permitted & otherwise denied.

The encryptor deploys reversible, symmetric permutation of the secured information buried in the indecipherable data of the message shuffle & its association keys embedded in a concatenated encryption of a datetime code, T↔T′, part of which is a key to a reversible combination mask, C(s(u))+C′, that has to be deciphered to check the access permission of an established combination key, C(s(u)), which is embedded, along with T′, in the Channel Access Key:

CAK(C(s(u)),T)=C′T′_21[S]_39[σ₃₈].

We explicate this in the description of the system, although not exactly in this form.

But the CAK is a function of the user combination, C, & the datetime code, T. The S in register 21 carries the channel state indicator. Register 39 carries the permutation key to descramble the message. The keys to descramble C′ & T′ are embedded w/in them. Register 17 carries the decryption key for T′ →T, & T contains the decryption key for C′ →C.

Note on Security: If we remove the a[s] store, there is no interpretable trace of the user's access key sequence, passcode, or combination on any of the devices deployed to interface the user with the channel of desired access. We can still deploy the s generation scheme, but remove the check that s(u)∈a[s]. This removes the check of s that is otherwise required to gain access to the combination generator:

κ_{0,1}²(γ₊₁⁻¹•τ(s(u))I)→C(s(u)).

Note on Originality: The novelty, or originality, is in the use of a large permutation space of

[symbol]

≡ [symbol] _{2,3}^{11,7} [symbol] A_{12,8}.

This is the space of constrained permutations of S₄₈, of what is known as a semi-direct product space. Where [symbol] _{2,3}^{11,7} represents the normal subgroup, & A_{12,8} represents the even alternating subgroup of S_{12,8} we map into S₂₀ via our encryption scheme that permutes the combination, C(s(u)), & the timecode associate, T. We created the encryption scheme, using modular division & reversible permutations. Our use of a datetime code associated with a permutation key, is also an original invention, as is the encryption of s(u), which is also an invention of our own design & development. As are the novelty filters, which assure the uniqueness of (1, C)(s(u)) for each user of the application.

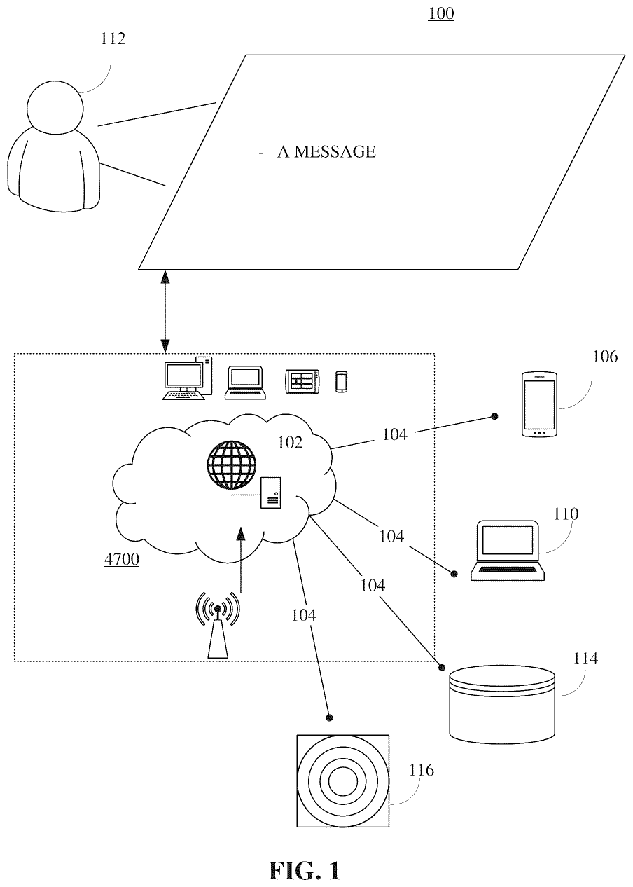

FIG. 1 is an illustration of an online platform 100 consistent with various embodiments of the present disclosure. By way of non-limiting example, the online platform 100 to facilitate secure communication may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 4700.

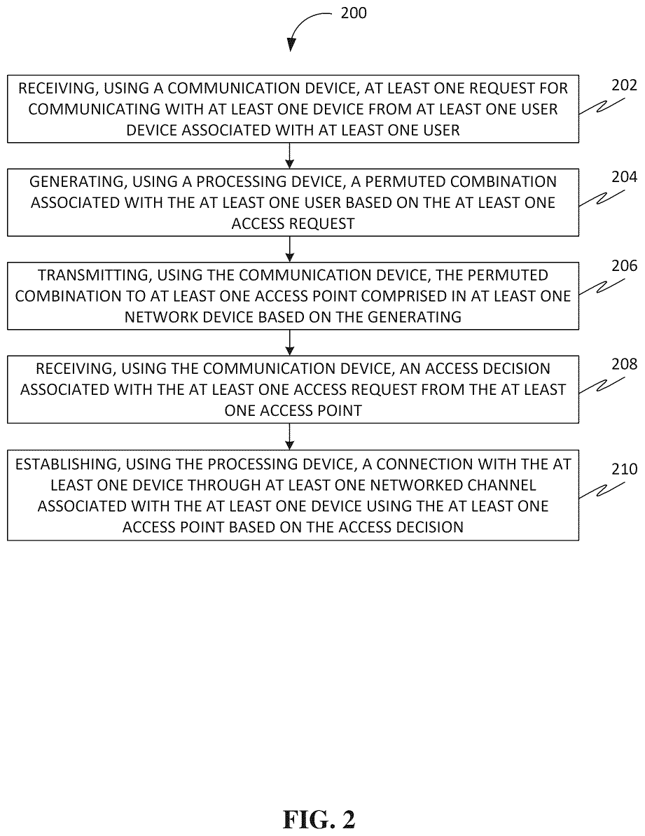

FIG. 2 is a flowchart of a method 200 for facilitating secure communication to a device, in accordance with some embodiments. Accordingly, the method 200 may include a step 202 of receiving, using a communication device, at least one request for communicating with at least one device from at least one user device associated with at least one user. Further, the at least one device requires restricted access. Further, the at least one request may include at least one access request. Further, the at least one access request may include at least one user identifier associated with the at least one user. Further, the at least one user device may include a user terminal, a user terminal device, a computing device, a client device, etc. Further, the at least one device may include a data source, a database, a device, a system, a monitored system, etc.

Further, the method 200 may include a step 204 of generating, using a processing device, a permuted combination associated with the at least one user based on the at least one access request. Further, the generating of the permuted combination may be based on a combination generator. Further, a model of a Rubik's Cube may be used as a source for the combination generator.

Further, the method 200 may include a step 206 of transmitting, using the communication device, the permuted combination to at least one access point comprised in at least one network device based on the generating. Further, the at least one access point may be configured for validating the at least one access request based on the permuted combination. Further, the at least one network device may include a gateway.

Further, the method 200 may include a step 208 of receiving, using the communication device, an access decision associated with the at least one access request from the at least one access point. Further, the access decision may include a positive access decision and a negative access decision.

Further, the method 200 may include a step 210 of establishing, using the processing device, a connection with the at least one device through at least one networked channel associated with the at least one device using the at least one access point based on the access decision. Further, the communicating with the at least one device may be based on the connection.

Further, in some embodiments, the at least one user identifier may include a user key (such as a user's-key). Further, the user key may include a user key sequence. Further, the generating of the permuted combination may include reestablishing a passcode using the user key from a user queue associated with the at least one user device based on the at least one access request. Further, the reestablishing of the passcode may include reconstructing the passcode. Further, the user queue may include at least one encrypted passcode of the at least one passcode. Further, the generating of the permuted combination may include regenerating a combination (such as a user's combination) associated with the at least one user based on the passcode. Further, the generating of the permuted combination may include appending the combination with an encrypted timecode associated with a clock. Further, the encrypted timecode may be nonrepeatable.

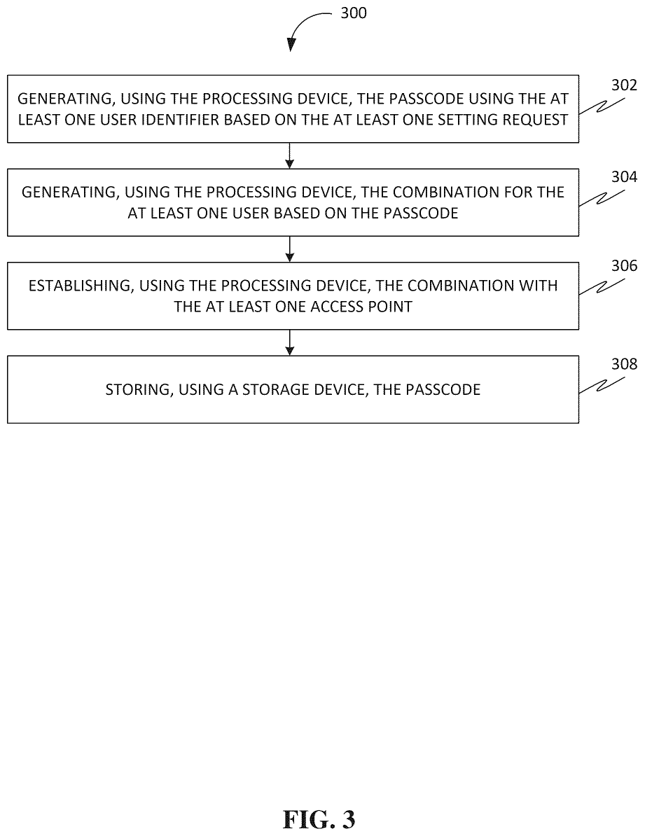

FIG. 3 is a flowchart of a method 300 for facilitating secure communication to the device, in accordance with some embodiments. Further, the at least one request may include at least one setting request. Further, the at least one setting request may include the at least one user identifier.

Further, the method 300 may include a step 302 of generating, using the processing device, the passcode using the at least one user identifier based on the at least one setting request.

Further, the method 300 may include a step 304 of generating, using the processing device, the combination for the at least one user based on the passcode. Further, the combination may be unique.

Further, the method 300 may include a step 306 of establishing, using the processing device, the combination with the at least one access point. Further, the at least one access point may be associated with a combination queue. Further, the combination may be comprised in the combination queue. Further, the validating of the at least one access request may include determining a match to the permuted combination from the combination queue.

Further, the method 300 may include a step 308 of storing, using a storage device, the passcode.

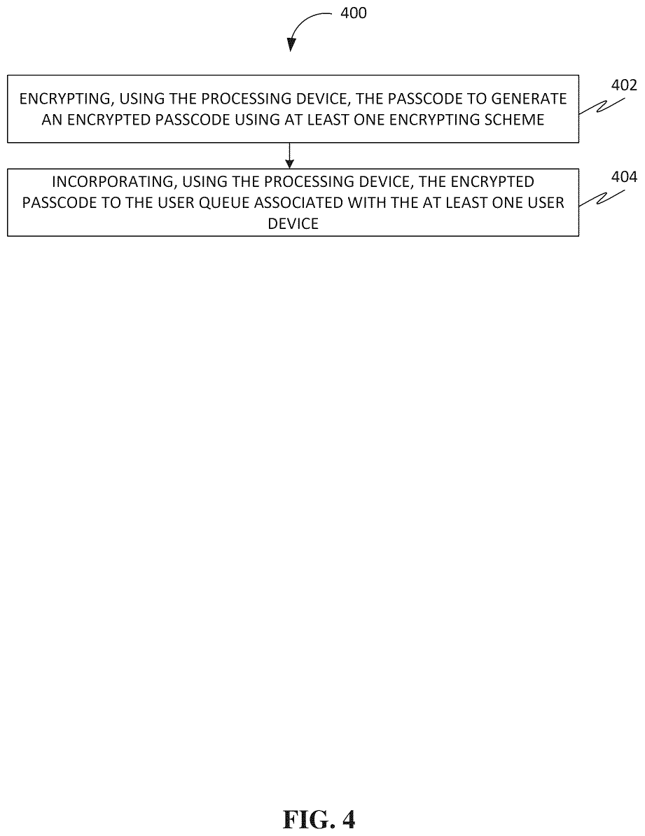

FIG. 4 is a flowchart of a method 400 for facilitating secure communication to the device, in accordance with some embodiments. Further, the generating of the passcode may include translating the user key. Further, the generating of the passcode may include encoding the user key into the passcode using a randomly generated data based on the translating.

Further, the method 400 may include a step 402 of encrypting, using the processing device, the passcode to generate an encrypted passcode using at least one encrypting scheme.

Further, the method 400 may include a step 404 of incorporating, using the processing device, the encrypted passcode to the user queue associated with the at least one user device. Further, the reestablishing of the passcode using the user key from the user queue may be based on the incorporating.

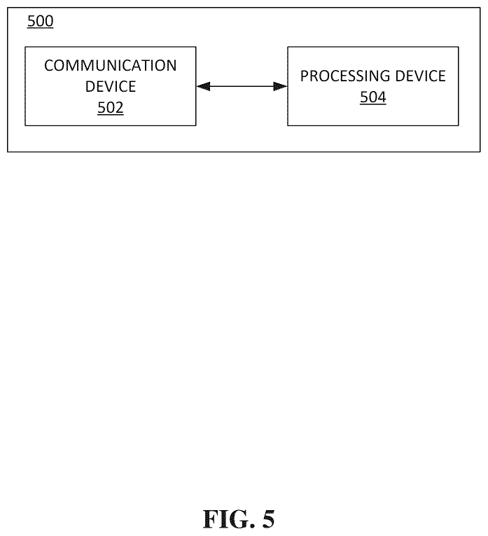

FIG. 5 is a block diagram of a system 500 facilitating secure communication to a device, in accordance with some embodiments. Further, the system 500 may include a communication device 502 and a processing device 504.

Further, the communication device 502 may be configured for receiving at least one request for communicating with at least one device from at least one user device associated with at least one user. Further, the at least one device requires restricted access. Further, the at least one request may include at least one access request. Further, the at least one access request may include at least one user identifier associated with the at least one user. Further, the at least one user device may include a user terminal, a computing device, a client device, etc. Further, the at least one device may include a data source, a database, a device, a system, a monitored system, etc. Further, the communication device 502 may be configured for transmitting a permuted combination to at least one access point comprised in at least one network device based on the generating. Further, the at least one access point may be configured for validating the at least one access request based on the permuted combination. Further, the communication device 502 may be configured for receiving an access decision associated with the at least one access request from the at least one access point. Further, the access decision may include a positive access decision and a negative access decision.

Further, the processing device 504 may be communicatively coupled with the communication device 502. Further, the processing device 504 may be configured for generating the permuted combination associated with the at least one user based on the at least one access request. Further, the processing device 504 may be configured for establishing a connection with the at least one device through at least one networked channel associated with the at least one device using the at least one access point based on the access decision. Further, the communicating with the at least one device may be based on the connection.

Further, in some embodiments, the at least one user identifier may include a user key. Further, the generating of the permuted combination may include reestablishing a passcode using the user key from a user queue associated with the at least one user device based on the at least one access request. Further, the user queue may include at least one encrypted passcode of the at least one passcode. Further, the generating of the permuted combination may include regenerating a combination associated with the at least one user based on the passcode. Further, the generating of the permuted combination may include appending the combination with an encrypted timecode associated with a clock. Further, the encrypted timecode may be nonrepeatable.

Further, in an embodiment, Further, the at least one request may include at least one setting request. Further, the at least one setting request may include the at least one user identifier. Further, the processing device 504 may be configured for generating the passcode using the at least one user identifier based on the at least one setting request. Further, the processing device 504 may be configured for generating the combination for the at least one user based on the passcode. Further, the combination may be unique. Further, the processing device 504 may be configured for establishing the combination with the at least one access point. Further, the at least one access point may be associated with a combination queue. Further, the combination may be comprised in the combination queue. Further, the validating of the at least one access request may include determining a match to the permuted combination from the combination queue. Further, the system may include a storage device communicatively coupled with the processing device 504. Further, the storage device may be configured for storing the passcode.

Further, in an embodiment, the generating of the passcode may include translating the user key. Further, the generating of the passcode may include encoding the user key into the passcode using a randomly generated data based on the translating. Further, the processing device 504 may be configured for encrypting the passcode to generate an encrypted passcode using at least one encrypting scheme. Further, the processing device 504 may be configured for incorporating the encrypted passcode to the user queue associated with the at least one user device. Further, the reestablishing of the passcode using the user key from the user queue may be based on the incorporating.

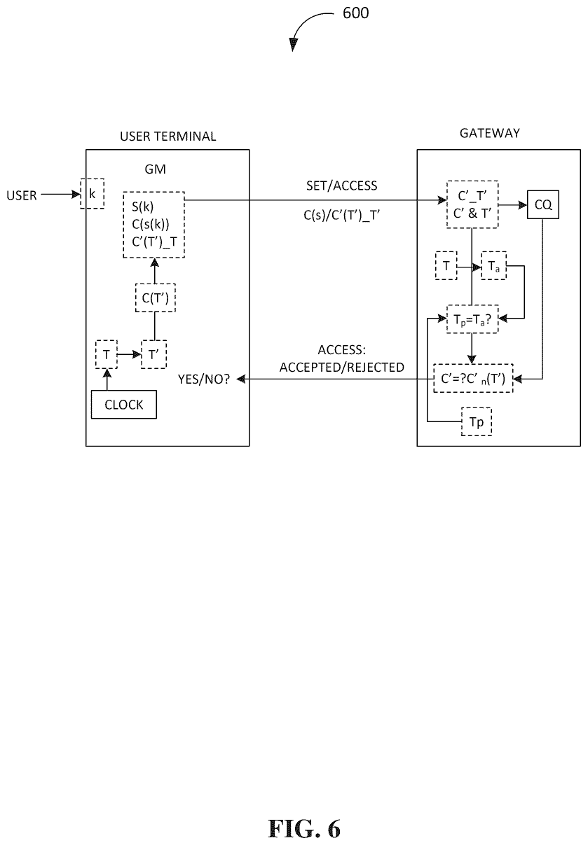

FIG. 6 is a schematic diagram of a system 600 for providing a secure channel access scheme to a secured networked channel, in accordance with some embodiments.

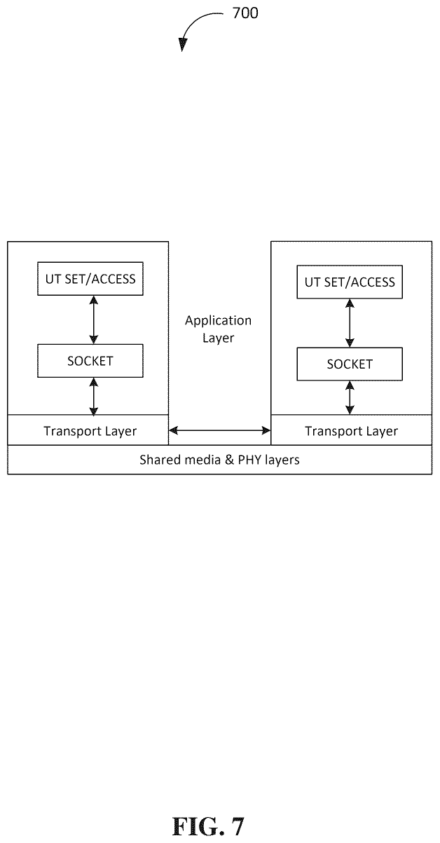

FIG. 7 is a schematic diagram of a channel associated with the system, in accordance with some embodiments.

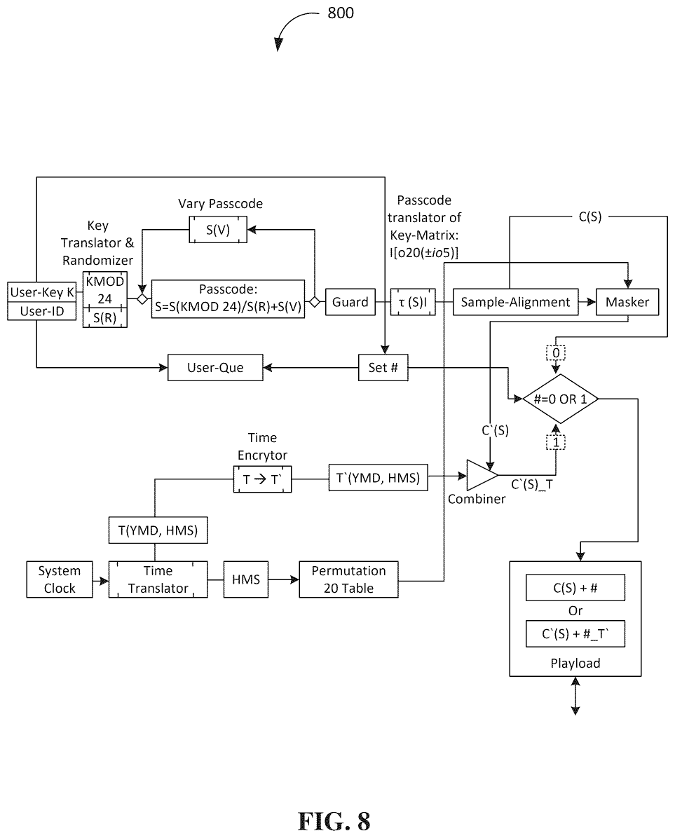

FIG. 8 is a flow diagram of a method 800 for performing SET and ACCESS by a user terminal providing a secure channel access scheme to a secured networked channel, in accordance with some embodiments. Further, at 802 and 804, passcode decision points may be varied as required. Further, the system clock 820 is a sample system clock. Further, at 806, the passcode is accessed by a combination generator. Further, at 810, the set combination is unmasked. Further, at 812, the SET # is 0. Further, at 814, the ACCESS # is 1. Further, at 808, the access request encrypted combination is combined with an encrypted HMS. Further, at 816, the combination+set # to & from the access point. Further, at 818, masked combination+access # with encrypted timecode to & from the access point.

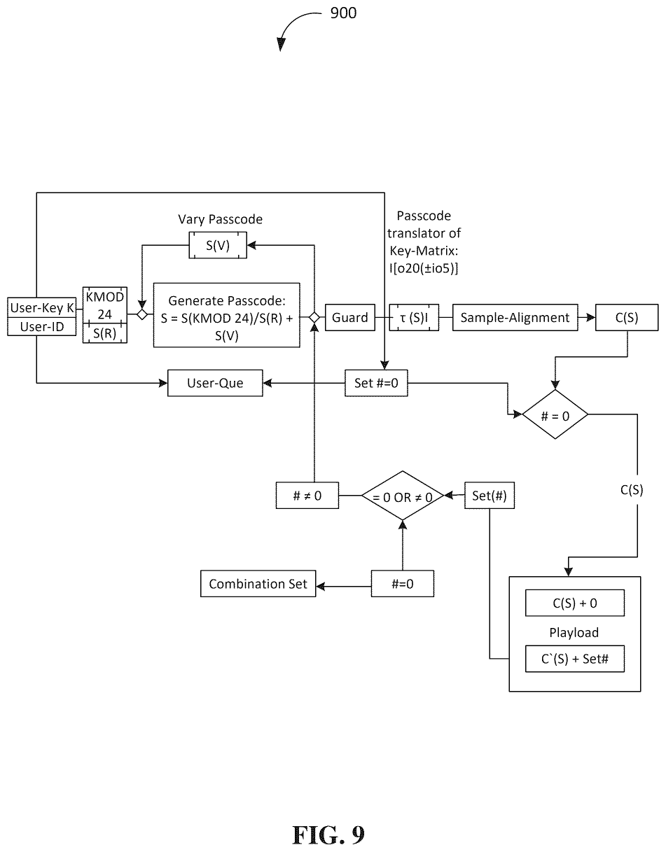

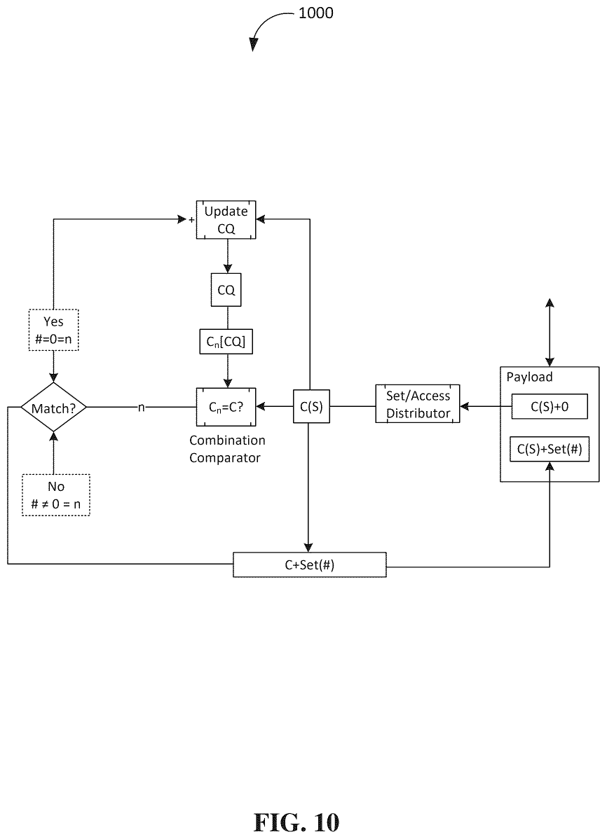

FIG. 9 is a flow diagram of a method 900 for performing RESET by the user terminal providing the secure channel access scheme to the secured networked channel, in accordance with some embodiments. Further, at 902 and 904, the decision points are varied as required. Further, at 906, the passcode is accessed by the combination generator. Further, at 908, the set combination is unmasked. Further, the set is performed at 910 and 912. Further, at 914 and 916, reset commands to and from the access point are performed.

FIG. 10 is a flow diagram of a method 1000 for performing SET by an access point of a gateway providing the secure channel access scheme to the secured networked channel, in accordance with some embodiments. Further, at 1002, the combination is accepted or rejected. Further, at 1004, the combination is matched with C=Cₙ. Further, at 1006, no combination is matched and CQ is updated. Further, at 1008, the C(s) is compared with prior combinations. Further, at 1010, the combination is returned with a set decision number (accept=0/reject≠0). Further, at 1012, a connection with the user terminal is provided.

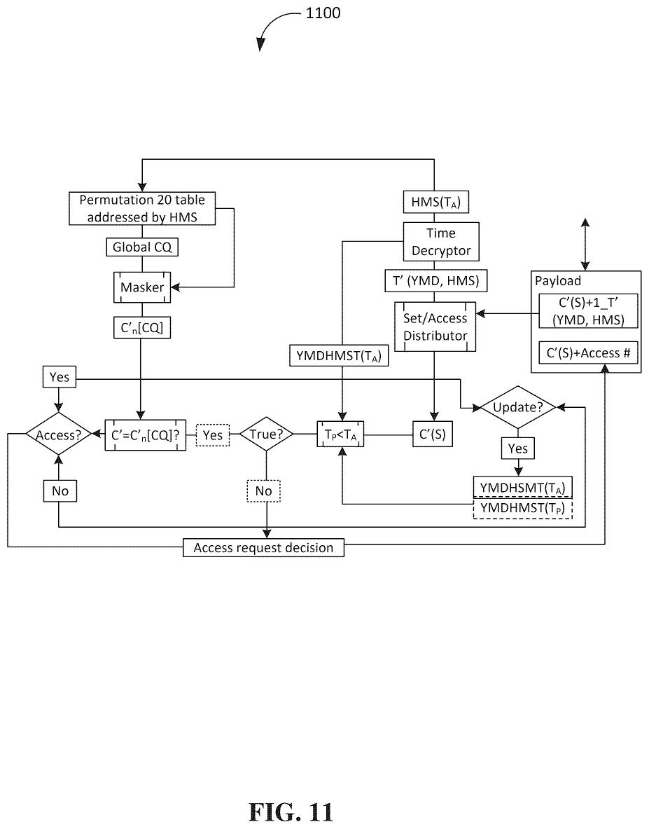

FIG. 11 is a flow diagram of a method 1100 for performing ACCESS by the access point of the gateway providing the secure channel access scheme to the secured networked channel, in accordance with some embodiments. Further, at 1102, the permutation mask is applied to each C of CQ. Further, at 1104, C′ of CQ is compared with C′. Further, at 1106 and 1108, the access request is accepted or rejected. Further, at 1110, the permutation codes are associated with HMS. Further, at 1112, a connection with the user terminal is provided. Further, at 1114, the time comparison is performed to allow or deny access to CQ. Further, at 1116, an active time replaces past time (T_{A}→T_{P}).

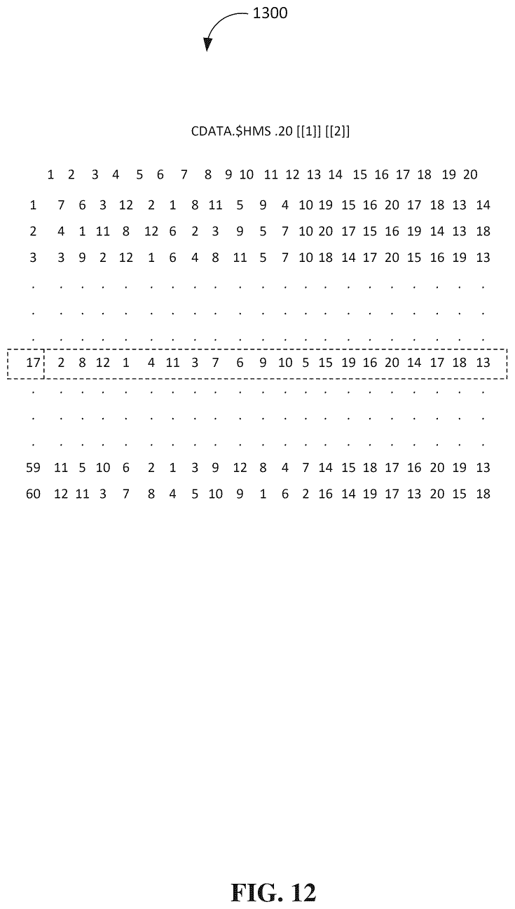

FIG. 12 illustrates a hash table 1300 for permutation order 20, for HMS-key of first hour, first minute, of all 60 seconds for providing the secure channel access scheme, in accordance with some embodiments. Each second holds a permutation key of the order of 20. The table is similarly structured over time, so associate via the HMS-key. Further, the HMS key is [1, 2, 17]. Further, the HMS key [1, 2, 17] corresponds to combination permutation at seconds element 17. Further, an example of HMS-key encryption for providing the secure channel access scheme may include a first HMS, a second HMS, first permutation levels and residues, second permutation levels and residues, first permutation IDs, second permutation IDs, a first encrypted HMS, and a second encrypted HMS.

The combination mask of second 17: 2, 8, 12, 1, 4, 11, 3, 7, 6, 9, 10, 5, 15, 19, 16, 20, 14, 17, 18, 13. This mask is inverted & applied to the combination for comparison with each combination in the global combination-queue, until/if a match is found. If the match is found, access is allowed & otherwise denied. We could likewise apply the mask as is against each combination of the que compared with the received combination. We deployed both methods in simulation.

The timecode is composed of 2×3=6 numbers: (YMD, HMS). These numbers are encrypted & appended to the scrambled combination before being exposed to the network each 3 of YMD & 3 of HMS numbers is encrypted into residue-floor pairs, so there are 2×2×3=4×3=12 numbers modulo 24 that compose the encrypted timecode. These residue-floors are permuted, & 2 id numbers append these sets of 12(4, 3) to make 16(4, 4(3, 1)). These id numbers distinguish unique permutations for each of the 4 sets of 4(3, 1). The 4×4=16(4, 4(3, 1)) are also scrambled in 1 of 4!=24 ways & appended with a unique id number to compose a scramble of 17(16(4, 4(3, 1)), 1) that completes the encryption of the timecode. The HMS is the association key. The YMD is also used to restrict access to the CQ of the AP. The YMD+HMS together allows access to the CQ in the AP.

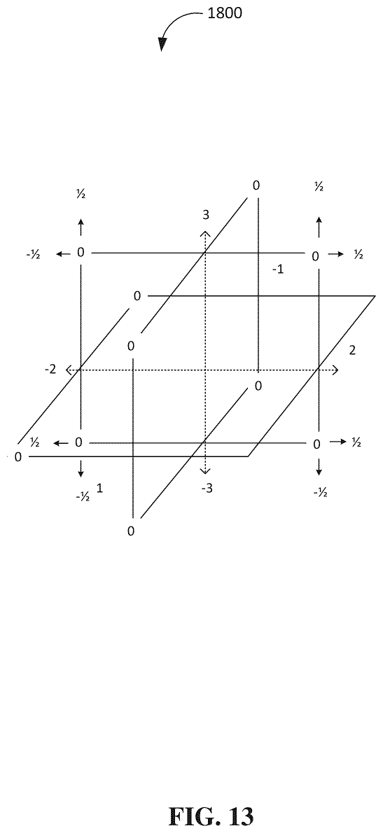

FIG. 13 illustrates factors of 0-bivectors with respect to reference coordinates 1800, in accordance with some embodiments.

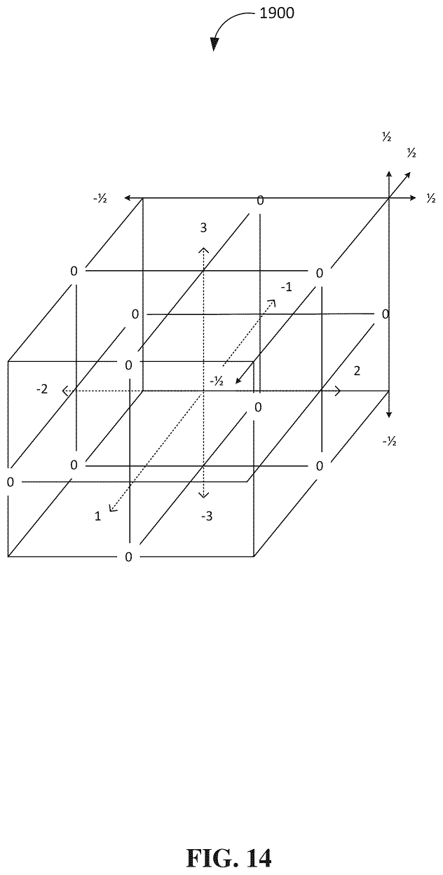

FIG. 14 illustrates factors of 0-bivectors with respect to reference coordinates 1900, in accordance with some embodiments.

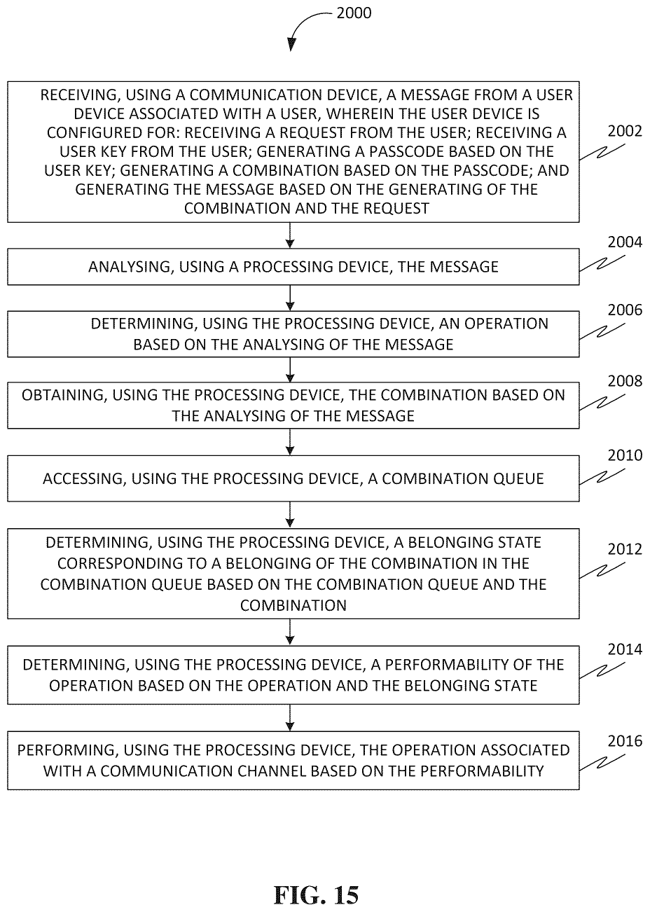

FIG. 15 is a flowchart of a method 2000 of facilitating secure communication, in accordance with some embodiments. Accordingly, the method 2000 may include a step 2002 of receiving, using a communication device, a message from a user device associated with a user. Further, the user device may include a computing device, a client device, a user terminal, a user terminal device etc. Further, the user device may execute an application. Further, the user device may include GATORMOAT Further, the GATORMOAT may be associated with a GATORMOAT interface (GMI). Further, the user device may be configured for receiving a request from the user. Further, the request may include a request for accessing a communication channel, a request for setting the communication channel for accessing, a request for clearing the set communication channel, a request for exiting the communication channel, etc. Further, the user device may be configured for receiving a user key (such as a user-key, a user's-key, etc.) from the user. Further, the user key may include a user key sequence. Further, the user key may be encrypted into a list of numbers as scalars & arrays in the user device. Further, the user device may be configured for generating a passcode based on the user key. Further, the generating of the user key may include reconstructing the user passcode from the user key. Further, the user device may be configured for generating a combination based on the passcode. Further, the generating of the combination may be based on a combination generator. Further, a model of a Rubik's Cube may be used as a source for the combination generator. Further, the combination may include a user combination (user-combination). Further, the user device may be configured for generating the message based on the generating of the combination of the request. Further, the message is carried in a transport payload, etc. Further, the message may include a channel access key (CAK). Further, the message may be encrypted. Further, the message servers as the CAK.

Further, the method 2000 may include a step 2004 of analysing, using a processing device, the message. Further, the analysing of the message may include deciphering the message. Further, the analysing of the message may include interpreting the message.

Further, the method 2000 may include a step 2006 of determining, using the processing device, an operation based on the analysing of the message. Further, the operation may include an access operation, a set operation, a clear operation, an exit operation, etc. Further, the operation corresponds to a state (such as an access state, a set state, a clear state, an exit state, etc.) of the communication channel.

Further, the method 2000 may include a step 2008 of obtaining, using the processing device, the combination based on the analysing of the message. Further, the obtaining of the combination may include reconstructing the passcode, and the regenerating the combination.

Further, the method 2000 may include a step 2010 of accessing, using the processing device, a combination queue. Further, the combination queue may be a combination que (combination-que)

Further, the method 2000 may include a step 2012 of determining, using the processing device, a belonging state corresponding to a belonging of the combination in the combination queue based on the combination queue and the combination. Further, the belonging state may include a positive belonging state in which the combination belongs in the combination state. Further, the belonging state may include a negative belonging state in which the combination does not belong in the combination state.

Further, the method 2000 may include a step 2014 of determining, using the processing device, a performability of the operation based on the operation and the belonging state. Further, the performability of the operation may include a positive performability in which the operation is allowed to be performed. Further, the performability of the operation may include a negative performability in which the operation is restricted from being performed.

Further, the method 2000 may include a step 2016 of performing, using the processing device, the operation associated with a communication channel based on the performability. Further, the performing of the operation may include providing access, performing setting, performing clearing, performing exiting, etc. Further, the communication channel may include a channel, a data channel, a secured channel, etc. Further, the communication channel facilitates the secure communication. Further, the facilitation of the secure communication may be based on a secured channel access scheme (SCAS). Further, the secured channel access scheme uses a control protocol, an access control protocol, a channel control protocol, a mediating protocol, etc.

Further, in some embodiments, the generating of the combination may include generating the combination using a sample of a source matrix under an operator action based on the passcode. Further, the source matrix may include a combination source matrix. Further, the combination source matrix may be associated with a combination source matrix structure. Further, the generating of the combination using the sample of the source matrix may be based on a model of the cube, as a semi-direct product matrix, I, of 20(12, 8) polarized direction vectors of 2, 3-directions, (equivalent to permutable orders), a matrix mixer, which is representative of a composite SU(2) operator, τ_{±p}(s), and an encryption scheme that deploys a time sample from the user terminal.

Further, in some embodiments, the user device may be configured for masking the combination. Further, the masking of the combination may include applying a mask (combination mask) to the combination, encrypting the combination, etc. Further, the masking of the combination may include masking the combination using one or more associated keys. Further, the one or more associated keys may include an encrypting key and a permutation key of the combination mask. Further, the combination is masked via a permutation associated with a timecoded key. Further, the user device may be configured for generating a masked combination based on the masking of the combination. Further, the user device may be configured for sampling a clock comprised in the user device. Further, the clock may include a system clock of the user device. Further, the user device may be configured for generating a datetime based on the sampling of the clock. Further, the datetime may include a date, a time, a timecode, a datetime code, etc. Further, the masking of the combination may include masking the combination based on one or more combination keys using an encryption scheme. Further, the one or more combination keys may include one or more associated keys (such as an association key). Further, the one or more combination keys may be based on the datetime. Further, the generating of the masked combination may be based on the masking of the combination based the one or more combination keys using the encryption scheme. Further, the user device may be configured for encrypting the datetime based on the generating of the datetime. Further, the user device may be configured for generating an encrypted datetime based on the encrypting. Further, the user device may be configured for concatenating the encrypted datetime with the masked combination. Further, the user device may be configured for generating a concatenated composite based on the concatenating. Further, the concatenated composite may include the encrypted datetime and the masked combination. Further, the generating of the message may be further based on the generating of the concatenated composite.

Further, in some embodiments, the performing of the operation may include adding the combination in the combination queue. Further, the combination is added to the combination queue in the set state.

Further, in some embodiments, the performing of the operation may include transitioning a state of a port of the communication channel between a closed state and an open state. Further, the port may include a data port. Further, the data port is associated with a data transport of the communication channel. Further, the communication channel may be a data channel. Further, the communication channel is bidirectional. Further, the performing of the operation is based on an access key. Further, a communication of the user device through the communication channel may be allowed based on the open state of the port. Further, the communication may include the exchange of data. Further, the communication of the user device through the communication channel may be restricted based on the closed state of the port. Further, the communication channel establishes a connection of the user device with another network, a database, or a device.

Further, in an embodiment, the transitioning of the state of the port of the communication channel may include transitioning the state of the port from the closed state to the open state.

Further, in an embodiment, the transitioning of the state of the port of the communication channel may include transitioning the state of the port from the open state to the closed state. Further, the method 2000 may include removing, using the processing device, the combination from the combination queue based on the transitioning of the state of the port from the open state to the closed state. Further, the combination is removed from the combination queue in the clear state, and/or the exit state.

Further, in some embodiments, the user device may be configured for determining the operation based on the request. Further, the user device may be configured for encrypting the passcode. Further, the user device may be configured for generating an encrypted passcode. Further, the user device may be configured for adding the encrypted passcode in a user queue at an address. Further, the user queue may be a user que (user-que). Further, the user queue may be uniquely assigned to the user. Further, the user queue may be uniquely assigned to the user based on a user ID.

Further, in some embodiments, the user device may be configured for determining the operation based on the request. Further, the user device may be configured for accessing a user queue uniquely assigned to the user based on the operation. Further, the generating of the passcode may be based on the user queue.

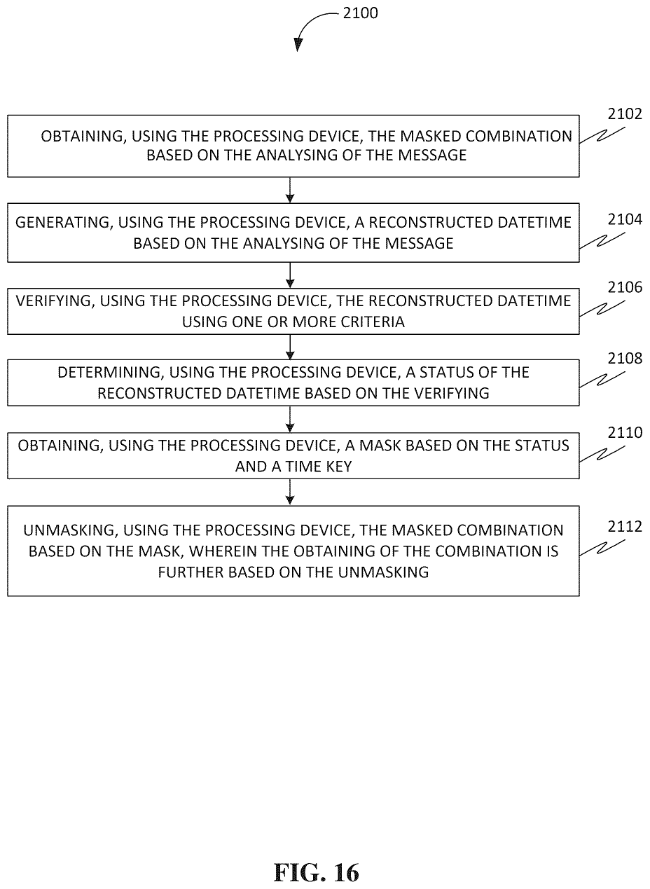

FIG. 16 is a flowchart of a method 2100 of facilitating secure communication, in accordance with some embodiments. Accordingly, the method 2100 may include a step 2102 of obtaining, using the processing device, the masked combination based on the analysing of the message.

Further, the method 2100 may include a step 2104 of generating, using the processing device, a reconstructed datetime based on the analysing of the message.

Further, the method 2100 may include a step 2106 of verifying, using the processing device, the reconstructed datetime using one or more criteria. Further, the one or more criteria may include a requirement that a difference of the reconstructed datetime and a prior datetime must be within a window of a number of seconds. Further, the prior datetime may be generated by sampling a clock.

Further, the method 2100 may include a step 2108 of determining, using the processing device, a status of the reconstructed datetime based on the verifying. Further, the status may include a positive status in which the difference is within the window. Further, the status may include a negative status in which the difference is not within the window.

Further, the method 2100 may include a step 2110 of obtaining, using the processing device, a mask based on the status and a time key. Further, the time key may include a timecoded key, a HMS key, etc.

Further, the method 2100 may include a step 2112 of unmasking, using the processing device, the masked combination based on the mask. Further, the obtaining of the combination may be based on the unmasking.

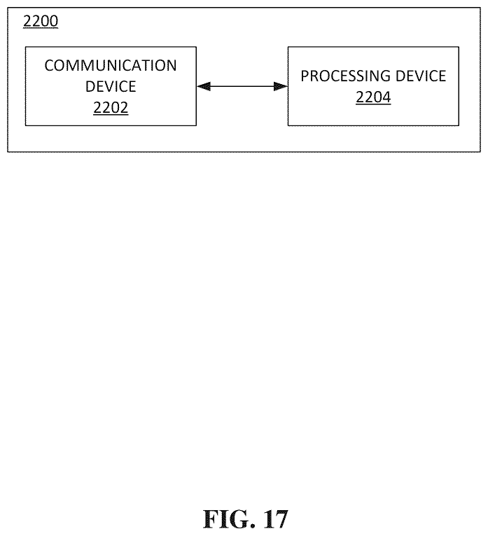

FIG. 17 is a block diagram of a system 2200 for facilitating secure communication, in accordance with some embodiments. Accordingly, the system 2200 may include a communication device 2202 and a processing device 2204. Further, the system 2200 may be a gateway, an access gateway, a gateway device, etc. Further, the system 2200 may execute an application. Further, the system 2200 may include an access point. Further, the access point may be associated with an access point interface (API). Further, the API interfaces with the GMI. Further, the GMI and API communicate with each other. Further, the API manages one or more ports comprised in the system 2200.

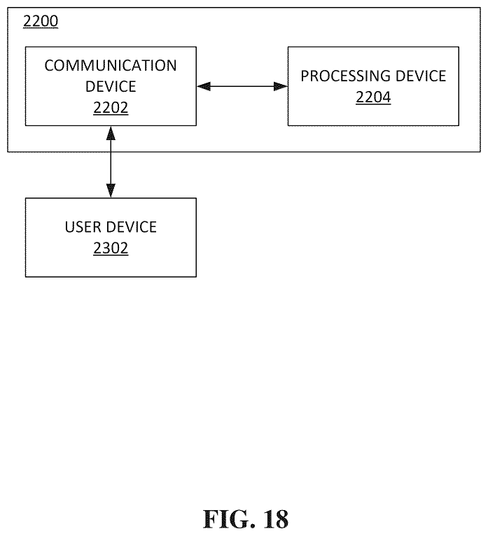

Further, the communication device 2202 may be configured for receiving a message from a user device 2302, as shown in FIG. 18, associated with a user. Further, the user device 2302 may be configured for receiving a request from the user. Further, the user device 2302 may be configured for receiving a user key from the user. Further, the user device 2302 may be configured for generating a passcode based on the user key. Further, the user device 2302 may be configured for generating a combination based on the passcode. Further, the user device 2302 may be configured for generating the message based on the generating of the combination and the request. Further, the user device 2302 may be a device in a network.

Further, the processing device 2204 may be communicatively coupled with the communication device 2202. Further, the processing device 2204 may be configured for analysing the message. Further, the processing device 2204 may be configured for determining an operation based on the analysing of the message. Further, the processing device 2204 may be configured for obtaining the combination based on the analysing of the message. Further, the processing device 2204 may be configured for accessing a combination queue. Further, the processing device 2204 may be configured for determining a belonging state corresponding to a belonging of the combination in the combination queue based on the combination queue and the combination. Further, the processing device 2204 may be configured for determining a performability of the operation based on the operation and the belonging state. Further, the processing device 2204 may be configured for performing the operation associated with a communication channel based on the performability.

Further, in some embodiments, the generating of the combination may include generating the combination using a sample of a source matrix under an operator action based on the passcode.

Further, in some embodiments, the user device 2302 may be configured for masking the combination. Further, the user device 2302 may be configured for generating a masked combination based on the masking of the combination. Further, the user device 2302 may be configured for sampling a clock comprised in the user device 2302. Further, the user device 2302 may be configured for generating a datetime based on the sampling of the clock. Further, the masking of the combination may include masking the combination based on one or more combination keys using an encryption scheme. Further, the one or more combination keys may be based on the datetime. Further, the generating of the masked combination may be further based on the masking of the combination based the one or more combination keys using the encryption scheme. Further, the user device 2302 may be configured for encrypting the datetime based on the generating of the datetime. Further, the user device 2302 may be configured for generating an encrypted datetime based on the encrypting. Further, the user device 2302 may be configured for concatenating the encrypted datetime with the masked combination. Further, the user device 2302 may be configured for generating a concatenated composite based on the concatenating. Further, the generating of the message may be further based on the generating of the concatenated composite.

Further, in an embodiment, the processing device 2204 may be configured for obtaining the masked combination based on the analysing of the message. Further, the processing device 2204 may be configured for generating a reconstructed datetime based on the analysing of the message. Further, the processing device 2204 may be configured for verifying the reconstructed datetime using one or more criteria. Further, the processing device 2204 may be configured for determining a status of the reconstructed datetime based on the verifying. Further, the processing device 2204 may be configured for obtaining a mask based on the status and a time key. Further, the processing device 2204 may be configured for unmasking the masked combination based on the mask. Further, the obtaining of the combination may be further based on the unmasking.

Further, in some embodiments, the performing of the operation may include adding the combination in the combination queue.

Further, in some embodiments, the performing of the operation may include transitioning a state of a port of the communication channel between a closed state and an open state. Further, a communication of the user device 2302 through the communication channel may be allowed based on the open state of the port. Further, the communication of the user device 2302 through the communication channel may be restricted based on the closed state of the port.

Further, in an embodiment, the transitioning of the state of the port of the communication channel may include transitioning the state of the port from the closed state to the open state.

Further, in an embodiment, the transitioning of the state of the port of the communication channel may include transitioning the state of the port from the open state to the closed state. Further, the processing device 2204 may be configured for removing the combination from the combination queue based on the transitioning of the state of the port from the open state to the closed state.

Further, in some embodiments, the user device 2302 may be configured for determining the operation based on the request. Further, the user device 2302 may be configured for encrypting the passcode. Further, the user device 2302 may be configured for generating an encrypted passcode. Further, the user device 2302 may be configured for adding the encrypted passcode in a user queue at an address. Further, the user queue may be uniquely assigned to the user.

Further, in some embodiments, the user device 2302 may be configured for determining the operation based on the request. Further, the user device 2302 may be configured for accessing a user queue uniquely assigned to the user based on the operation. Further, the generating of the passcode may be further based on the user queue.

FIG. 18 is a block diagram of the system 2200, in accordance with some embodiments.

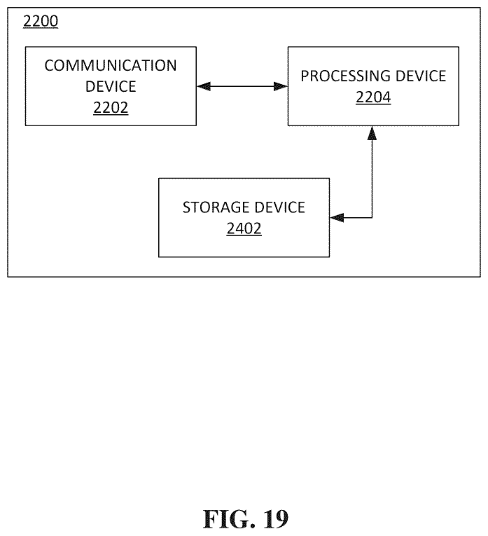

FIG. 19 is a block diagram of the system 2200, in accordance with some embodiments. Further, the system 2200 may include a storage device 2402 communicatively coupled with the processing device 2204. Further, the storage device 2402 may be configured for storing the combination queue.

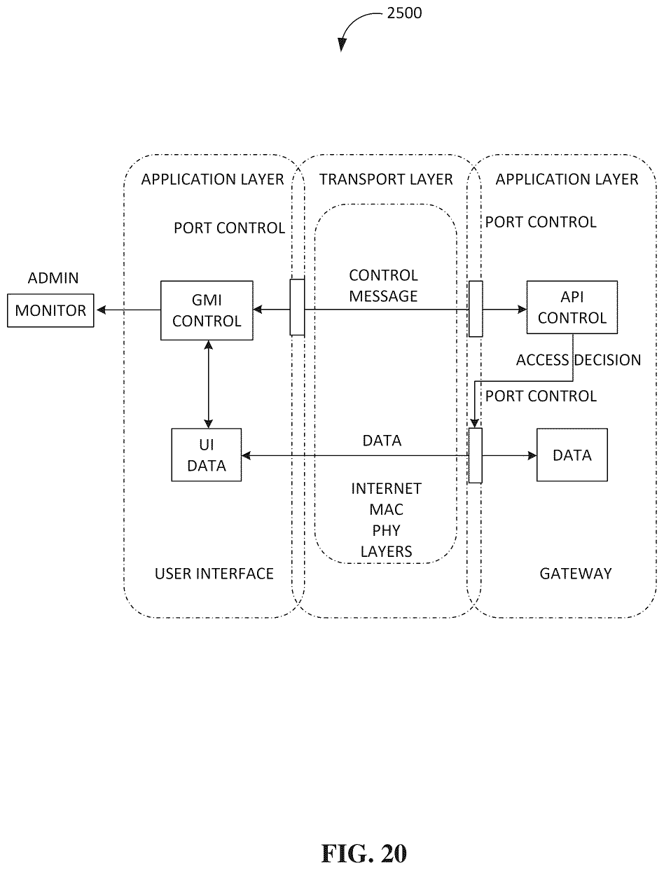

FIG. 20 illustrates a system 2500 comprising a user interface and a gateway for facilitating secure communication, in accordance with some embodiments.

FIG. 21 illustrates matrix frame coordinates 2600, in accordance with some embodiments.

FIG. 22 illustrates matrix frame coordinates 2700, in accordance with some embodiments.

FIG. 23 illustrates a complementary gate 2800 distributed over 40 registers, in accordance with some embodiments.

FIG. 24 illustrates layers 3100 in a matrix, in accordance with some embodiments.

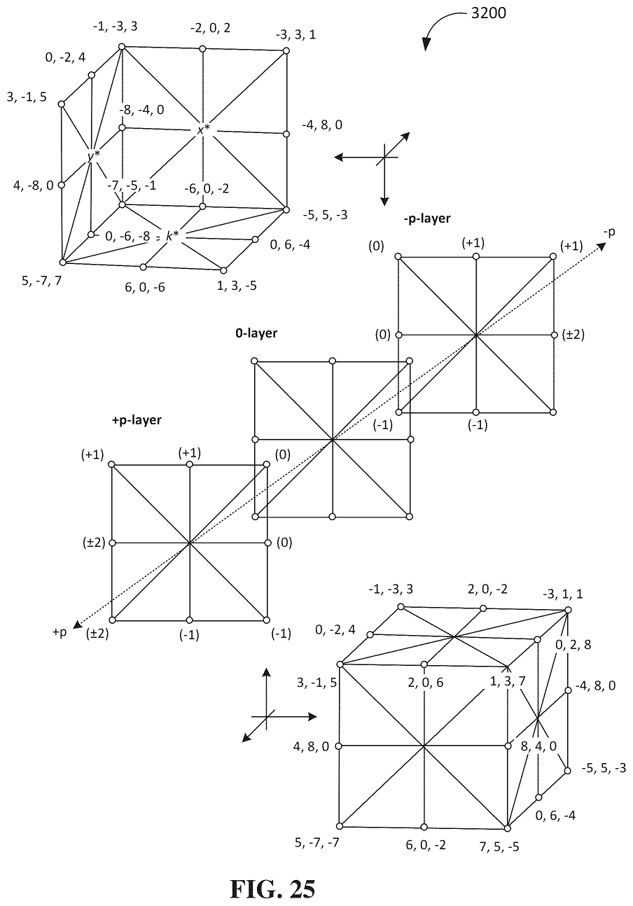

FIG. 25 is a representation 3200 associated with (0, p)-layer over the matrix order, in accordance with some embodiments.

FIG. 26 is a representation 3300 associated with a matrix operator, in accordance with some embodiments.

FIG. 27 is a representation 3400 associated with a spin operator, in accordance with some embodiments.

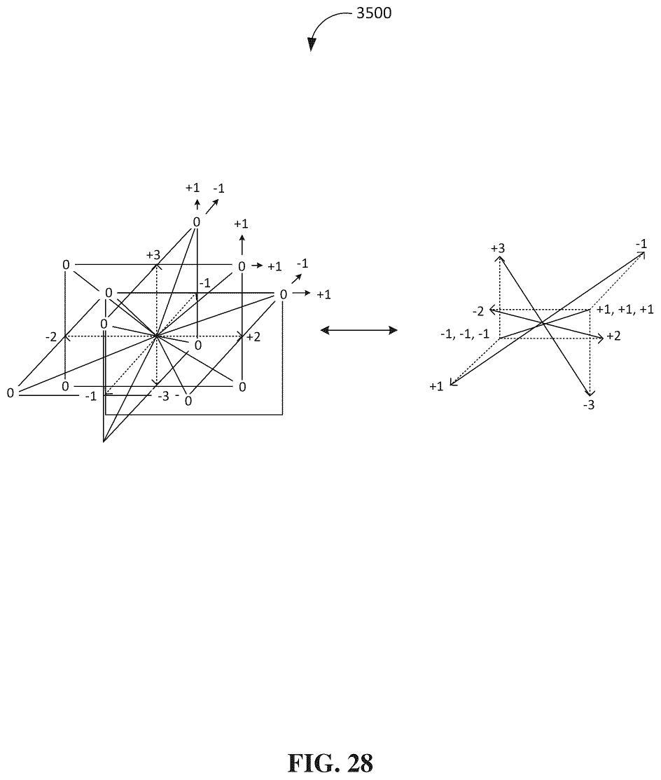

FIG. 28 is a representation 3500 of 3(0) & 2(±1) alignments in the 2, 3-grades associated with a cublet matrix, in accordance with some embodiments.

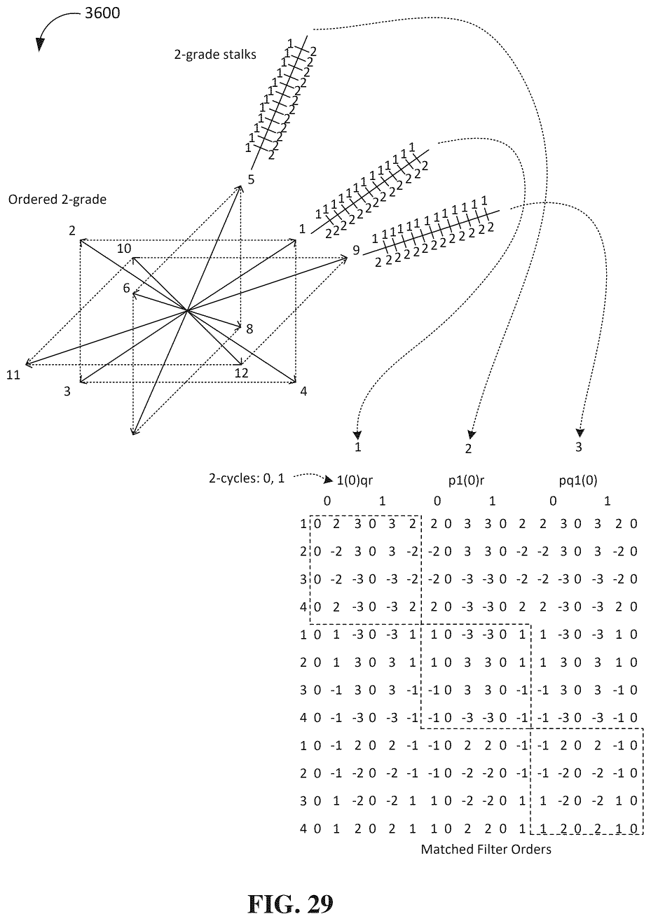

FIG. 29 is a representation 3600 of a filtering, in accordance with some embodiments.

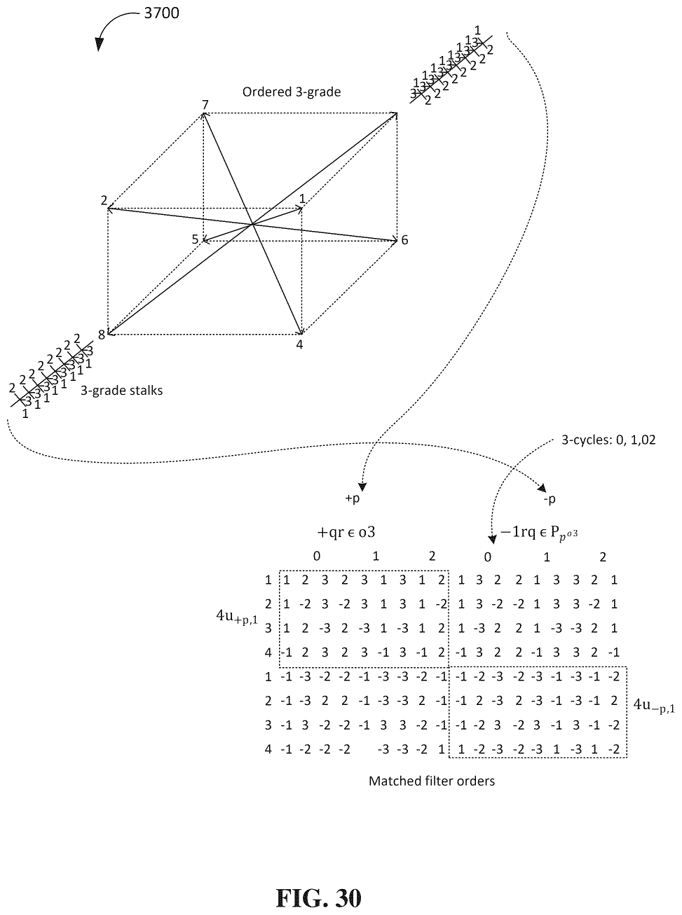

FIG. 30 is a representation 3700 of a filtering, in accordance with some embodiments.

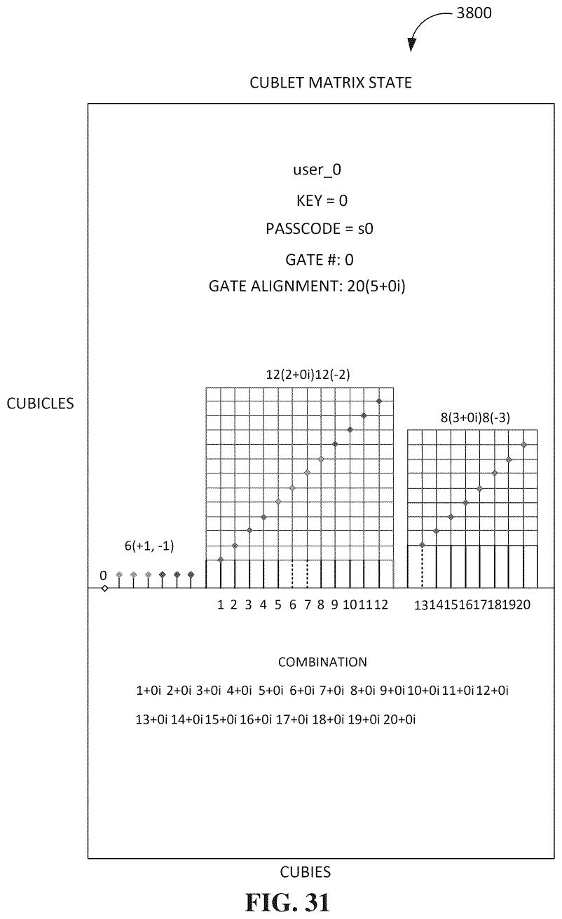

FIG. 31 illustrates a cublet matrix state 3800 of a quiescent, in accordance with some embodiments.

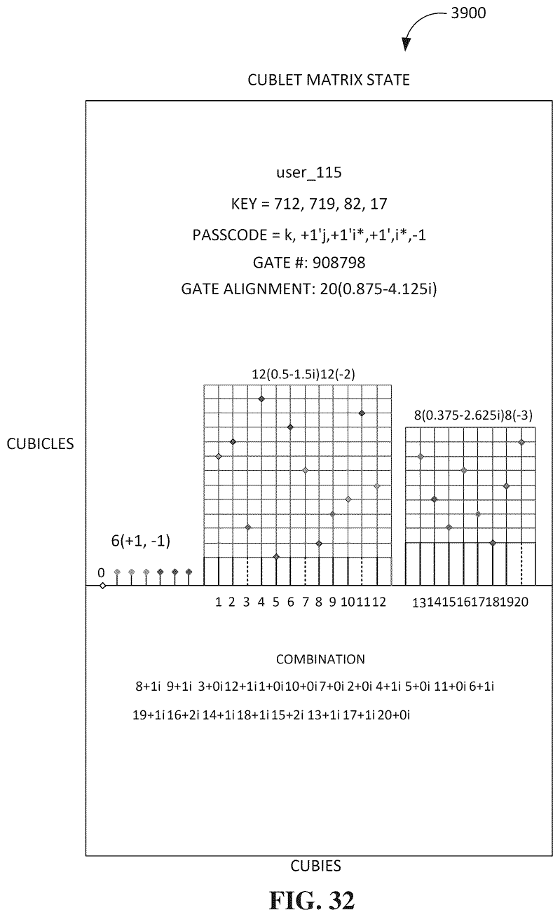

FIG. 32 illustrates a cublet matrix state 3900 of a user, in accordance with some embodiments.

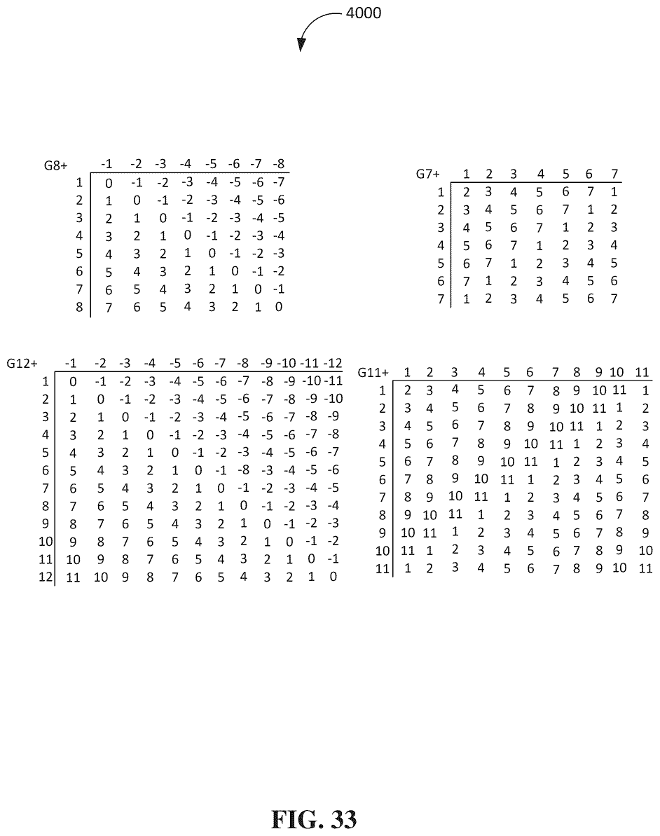

FIG. 33 is a representation 4000 associated with disorders, in accordance with some embodiments.

FIG. 34 is a flow diagram of a SET state flow 4100, in accordance with some embodiments.

FIG. 35 is a flow diagram of an ACCESS state flow 4200, in accordance with some embodiments.

FIG. 36 illustrates a representation 4300 of a control state XOR Logic, in accordance with some embodiments.

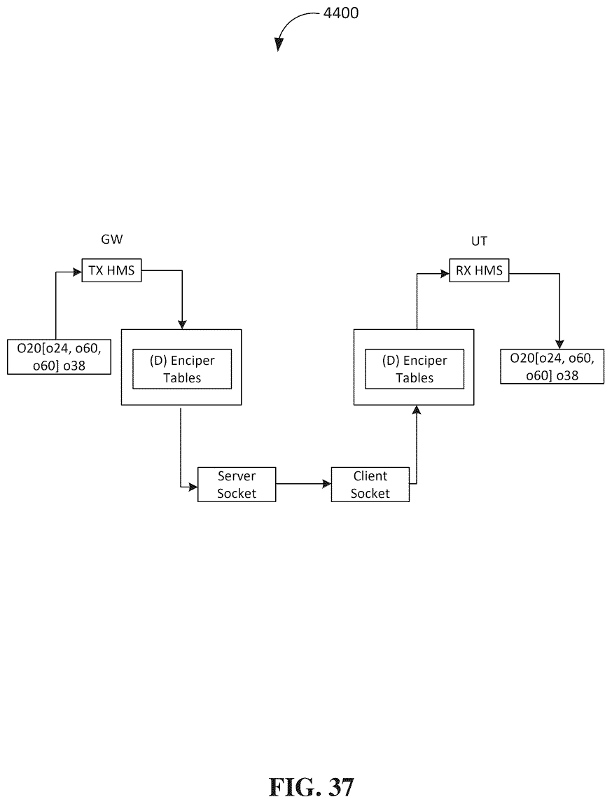

FIG. 37 illustrates 3-level HMS hash tables 4400 for combination encryption, in accordance with some embodiments.

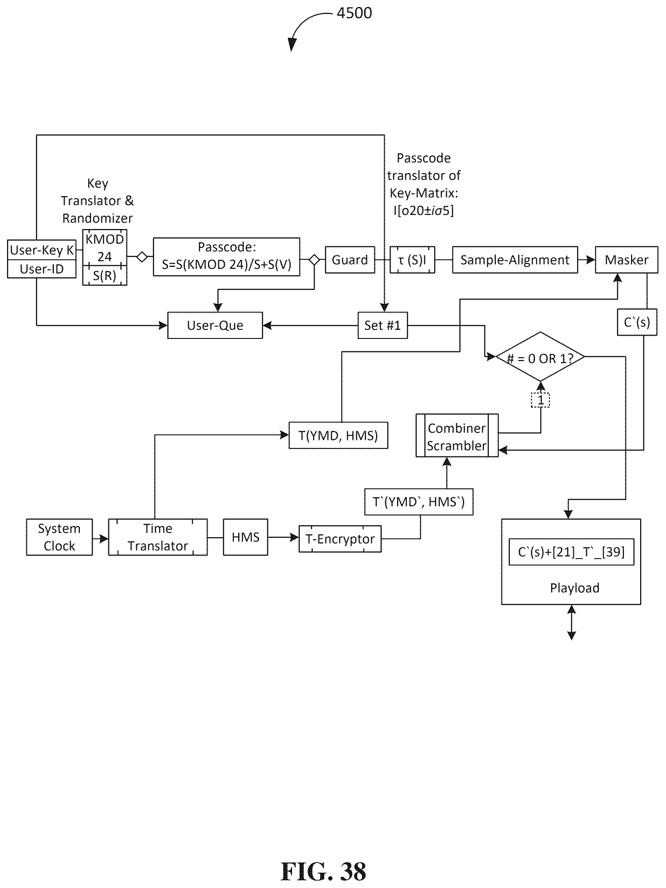

FIG. 38 is a flow diagram of a process flow 4500 of a GATORMOAT (GM) on a user terminal (UT) communication, in accordance with some embodiments.

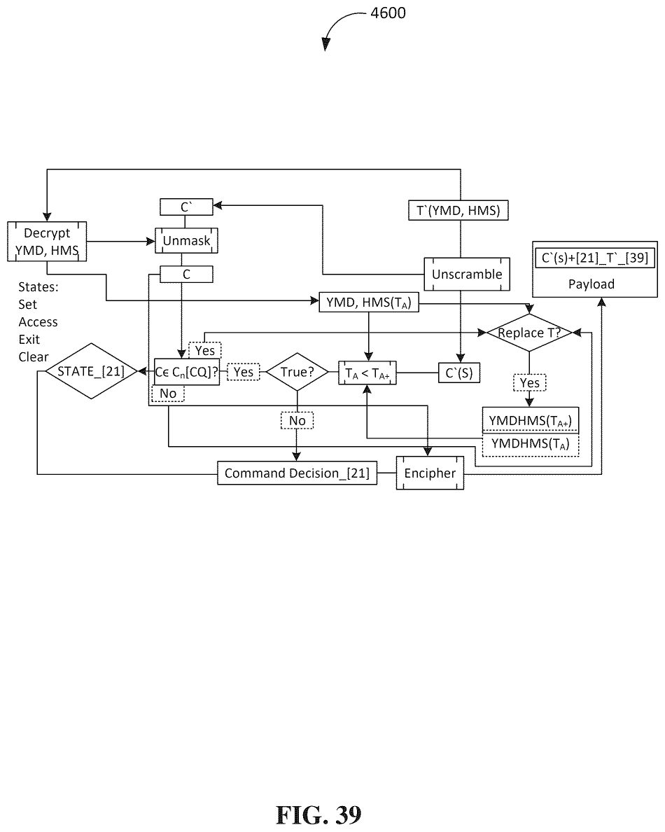

FIG. 39 is a flow diagram of a process flow 4600 of an access point (AP) on a gateway, in accordance with some embodiments.

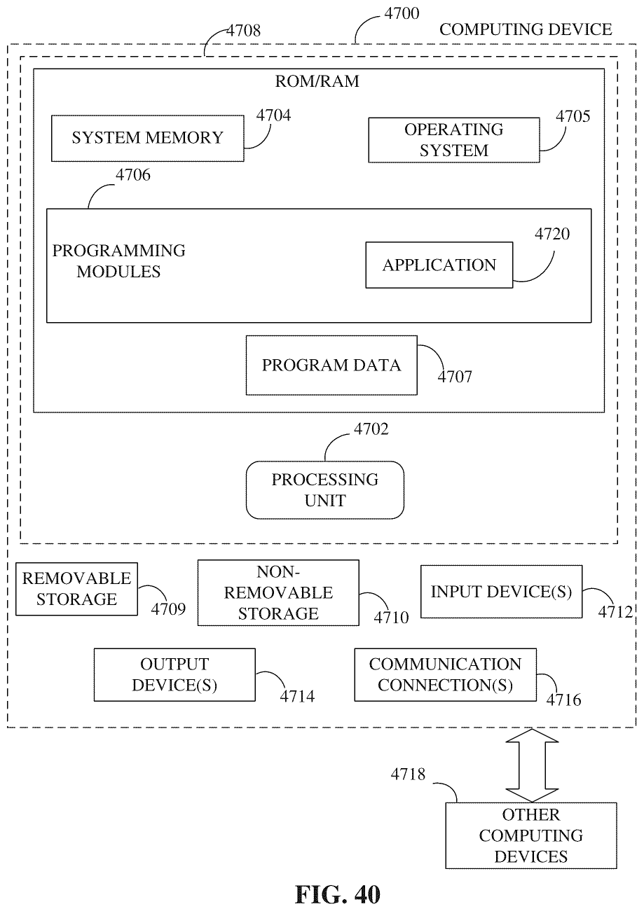

With reference to FIG. 40, a system consistent with an embodiment of the disclosure may include a computing device or cloud service, such as computing device 4700. In a basic configuration, computing device 4700 may include at least one processing unit 4702 and a system memory 4704. Depending on the configuration and type of computing device, system memory 4704 may comprise, but is not limited to, volatile (e.g. random-access memory (RAM)), non-volatile (e.g. read-only memory (ROM)), flash memory, or any combination. System memory 4704 may include operating system 4705, one or more programming modules 4706, and may include a program data 4707. Operating system 4705, for example, may be suitable for controlling computing device 4700's operation. In one embodiment, programming modules 4706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 40 by those components within a dashed line 4708.

Computing device 4700 may have additional features or functionality. For example, computing device 4700 may also include additional data storage devices (removable and/or non-removable) such as, for example, magnetic disks, optical disks, or tape. Such additional storage is illustrated in FIG. 40 by a removable storage 4709 and a non-removable storage 4710. Computer storage media may include volatile and non-volatile, removable and non-removable media implemented in any method or technology for storage of information, such as computer-readable instructions, data structures, program modules, or other data. System memory 4704, removable storage 4709, and non-removable storage 4710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 4700. Any such computer storage media may be part of device 4700. Computing device 4700 may also have input device(s) 4712 such as a keyboard, a mouse, a pen, a sound input device, a touch input device, a location sensor, a camera, a biometric sensor, etc. Output device(s) 4714 such as a display, speakers, a printer, etc. may also be included. The aforementioned devices are examples and others may be used.

Computing device 4700 may also contain a communication connection 4716 that may allow device 4700 to communicate with other computing devices 4718, such as over a network in a distributed computing environment, for example, an intranet or the Internet. Communication connection 4716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 4704, including operating system 4705. While executing on processing unit 4702, programming modules 4706 (e.g., application 4720 such as a media player) may perform processes including, for example, one or more stages of methods, algorithms, systems, applications, servers, databases as described above. The aforementioned process is an example, and processing unit 4702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating secure communication, the method comprising:
receiving, using a communication device, a message from a user device associated with a user, wherein the user device is configured for:
receiving a request from the user;
receiving a user key from the user;
generating a passcode based on the user key;
generating a combination based on the passcode; and
generating the message based on the generating of the combination and the: request;
analysing, using a processing device, the message;
determining, using the processing device, an operation based on the analysing of the message;
obtaining, using the processing device, the combination based on the analysing of the message;
accessing, using the processing device, a combination queue;
determining, using the processing device, a belonging state corresponding to a belonging of the combination in the combination queue based on the combination queue and the combination;
determining, using the processing device, a performability of the operation based on the operation and the belonging state; and
performing, using the processing device, the operation associated with a communication channel based on the performability.

2. The method of claim 1, wherein the generating of the combination comprises generating the combination using a sample of a source matrix under an operator action based on the passcode.

3. The method of claim 1, wherein the user device is further configured for:
masking the combination;
generating a masked combination based on the masking of the combination;
sampling a clock comprised in the user device;
generating a datetime based on the sampling of the clock, wherein the masking of the combination comprises masking the combination based on one or more combination keys using an encryption scheme, wherein the one or more combination keys is based on the datetime, wherein the generating of the masked combination is further based on the masking of the combination based the one or more combination keys using the encryption scheme;
encrypting the datetime based on the generating of the datetime;
generating an encrypted datetime based on the encrypting;
concatenating the encrypted datetime with the masked combination; and
generating a concatenated composite based on the concatenating, wherein the generating of the message is further based on the generating of the concatenated composite.

4. The method of claim 3 further comprising:
obtaining, using the processing device, the masked combination based on the analysing of the message;
generating, using the processing device, a reconstructed datetime based on the analysing of the message;
verifying, using the processing device, the reconstructed datetime using one or more criteria;
determining, using the processing device, a status of the reconstructed datetime based on the verifying;
obtaining, using the processing device, a mask based on the status and a time key; and
unmasking, using the processing device, the masked combination based on the mask, wherein the obtaining of the combination is further based on the unmasking.

5. The method of claim 1, wherein the performing of the operation comprises adding the combination in the combination queue.

6. The method of claim 1, wherein the performing of the operation comprises transitioning a state of a port of the communication channel between a closed state to an open state, wherein a communication of the user device through the communication channel is allowed based on the open state of the port, wherein the communication of the user device through the communication channel is restricted based on the closed state of the port.

7. The method of claim 6, wherein the transitioning of the state of the port of the communication channel comprises transitioning the state of the port from the closed state to the open state.

8. The method of claim 6, wherein the transitioning of the state of the port of the communication channel comprises transitioning the state of the port from the open state to the closed state, wherein the method further comprises removing, using the processing device, the combination from the combination queue based on the transitioning of the state of the port from the open state to the closed state.

9. The method of claim 1, wherein the user device is further configured for:
determining the operation based on the request;
encrypting the passcode;
generating an encrypted passcode; and
adding the encrypted passcode in a user queue at an address, wherein the user queue is uniquely assigned to the user.

10. The method of claim 1, wherein the user device is further configured for:
determining the operation based on the request; and
accessing a user queue uniquely assigned to the user based on the operation, wherein the generating of the passcode is further based on the user queue.

11. A system of facilitating secure communication, the system comprising:
a communication device configured for receiving a message from a user device associated with a user, wherein the user device is configured for:
receiving a request from the user;
receiving a user key from the user;
generating a passcode based on the user key;
generating a combination based on the passcode; and
generating the message based on the generating of the combination and the: request; and
a processing device communicatively coupled with the communication device, wherein the processing device is configured for:
analysing the message;
determining an operation based on the analysing of the message;
obtaining the combination based on the analysing of the message;
accessing a combination queue;
determining a belonging state corresponding to a belonging of the combination:
in the combination queue based on the combination queue and the combination;
determining a performability of the operation based on the operation and the belonging state; and
performing the operation associated with a communication channel based on the performability.

12. The system of claim 11, wherein the generating of the combination comprises generating the combination using a sample of a source matrix under an operator action based on the passcode.

13. The system of claim 11, wherein the user device is further configured for:
masking the combination;
generating a masked combination based on the masking of the combination;
sampling a clock comprised in the user device;
generating a datetime based on the sampling of the clock, wherein the masking of the combination comprises masking the combination based on one or more combination keys using an encryption scheme, wherein the one or more combination keys is based on the datetime, wherein the generating of the masked combination is further based on the masking of the combination based the one or more combination keys using the encryption scheme;
encrypting the datetime based on the generating of the datetime;
generating an encrypted datetime based on the encrypting;
concatenating the encrypted datetime with the masked combination; and
generating a concatenated composite based on the concatenating, wherein the generating of the message is further based on the generating of the concatenated composite.

14. The system of claim 13, wherein the processing device is further configured for:
obtaining the masked combination based on the analysing of the message;
generating a reconstructed datetime based on the analysing of the message;
verifying the reconstructed datetime using one or more criteria;
determining a status of the reconstructed datetime based on the verifying;
obtaining a mask based on the status and a time key; and
unmasking the masked combination based on the mask, wherein the obtaining of the combination is further based on the unmasking.

15. The system of claim 11, wherein the performing of the operation comprises adding the combination in the combination queue.

16. The system of claim 11, wherein the performing of the operation comprises transitioning a state of a port of the communication channel between a closed state to an open state, wherein a communication of the user device through the communication channel is allowed based on the open state of the port, wherein the communication of the user device through the communication channel is restricted based on the closed state of the port.

17. The system of claim 16, wherein the transitioning of the state of the port of the communication channel comprises transitioning the state of the port from the closed state to the open state.

18. The system of claim 16, wherein the transitioning of the state of the port of the communication channel comprises transitioning the state of the port from the open state to the closed state, wherein the processing device is further configured for removing the combination from the combination queue based on the transitioning of the state of the port from the open state to the closed state.

19. The system of claim 11, wherein the user device is further configured for:
determining the operation based on the request;
encrypting the passcode;
generating an encrypted passcode; and
adding the encrypted passcode in a user queue at an address, wherein the user queue is uniquely assigned to the user.

20. The system of claim 11, wherein the user device is further configured for:
determining the operation based on the request; and
accessing a user queue uniquely assigned to the user based on the operation, wherein the generating of the passcode is further based on the user queue.
